(19) United States
(12) Patent Application Publication
(10) Pub. No.: US 2024/0375975 A1
(43) Pub. Date: Nov. 14, 2024

(54) COLOR REMOVAL WITH ZIPGEM FILTRATION MEDIA FOR WATER AND WASTEWATER TREATMENT

(71) Applicant: University of Central Florida Research Foundation, Inc., Orlando, FL (US)

(72) Inventor: Ni-Bin Chang, Orlando, FL (US)

(21) Appl. No.: 18/770,246

(22) Filed: Jul. 11, 2024

Related U.S. Application Data
(63) Continuation-in-part of application No. 18/303,973, filed on Apr. 20, 2023.
(60) Provisional application No. 63/333,310, filed on Apr. 21, 2022.

(51) Int. Cl. C02F 1/28; B01J 20/04; B01J 20/10; B01J 20/12; B01J 20/28; C02F 101/10; C02F 101/30; C02F 101/34; C02F 103/00; C02F 103/06

(52) U.S. Cl. CPC C02F 1/288; B01J 20/04; B01J 20/106; B01J 20/12; B01J 20/28011; B01J 20/28059; C02F 1/281; C02F 2101/105; C02F 2101/308; C02F 2101/34; C02F 2103/007; C02F 2103/06

(57) ABSTRACT

Described herein relates to an optimum, low maintenance and low-cost filtration media which may be implemented near a source water location as a pretreatment to remove tannic acid and/or humic acid (color) from dissolved natural organic matter (NOM) (i.e., tannic acid, humic acid) to impede the prompt production of disinfection by-products collectively termed trihalomethanes in drinking water treatment processes. In an embodiment, the filtration media may comprise a composition having a ratio of at least 83% sand, at most 5% clay, at most 6% ZVI and at most 6% perlite by percent volume.

### CROSS-REFERENCE TO RELATED APPLICATIONS

This nonprovisional application is a Continuation-in-Part of and claims priority to U. S. Nonprovisional patent application Ser. No. 18/303,973 entitled “COLOR REMOVAL WITH ZIPGEM FILTRATION MEDIA FOR WATER AND WASTEWATER TREATMENT” filed Apr. 20, 2023 by the same inventor, which claims priority to U. S. Provisional Patent Application No. 63/333,310 entitled “COLOR REMOVAL WITH ZIPGEM FILTRATION MEDIA FOR WATER AND WASTEWATER TREATMENT” filed Apr. 21, 2022 by the same inventor, all of which are incorporated herein by reference, in their entireties, for all purposes.

### BACKGROUND OF THE INVENTION

### 1. Field of the Invention

This invention relates, generally, to media used to improve efficiencies of contaminant removal from fluids, such as water sources. More specifically, it relates to a synergistic zero-valent-iron and perlite based green sorption media composition that is used to remove color from fluid.

### 2. Brief Description of the Prior Art

The increasing needs of drinking water due to population growth has spurred a need to find new tap water sources. However, these large-scale tap water sources are often discolored. Natural or synthetic color present in aquatic systems can occur from dyes from domestic or industrial wastewater (Tara et al., 2020), dissolved natural organic matter (hereinafter “NOM”) from plant species (Kutser et al., 2005), and algae (Shengguang et al., 1991). More specifically, NOM including humic, fulvic, and tannic acids (Darko et al., 2014) can result in a yellow, red, brown and/or gray color in aquatic system. Humic and fulvic acids are the final products from the natural decay of plants and animals while tannin acid mostly occurs from leaching of twigs and swelling of certain trees including chestnut and oak trees. While these organic acids are beneficial to soil for agricultural processes, they can cause color contamination in water bodies. Therefore, they can affect the ability of these water bodies to be used as drinking water sources as they are precursors to disinfectant by-products (hereinafter “DBPs”) after drinking water treatment (EPA, 2012; Ahamed et al., 2019). For this reason, the US Environmental Protection Agency (hereinafter “EPA”) has regulated color concentration in drinking water to 15 Pt—Co units (e.g., visual color on the Platinum-Cobalt Scale) under the secondary drinking water standards (Dietrich and Burlingame, 2015).

Disinfection byproducts (DBPs hereafter) are unintentional by-products resulting from the interaction of disinfectants like chlorine with NOM (Tak and Vellanki, 2018). Trihalomethanes, halo acetic acids, formaldehyde, and acetaldehyde are some of the commonly found DBPs (Krasner et al., 1989; Palmstrom et al., 1988). The occurrence of DBPs in drinking water can cause adverse effects on human health, (Fawell et al., 1997) including increasing risk of bladder cancer (Li and Mitch, 2018), and influencing reproduction, which can result in birth defects (Wigle, 1998). The removal of DBP precursors (e.g., NOMs) within drinking water treatment facilities typically requires coagulation, microfiltration (Bottino et al., 2001) or adsorption (Gora and Andrews, 2017; Sun et al., 2017). Given such complicated treatment processes, the removal of color from the natural aquatic sources utilized as drinking water is of importance as it can lower the treatment cost and minimize the emergence of DBPs.

Currently there are four different ways to remove tannic or humic acids (e.g., color) including 1) photocatalytic methods; 2) coagulation; 3) microfiltration; and 4) adsorption. The first three methods are relatively expensive and require sophisticated control schemes.

The removal of NOM (e.g., tannic and humic acid) and the degradation of dyes (e.g., color) by photocatalytic methods is an effective approach. In the photocatalytic process, heterogeneous photocatalysis involves the irradiation of semiconductor catalysts (e.g., TiO2, ZnO, WO3, Fe₂O₃, CdO, CdS, SnO₂, etc.) with a light source (e.g., ultraviolet (UV), sunlight, or artificial light) to generate highly reactive oxygen species (ROS) (e.g., ·OH, O₂·—) for the subsequent mineralization of long chain or short chain organic pollutants. An example is the degradation of dyes, detergents, and organic acids by TiO₂ nanofilms (Albu et al., 2007).

As to the coagulation, the most common coagulates are aluminum and iron salts. Aluminum and iron salt when added to water dissolve negatively into particle trivalent forms (e.g., Al³⁺ and Fe³⁺) which allows the attachment to negative charged particles. Given the composition of NOM, its removal mechanism encompasses charge neutralization, entrapment, adsorption, and complexation with coagulant metal ions into the insoluble particles. Besides, the use of ferric salts has increased, with ferric chloride (i.e., FeCl₃) and ferric sulphate (i.e., Fe(SO₄)₃) being the most common alternatives (Matilainen et al., 2010). Furthermore, membrane filtration is an alternative physical treatment that can be used to remove color from source water or wastewater. The use of a flat ceramic microfiltration membrane made of natural perlite as the base material showed turbidity removal above 96% from industrial wastewater (Saja et al., 2018).

Adsorption methods are relatively easier than the previous three methods. Activated Carbon (hereinafter “AC”) filter is the most common method to remove color from water and wastewater due to its simplicity and regeneration potential (Rao and Krishnaiah, 1994; Singh et al., 2003). This conventional treatment is designed to absorb particles and organic contaminants in drinking water that may result in bad tastes and odors. The utilization of AC in early stage has expanded to the innovated use of agricultural waste (Suba and Rathika, 2016). Sun and Xu (1997) revealed that sunflower stalks have a maximum adsorption potential of 105 and 317 mg·g⁻¹ to remove basic dyes, Methylene Blue and Basic Red 9, respectively. Other innovated agricultural waste materials have been studied including mango peels (Jawad et al., 2017), rice husk (Vadivelan and Kumar, 2005), palm kernel shell (El-Sayed, 2011), coconut shell (Aljeboree et al., 2017), and banana and orange peels (Mane and Bhusari, 2012). The removal of humic acid by AC has been previously studied, where it showed a 98.9% removal of humic acid by a combined system of plasma and AC adsorption, after 90 minutes. Furthermore, it has been reported that AC had a maximum color removal efficiency of 90.72% with Fe⁰ synthesized nanoparticles of size 16.64 nm. (Prema et al., 2011) Moreover, a polysilicate aluminum magnesium and cationic polyacrylamide flocculant have been successfully designed and have been able to obtain turbidity and color removal above 98% at optimum in drinking water. (Ma et al., 2019)

Additionally, other materials have been implemented for color removal, including clay to remove tannic and humic acid (Chang and Juang, 2004), where the maximum adsorption capacity was reported to be 153 mg·g⁻¹ and 28.3 mg·g⁻¹ for tannic and humic acid correspondingly. Moreover, the adsorption of tannic and humic acid to activated clay follows pseudo-first order model and can be best model by intraparticle diffusion given that they are denser solids and have better mass transfer blockage in comparison with other absorbents (Chang and Juang, 2004).

The use of membranes to remove color and dyes have also been investigated. Rambabu et al. (2019) studied the dye rejection potential of a polyethersurfone nano-porous membrane modified with calcium chloride. A 95% rejection of Congo Red dye with the polyethersurfone nano-porous membrane was observed.

Perlite is a soil amendment derived from volcanic rock usually formed from siliceous lava or ash. Natural perlite is usually grey, but it can also be green, red, blue, or brown; yet after heating it usually takes on a white color. The chemical formula of perlite is Al₂CaFe₂K₂MgNa₂O₁₂Si and the molecular weight is 574.29 g·mol⁻¹; hence it is natural sodium-potassium-aluminum-silicate. The use of perlite and volcanic rock has also been studied for the removal of dyes from aqueous solutions (Rossatto et al., 2021). Dogan et al. (2000) examined the adsorption of methylene blue from aqueous solutions to unexpanded and expanded perlite samples activated by H₂SO₄ and NaCl solutions to remove cationic dyes. Their results indicated that perlite can be used for removal of methylene; a better removal efficacy was observed from unexpanded perlite. Meesuk and Seammai (2010) suggested that expanded perlite can be used to remove dark color from spent palm oil via physical mechanism and can also remove benzo (a) pyrene from the palm oil. Although the adsorption of tannic acid onto perlite has not been broadly explored, the adsorption efficiency of humic substances onto expanded perlite was investigated by Chassapis et al. (2010). Chassapis et al. (2010) indicated that the adsorption of humic substance stems involved Coulombic attraction forces related to the positively charged humic substances and negative sites of the perlite (i.e., alumino-silicate).

Accordingly, what is needed is an improved and cost-effective approach to removing color from water sources. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a filtration media. In an embodiment the filtration media may comprise: (a) at least one silicon atom; (b) at least one aluminum atom; and (c) at least one zero-valence-iron (hereinafter “ZVI”) atom. In this embodiment, the at least one ZVI atom may be chemically bonded to at least one silicon atom of at least one grain of perlite, such that at least one ZVI-perlite structure may be formed. Additionally, the at least one ZVI-perlite structure may then be chemically bonded to at least one alternative silicon atom of at least one grain of sand, such that at least one quartz structure may be formed. In this embodiment, the at least one ZVI atom may be configured to be disposed about at least a portion of a surface of the at least one quartz structure. Moreover, in this embodiment, the at least one ZVI-coated quartz structure may be metallically bonded to at least one aluminum atom, such that an aluminum-doped ZVI-quartz construct may be formed. Furthermore, in this embodiment, the aluminum-doped ZVI-quartz construct may further comprise at least one potassium atom and/or at least one calcium atom, and/or the aluminum-doped ZVI-quartz construct may comprise a heterogenous morphological structure.

In some embodiments, the ratio of the at least one ZVI atom to the at least one grain of sand within the aluminum-doped ZVI-quartz construct may be at most 0.071 by percent volume. In addition, in these other embodiments, the aluminum-doped ZVI-quartz construct may comprise a composition ratio of at least 85% sand, at most 5% clay, at most 6% ZVI, and at most 4% perlite by percent volume.

In some embodiments, the aluminum-doped ZVI-quartz construct may comprise a surface area of at most 3.00 m²·g⁻¹. In this manner, the aluminum-doped ZVI-quartz construct may be configured to be hydraulicly conductive and/or highly porous. As such, in these other embodiments, the aluminum-doped ZVI-quartz construct may comprise a porosity of at least 29.0% of percent surface area.

In some embodiments, the aluminum-doped ZVI-quartz construct may comprise a density of at least 2.50 g·cm⁻³. In addition, the aluminum-doped ZVI-quartz construct may be electrochemically stable and/or hydrophobic.

Another aspect of the present disclosure pertains to a method of optimizing a color removal reaction within a water sample. In an embodiment, the method may comprise: (a) incorporating a filtration media into the water sample, the filtration media comprising: (i) at least one silicon atom; (ii) at least one aluminum atom; and (iii) at least one zero-valence-iron (hereinafter “ZVI”) atom. In this embodiment, the at least one ZVI atom may be chemically bonded to at least one silicon atom of at least one grain of perlite, such that at least one ZVI-perlite structure may be formed. Additionally, the at least one ZVI-perlite structure may then be chemically bonded to at least one alternative silicon atom of at least one grain of sand, such that at least one quartz structure may be formed. In this embodiment, the at least one ZVI atom may be configured to be disposed about at least a portion of a surface of the at least one quartz structure. Moreover, in this embodiment, the at least one ZVI-coated quartz structure may be metallically bonded to at least one aluminum atom, such that an aluminum-doped ZVI-quartz construct may be formed. As such, in this embodiment, the incorporation of the filtration media to the water sample thereof may optimize the color removal reaction within the water sample.

In some embodiments, the aluminum-doped ZVI-quartz construct may be configured to maintain an effluent concentration below at least 40 color units of Pt—Co. In this manner, in these other embodiments, the aluminum-doped ZVI-quartz construct may be configured to operate continuously in the water sample for at least 14,000 minutes.

As such, in some embodiments, the aluminum-doped ZVI-quartz construct may be configured to inhibit ponding and/or clogging within at least one pour of the aluminum-doped ZVI-quartz construct for at least 40,000 minutes. In addition, the aluminum-doped ZVI-quartz construct may be configured to maintain an adsorption capacity of at least 25.0 mg of Pt—Co·g⁻¹ during the color removal reaction.

Furthermore, an additional aspect of the present disclosure pertains to a method of synthesizing a filtration media. In an embodiment, the method may comprise: (a) pretreating at least one iron atom, such that the at least one iron atom may comprise zero-valence (hereinafter “ZVI”); (b) chemically bonding at least one silicon atom of at least one grain of perlite to the at least one ZVI atom to form a ZVI-perlite structure; (c) chemically bonding at least one alternative silicon atom of at least one grain of sand to the ZVI-perlite structure to a quartz structure, such that the at least one ZVI atom may be disposed about at least a portion of a surface of the quartz structure; and (d) metallically bonding at least one aluminum atom to the ZVI-coated quartz structure to form the filtration media which is an aluminum-doped ZVI-quartz construct.

In some embodiments, heat treatment may be used to chemically bond the at least one grain of perlite to the at least one grain of sand. Additionally, the heat treatment may be used to chemically bond the at least one ZVI atom to the at least one grain of perlite, and furthermore, in these other embodiments the heat treatment may be used to chemically bond the at least one aluminum atom to the at least one ZVI-coated quartz structure.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a fuller understanding of the invention, reference should be made to the following detailed description, taken in connection with the accompanying drawings, in which:

FIG. 1A is an aerial photograph comprising a marked location of Black Creek Tributary, according to an embodiment of the present disclosure.

FIG. 1B is a photograph comprising a sample collection location of the Black Creek Tributary, according to an embodiment of the present disclosure.

FIG. 1C is a photograph comprising the raw water in the location of collection of the Black Creek Tributary, according to an embodiment of the present disclosure.

FIG. 1D is an image illustrating a chemical structure of tannic acid, according to an embodiment of the present disclosure.

FIG. 2 is a plot illustrating gradation curves of a sorption (i.e., filtration) media (*x-axis is in logarithmic scale), according to an embodiment of the present disclosure.

FIG. 3A is a photograph and SEM image of sorption media, CTS, according to an embodiment of the present disclosure.

FIG. 3B is a photograph and SEM image of sorption media, IFGEM-1, according to an embodiment of the present disclosure.

FIG. 3C is a photograph and SEM image of sorption media, IFGEM-4, according to an embodiment of the present disclosure.

FIG. 3D is a photograph and SEM image of sorption media, CPS 367, according to an embodiment of the present disclosure.

FIG. 3E is a photograph and SEM image of sorption media, ZIPGEM, according to an embodiment of the present disclosure.

FIG. 4A is a photograph and SEM image of a composition of a media material, sand, according to an embodiment of the present disclosure.

FIG. 4B is a photograph and SEM image of a composition of a media material, clay, according to an embodiment of the present disclosure.

FIG. 4C is a photograph and SEM image of a composition of a media material, perlite, according to an embodiment of the present disclosure.

FIG. 4D is a photograph and SEM image of a composition of a media material, ZVI, according to an embodiment of the present disclosure.

FIG. 5A is a plot illustrating a dynamic color removal efficiency curve for 438 of CTS, according to an embodiment of the present disclosure.

FIG. 5B is a plot illustrating a dynamic color removal breakthrough curve for 438 of CTS, according to an embodiment of the present disclosure.

FIG. 5C is a plot illustrating a dynamic color removal efficiency curve for IFGEM-1, according to an embodiment of the present disclosure.

FIG. 5D is a plot illustrating a dynamic color removal breakthrough curve for IFGEM-1, according to an embodiment of the present disclosure.

FIG. 5E is a plot illustrating a dynamic color removal efficiency curve for IFGEM-4, according to an embodiment of the present disclosure.

FIG. 5F is a plot illustrating a dynamic color removal breakthrough curve for IFGEM-4, according to an embodiment of the present disclosure.

FIG. 5G is a plot illustrating a dynamic color removal efficiency curve for CPS, according to an embodiment of the present disclosure.

FIG. 5H is a plot illustrating a dynamic color removal breakthrough curve for CPS, according to an embodiment of the present disclosure.

FIG. 5I is a plot illustrating a dynamic color removal efficiency curve for 439 ZIPGEM, according to an embodiment of the present disclosure.

FIG. 5J is a plot illustrating a dynamic color removal breakthrough curve for 439 ZIPGEM, according to an embodiment of the present disclosure.

FIG. 6 is a graphical workflow illustrating a removal mechanism in ZIPGEM, according to an embodiment of the present disclosure.

FIG. 7 is a plot illustrating life expectancy curves for volume of water expected to be treated by various masses of ZIPGEM for Co=175±10 units Pt—Co, according to an embodiment of the present disclosure.

FIG. 8 is a plot illustrating a Rhodamine tracer examination for ZIPGEM based on a 1-ft long 3″ diameter column (e.g., 1,200 ml 567 of media) with influent flow rate of 4 ml·min⁻¹, according to an embodiment of the present disclosure.

FIG. 9 is a graphical illustration depicting media mixes and media components for a plurality of sorption media, according to an embodiment of the present disclosure.

FIG. 10 is a plot illustration a location of PZC for CPS, ZIPGEM, and BIPGEM, according to an embodiment of the present disclosure.

FIG. 11 is a plot illustration adsorption capacities for a plurality of sorption medias, according to an embodiment of the present disclosure. Section (A) depicts an adsorption capacity of CPS; Section (B) depicts an adsorption capacity of ZIPGEM; and Section (C) depicts an adsorption capacity of BIPGEM.

FIG. 12 is bar graph illustrating removal efficiencies for a plurality of sorption medias, according to an embodiment of the present disclosure. Section (A) depicts NO₃⁻ removal efficiency for CPS, ZIPGEM, and BIPGEM using canal water spiked with phosphate to a concentration of 0, 0.7, 2, 3, 4, 5, 15, 30, 60, 120, and 240 mg·L−1 PO₄³⁻ while maintaining a constant NO₃⁻ concentration of 2 mg·L⁻¹, denoted as influent conditions 1, 2, 3, 4, 5, 6, 7, 8, 9, 10 and 11, respectively; and Section (B) depicts PO₄³⁻ removal efficiency for CPS, ZIPGEM, and BIPGEM using canal water spiked with phosphate to a concentration of 0, 0.7, 2, 3, 4, 5, 15, 30, 60, 120, and 240 mg·L⁻¹ PO₄³⁻ while maintaining a constant NO₃⁻ concentration of 2 mg·L⁻¹, denoted as influent conditions 1, 2, 3, 4, 5, 6, 7, 8, 9, 10 and 11, respectively.

FIG. 13 is a plot illustrating a dynamic PO₄³⁻ removal rate of ZIPGEM, according to an embodiment of the present disclosure.

FIG. 14 is a graphical illustration depicting a MC-LR structure, according to an embodiment of the present disclosure. Section (a) depicts a MC-LR chemical structure; and Section (b) depicts a 3-D structure of the MC-LR.

FIG. 15 is a graphical illustration depicting a phosphate removal processes for a plurality of sorption media, according to an embodiment of the present disclosure.

FIG. 16 is a bar graph illustrating percentage removal of phosphate obtained under different initial conditions for a plurality of sorption media, according to an embodiment of the present disclosure. Section (a) depicts percentage removal obtained by CPS, ZIPGEM, BIPGEM-1 and BIPGEM-2 under different initial conditions (Control, Condition 1, Condition 2, Condition 3, Condition 4, Condition 5 and Condition 6) and for Case 1 (MC-LR); Section (b) depicts percentage removal obtained by CPS, ZIPGEM, BIPGEM-1 and BIPGEM-2 under different initial conditions (Control, Condition 1, Condition 2, Condition 3, Condition 4, Condition 5 and Condition 6) and for Case 2 (MC-LR and PO₄³⁻); and Section (c) depicts percentage removal obtained by CPS, ZIPGEM, BIPGEM-1 and BIPGEM-2 under different initial conditions (Control, Condition 1, Condition 2, Condition 3, Condition 4, Condition 5 and Condition 6) and for Case 3 (MC-LR and Ca²⁺).

FIG. 17 is an image depicting biochar at a plurality of magnifications, according to an embodiment of the present disclosure. Section (a) depicts biochar at a magnification of 65X; and Section (b) depicts biochar at a magnification of 1 KX.

FIG. 18 is a plot illustrating a dynamic MC-LR removal for a plurality of sorption media, according to an embodiment of the present disclosure. Section (a) depicts a dynamic MC-LR removal for CPS from a fixed bed column study with real canal water spiked to 70 μg·L⁻¹ MC-LR as influent conditions; Section (b) depicts a dynamic MC-LR removal for ZIPGEM from a fixed bed column study with real canal water spiked to 70 μg·L⁻¹ MC-LR as influent conditions; and Section (c) depicts a dynamic MC-LR removal for BIPGEM-1 from a fixed bed column study with real canal water spiked to 70 μg·L⁻¹ MC-LR as influent conditions.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention. Elements/components shown in diagrams are illustrative of exemplary embodiments of the disclosure and are meant to avoid obscuring the disclosure. Any headings, used herein, are for organizational purposes only and shall not be used to limit the scope of the description or the claims. Furthermore, the use of certain terms in various places in the specification, described herein, are for illustration and should not be construed as limiting.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

As used herein, the term “about” or “roughly” means approximately or nearly and in the context of a numerical value or range set forth means±15% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Filtration Media

The present disclosure pertains to an optimum, low maintenance, and low-cost filtration media (i.e., ZIPGEM) that may be implemented near a source water location as a pretreatment to remove tannic acid or humic acid (i.e., color) from dissolved natural organic matter (hereinafter “NOM”) (i.e., tannic acid, humic acid) to impede the prompt production of disinfection by-products collectively termed trihalomethanes and are abbreviated as either THM or TTHM (for total trihalomethanes) in drinking water treatment processes.

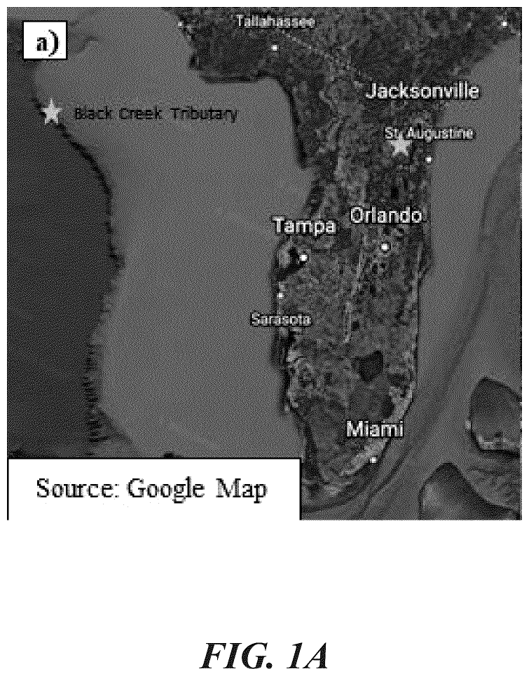

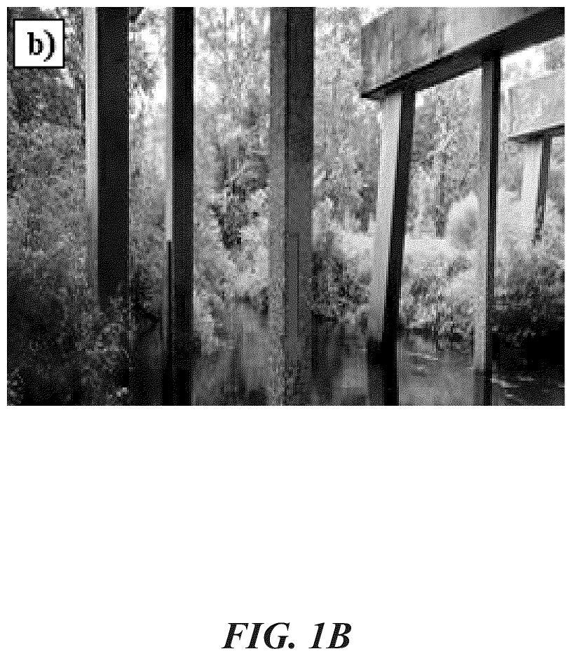

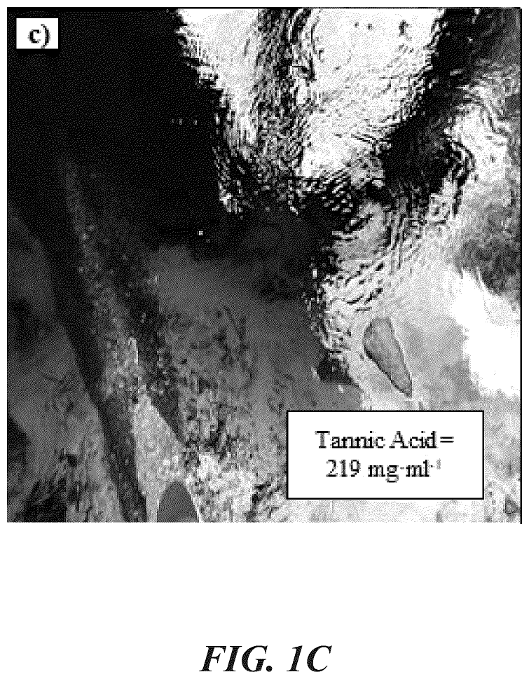

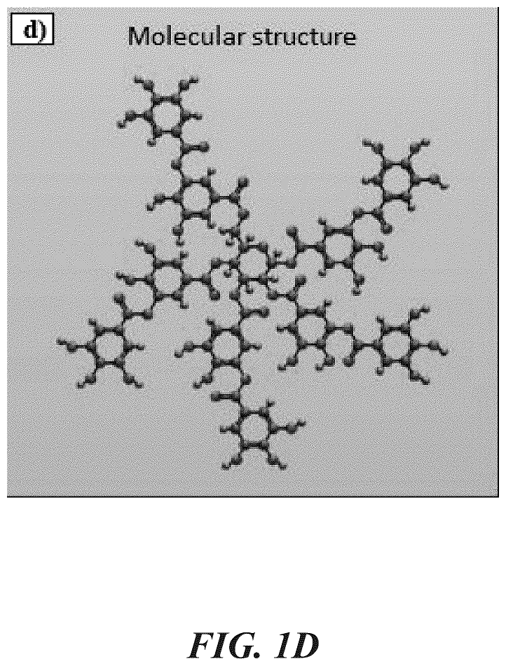

FIGS. 1A-1D depict a water sample and a sample collection location of the water source, according to an embodiment of the present disclosure. As such, in an embodiment, the sorption media utilizes the synergistic effects of several components to remove the color from the water. In some embodiments, the components are made from recycled materials and/or may include but are not limited to clay, sand (e.g., quartz), perlite, and/or zero-valent-iron to create a cost-effective media for the removal of color (e.g., tannic acid and humic acid, as shown in FIG. 1D) from water sources. In some embodiments, the sorption media may include iron-filling green environmental media 4 (hereinafter “IFGEM-4”), clay-perlite and/or sand sorption media (hereinafter “CPS), and/or zero-valent iron and perlite-based green environmental media (hereinafter “ZIPGEM” and/or “filtration media”). As such, in an embodiment, the filtration media may comprise composition ratio having a range of at least 50% sand to at most 96% sand, at least 1% clay to at most 30% clay, at least 1% ZVI to at most 30% ZVI, and at least 1% perlite to at most 30% perlite by volume. For example, in some embodiments, the filtration media may comprise a composition ratio of 85% sand, 5% clay, 6% ZVI, and 4% perlite by volume. Additionally, as an alternative example, in some embodiments, the filtration media may comprise a composition ratio of 83% sand, 5% clay, 6% ZVI, and 6% perlite by volume.

The unit cost per color removal is about 10+ times lower than that of photocatalytic, coagulation, and/or microfiltration methods. As such, the filtration media may be used as soil amendment in forest land and/or in landfill as at least one daily cover material. In an embodiment, the filtration media may be configured to remove color by maintaining the effluent concentration below at least forty (40) color units of Pt—Co for at least 10,000 minutes (e.g., 14,080 minutes) given the quantity of at least 500 ml (e.g., 900 ml) media volume and/or the hydraulic loading rate of at least 30 gallon·day⁻¹·ft⁻² (e.g., 31.02 gallon·day⁻¹·ft⁻²), which may be very competitive with respect to other existing options known in the art. Additionally, in this embodiment, the filtration media may not only be used to remove tannic acid and/or humic acid in natural water, but also filtration media may be applied to remove at least one dye in at least one of a plurality of industrial wastewater effluents, with a fairly broad application spectrum. The filtration media may also comprise one of the green sorption media, such that at least one recycled material may be used as at least one ingredient in the mix in a circular economy that meet the sustainable development goals of the United Nations.

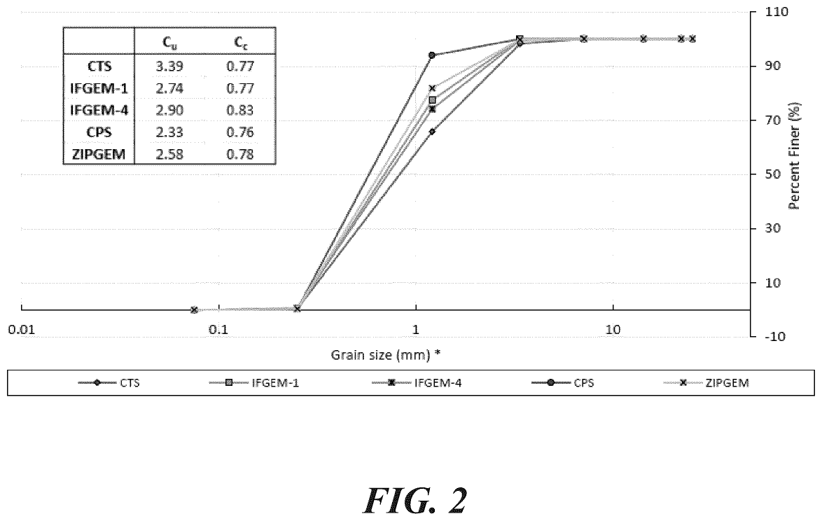

The deficiencies of prior art such as lower than photocatalytic, coagulation, and/or microfiltration methods have at least 10 times a higher price, and/or photocatalytic, coagulation, and/or microfiltration methods require sophisticated control schemes with operational complexity. In contrast, as shown in FIG. 2, in an embodiment, there is almost no process control requirement in the filtration media-based filter cells. Accordingly, based on the Cu and Cc scores, as shown in FIG. 2, the quality of the filtration media-based filter cell may vary between a poor-grade and a high grade. In addition, the filtration media may have no sludge and/or concentrate as residuals for final disposal whereas coagulation, membrane, and/or microfiltration often suffer from sludge and/or concentrate disposal. Thus, no limitation may be observed in the filtration media applications.

The following list provides at least one possible usage of the filtration media for cost-effective and/or large-scale color removal that can be applied either for ex situ or in situ facilities. Possible applications may include, but are not limited to, springs protection facilities, stormwater utilities, wastewater treatment plants, water treatment plants, integrated water resources management facilities at the watershed scale, environmental remediation facilities for soil and water remediation, forest runoff, the mining industry (e.g., tailing water for treatment), the textile industry, the dyeing industry, the food industry, the beverage industry, the drug industry, and/or the paper mill industry.

### Filtration Media Material Characterization

In an embodiment, the filtration media (i.e., ZIPGEM) may comprise a surface area having a range of at least 2.00 m²·g⁻¹ to at most 3.00 m²·g⁻¹. For example, in some embodiments the surface area of the filtration media may be 2.55 m²·g⁻¹, which comprises the largest surface area as compared to the sorption media known in the art (e.g., CTS, IFGEM-1, IFGEM-4, and/or CPS). As such, as known in the art, larger surface area may lead to better adsorption potential. In terms of porosity, the filtration media may be at least 15%. For example, in some embodiments, the filtration media may have a porosity of 29.04%. Additionally, in an embodiment, the filtration media may comprise a saturated hydraulic conductivity within the typical range for sand (at least 10⁻³ to at most 10⁻⁵ m·sec⁻¹), indicating that the filtration media may be appropriate for field implementation. Finally, in this embodiment, the inclusion of ZVI in the filtration media may be associated with the resultant higher density and/or larger surface area within the filtration media, such that the filtration media may optimize color removal facilitation. In this manner, in an embodiment, the filtration media may comprise a density having a range of at least 1.50 g·cm⁻³. As such, in some embodiments, for example, the filtration media may comprise a density of 2.80 g·cm⁻³. Furthermore, in an embodiment, the filtration media may have a chemical composition comprising at least one Al atom, at least one Si atom, at least one P atom, at least one K atom, at least one Ca atom, and/or at least one Fe atom.

In this manner, in an embodiment, the filtration media may comprise at least one Si atom (e.g., silica) within its chemical composition, such that the at least one Si atom comprises the main chemical element of the filtration media. As known in the art, amino-functionalized magnetic mesoporous silica may remove tannic acid from aqueous solution, via adsorption. Next, in this embodiment, the second most abundant chemical component within the chemical composition of the filtration media may be Al (i.e., aluminum). Accordingly, the presence of at least one Al atom within chemical composition of the filtration media may be explained by the inclusion of clay as at least one ingredient of the filtration media. As such, the at least one Al atom may be utilized for removal of diverse contaminants including but not limited to nutrients, metals, and/or contaminants of emerging concern. In addition, in this embodiment, the filtration media may also comprise at least one ZVI atom and/or at least one recycled ZVI (e.g., 95.6% Fc) atom within the chemical composition of the filtration media, such that a removal of contaminants may be substantially improved given the reactivity, large surface area, lower cost, and/or environmentally friendly nature of the at least one ZVI atom and/or the at least one recycled ZVI. Furthermore, in this embodiment, the filtration media may also comprise at least one K (i.e., potassium) atom and/or Ca (i.e., calcium) atom (e.g., 1-2.5% and/or 0.7-1%, respectively) within the filtration media's chemical composition, and thus, to some extent their presence may aid in a synergistic effect that can be helpful for the removal of contaminants.

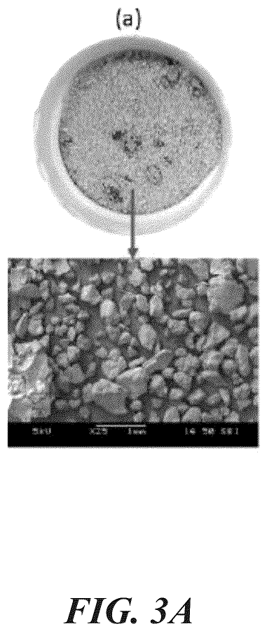

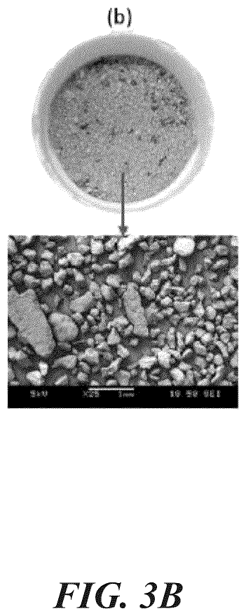

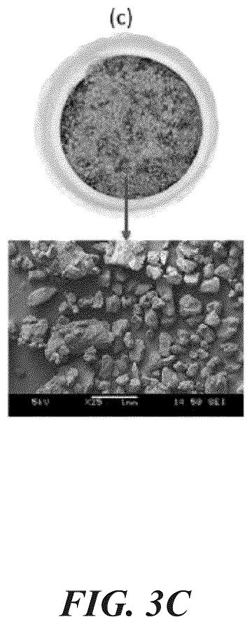

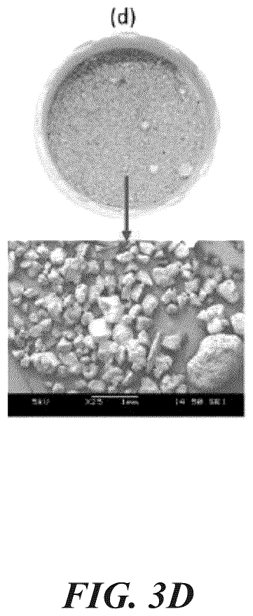

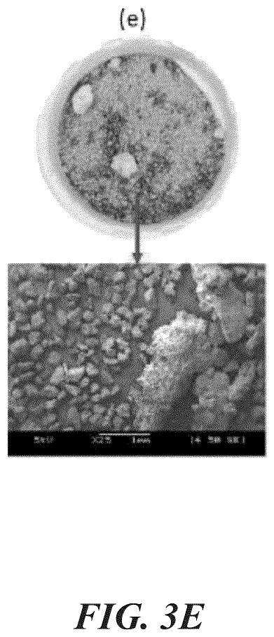

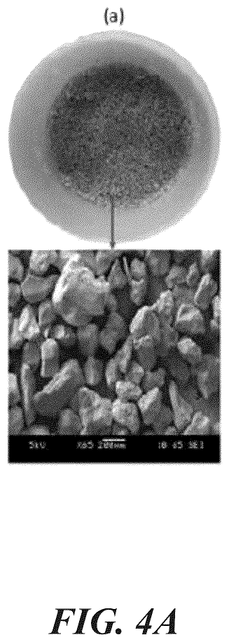

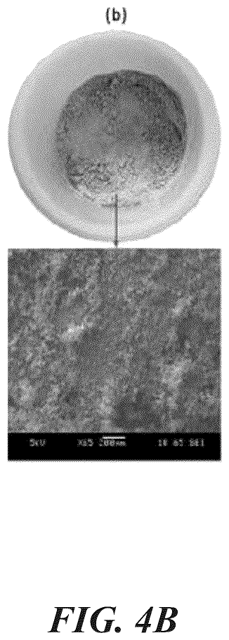

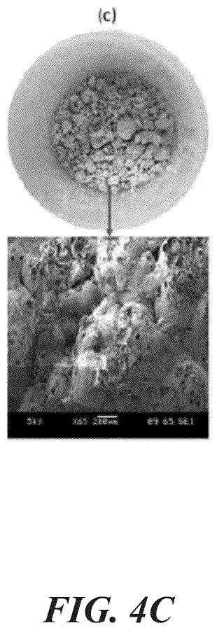

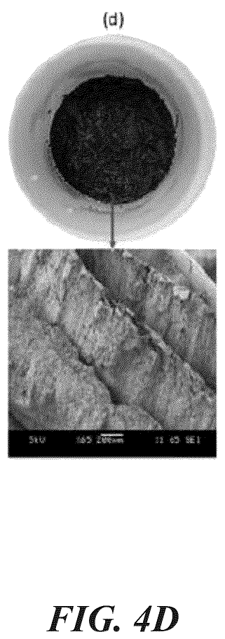

FIGS. 3A-3D depict photographs and SEM images of sorption media, according to an embodiment of the present disclosure. As such, as shown in FIG. 3E, in conjunction with FIGS. 4A-4D, in an embodiment, the filtration media may comprise a heterogenous size and shape. As such, in some embodiments, the filtration media may comprise at least one Si—Al and/or at least one Fe—Si bond, such that the at least one ZVI atom may be disposed about the surface of the sand and/or perlite (e.g., Si) quartz structure, causing the at least one ZVI atom to interact with the at least one water sample. As compared to sorption media known in the art (e.g., CTS, IFGEM-1, IFGEM-4, and/or CPS), the filtration media may comprise the most heterogenous size and/or shape, such that the filtration media may provide at least one 3-dimensional morphological structure with a higher hydraulic conductivity at the microscale than the known sorption media in order to promote and/or enhance molecular diffusion in at least one multi-layer structure during an adsorption process. As known in the art, poorly graded materials with morphological structures may have a higher potential to allow dispersion and molecular diffusion to occur in layer-by-layer films during the adsorption process. Accordingly, in this embodiment, the filtration media may be formed by the following steps, including but not limited to: (1) a mass transfer in a liquid phase via convective mass transfer followed by molecular diffusion; (2) an interface diffusion via film diffusion between the liquid phase and the exterior surface of the adsorbent; (3) an intrapellet mass transfer through surface diffusion and pore diffusion; and/or (4) an adsorption-desorption reaction before and after equilibrium.

### Filtration Media Color Removal Efficiency

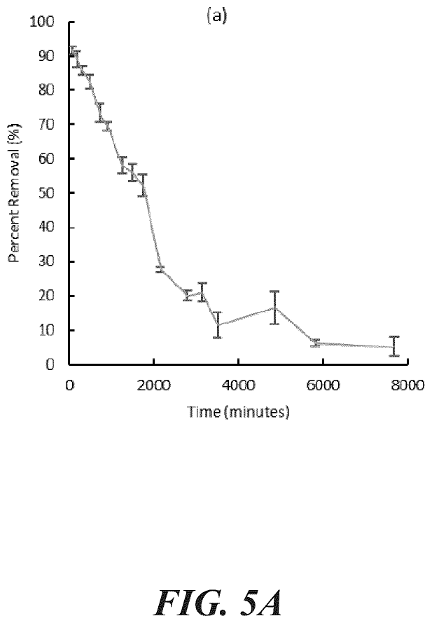

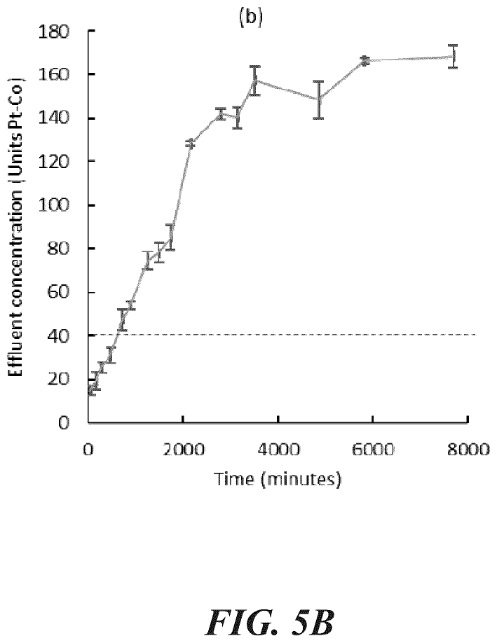

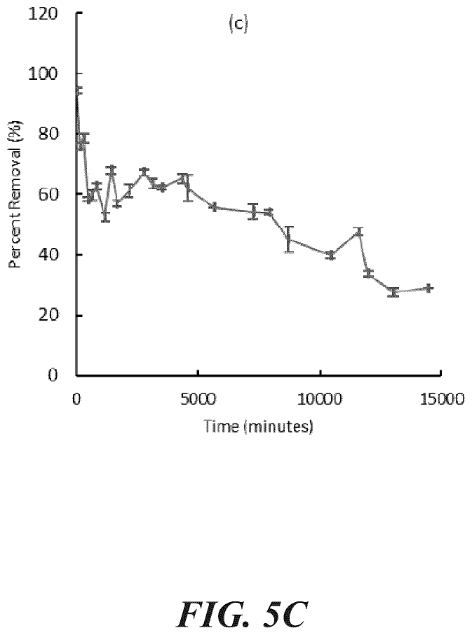

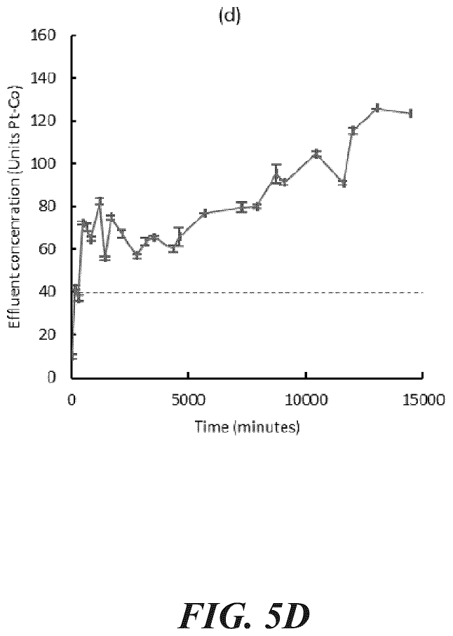

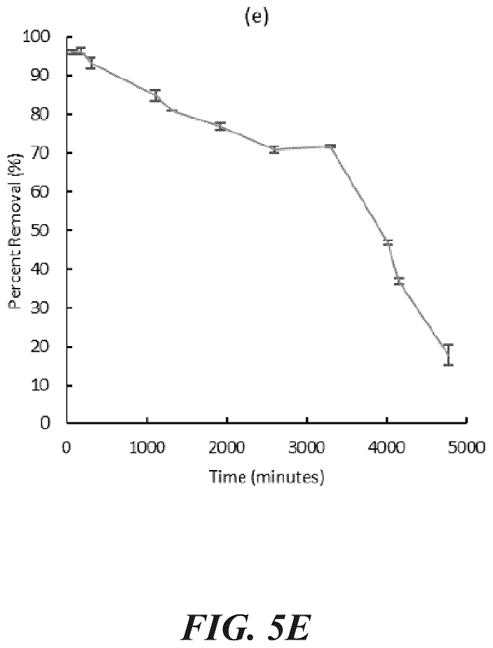

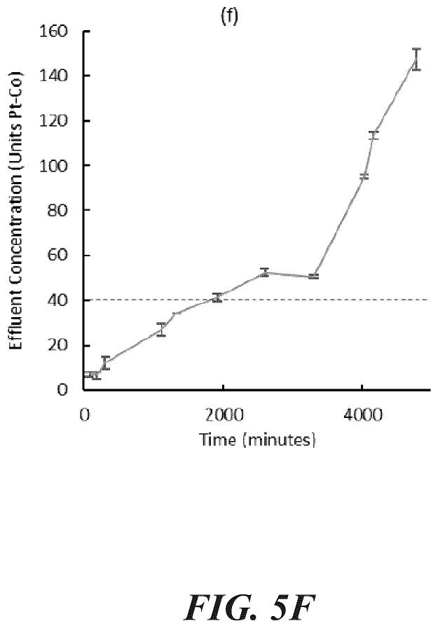

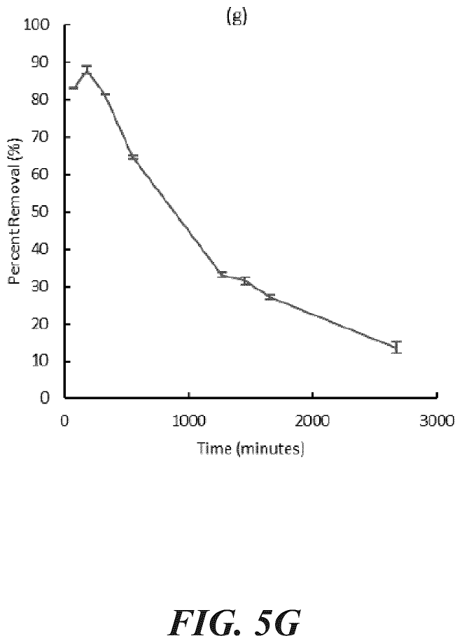

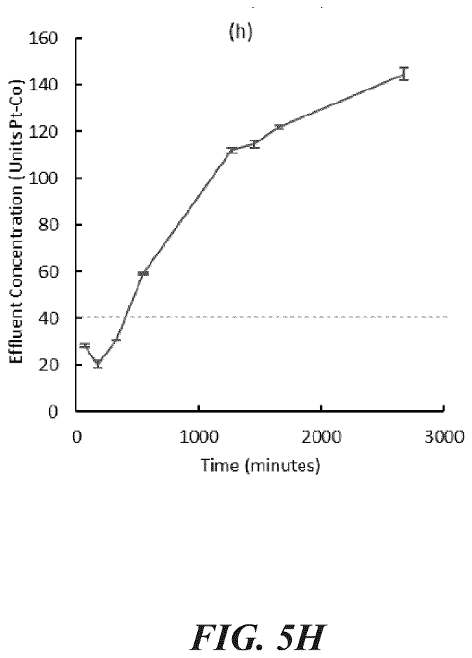

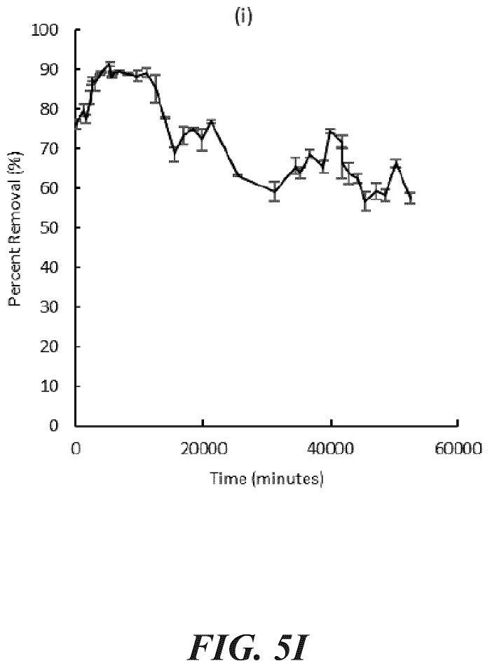

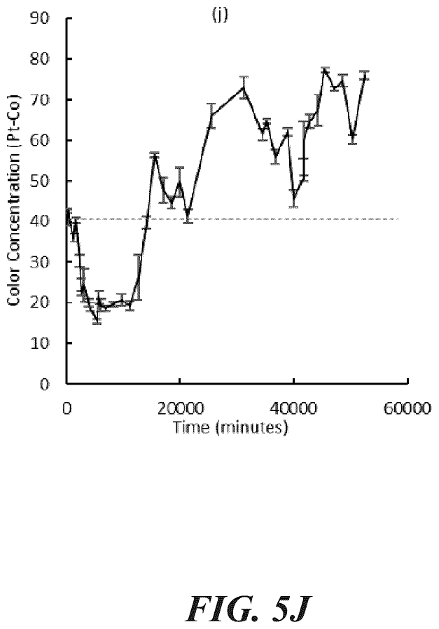

FIGS. 5A-5J depict plots illustrating dynamic color removal efficiency curves and dynamic color removal breakthrough curves, according to an embodiment of the present disclosure. The results are presented in FIGS. 5A-5J in terms of time (minutes) vs. color removal efficiency (%). In this manner, as shown in FIG. 5I and FIG. 5J, in an embodiment, the filtration media (i.e., ZIPGEM), comprising a mix of ZVI, perlite, clay, and/or sand, may comprise the highest efficiency among all sorption media known in the art (e.g., CTS, IFGEM-1, IFGEM-4, and/or CPS), as effluent concentrations below 40-unit Pt—Co were observed for prolonged times. Additionally, in this embodiment, the filtration media may comprise a possible recovery of the adsorption capacity (e.g., at least 70% filtration of color) for at least 40,000 minutes. As such, in this embodiment, the filtration media may also not comprise a ponding and/or clogging issue during the life cycle of the filtration media until at least 60,000 minutes.

In this manner, as known in the art, the clogging and/or ponding may be associated with the ZVI particles undergoing oxidization resulting in iron oxide clogging the pore space in the media mix and affecting the infiltration negatively. Given that some Al and Fe can be dissolved in water the major tannic acid removal mechanism could be chemical precipitation driven by the formation of solid organometallic complexes, the emergence of Al-tannate can also contribute to clogging issues. The higher the content of ZVI, the larger the chance to have a ponding effect due to accumulation of aluminum and iron salts on the surface of Si (found in sand). As such, in an embodiment, the filtration media may comprise a ZVI and Sand ratio of at most 0.090 (ZVI/Sand percent by volume). In some embodiments, for example, the ZVI and Sand ratio may be at least 0.071 (ZVI/Sand percent by volume). Additionally, in an embodiment, since the filtration media comprises a larger surface area and/or hydraulic conductivity, high porosity, and/or a high-grade heterogenous morphological structure as compared to the sorption media known in the art (e.g., CTS, IFGEM-1, IFGEM-4, and/or CPS), in addition to comprising stronger ionic interactions, van der Walls forces, and/or hydrogen bonding effects as compared to the sorption media known in the art, the removal of color from a water sample may be optimized.

### Filtration Media Removal Mechanism

As known in the art, tannic acid tends to spontaneously adsorb to different surfaces to yield a hydrophilic coating. In this manner, it has been suggested the interactions between soil minerals and tannins result in adsorption. It was discovered that the adsorption mechanism is heterogeneous, and dependent on pH and ionic strength. Moreover, prior studies have indicated that the adsorption of tannic acid to silicate is completed after about 15 minutes revealing that it produces a thin layer on SiO₂. The removal of tannic acids with clay is also related to adsorption. However, as noted in the prior art, attapulgite clay coated with chitosan was found to adsorb 95.3 mg g⁻¹ of tannic acid driven by electrostatic interactions, hydrogen bonding, and Van der Waals forces. In addition, since the anionic functional groups of tannic acid include hydroxyl and carboxyl groups, it has been noted that it can adsorb on oxide surfaces. Furthermore, as stated in the prior art, tannic acid is negatively charged, hence Ca²⁺ can aid to bind negatively charged surfaces such as species of tannic acid.

Besides, as known in the art, an Al ion has the possibility of interacting with multiple tannic acid molecules and the formation of insoluble complexes resulting from aluminum compounds such as Al—OH at low and/or high pH. While at pH between 5-6, when Al(OH)₃ is the predominant form, complex formation is replaced by adsorption onto Al(OH)₃ surface. As such, the coprecipitation of tannic acid with Al(OH)₃ occurs in the presence of hydrous aluminum oxide (e.g., Al(OH)₃) leading to soluble colloidal hydroxy-Al-tannate complexes. In the case of humic substances, prior studies have noted that when Al-humic complexes are formed, charge neutralization occurs. Similarly, since tannic acid is a polymeric molecule, it can chelate with Fe³⁺ ions, producing an insoluble complex where the structure is contingent on the solution.

As known in the art, given the composition of NOM present in natural water, the color removal mechanism encompasses the process of precipitation, charge neutralization, entrapment, adsorption, and complexation with coagulant metal ions into insoluble particles. The reduction in tannic acid in water can also be attained by precipitation leading to the formation of solid complexes which can be separated in processes like coagulation and sedimentation. As known in the art, the effect of tannic acid on phosphate and organism matter removal during wastewater treatment: inorganic salts of aluminum or iron are primary coagulants in natural or engineered systems that can hydrolyze to generate insoluble precipitates and entrap particles, neutralizing the charge on the particles. As mentioned in prior studies, accumulation of positively charged aluminum and iron salts (i.e., coagulating metal ions) on the surface of Si given the suitable pH values in water, could also attract negatively charged particles. In this manner, the NOM removal with ferric salts has been reported in a range for 29-70%, and NOM may also react with polyvalent metal cations producing soluble metal-NOM complexes.

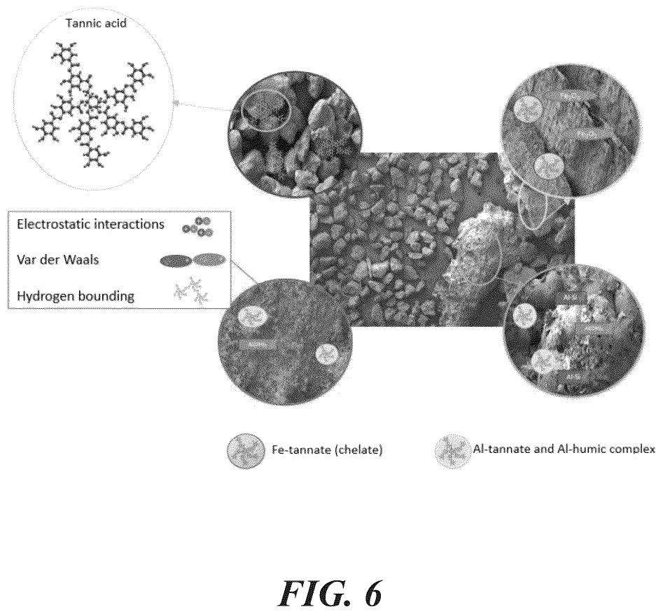

FIG. 6 depicts a graphical summary illustrating a removal mechanism in ZIPGEM, according to an embodiment of the present disclosure. As such, in an embodiment, interactions among at least one component and at least one alternative component within the filtration media may occur throughout the color removal process. In this manner, in this embodiment, the interactions among the at least one compound (e.g., perlite, clay, sand, and ZVI) and at least one alternative compound (e.g., perlite, clay, sand, and ZVI) of the filtration media may thus promote efficient color removal. As shown in FIG. 6, sand and perlite may be configured to work together via the retention of the precipitates (Al-tannin and Fe-tannin complexes) in the porous space while aiding in adsorption. It should be noted that sand, clay, and/or perlite may share removal mechanisms pertaining to Al and/or Al—Si bonds given their chemical composition. As shown in FIG. 3E, in this embodiment, the unique morphology of the filtration media may help the diffusion and/or dispersion of the filtration media, such that the color removal efficiency may be optimized.

Adsorption is still one of the most cost-effective treatment methods for the removal of color for drinking water treatment. Given the influent condition of 175±10 Pt—Co units, the adsorption capacity can be ranked in terms of how long the proposed media sustained the color removal of greater than or equal to 77%. As such, in an embodiment, the filtration media is configured to optimize the color removal efficiency during drinking water treatment. In this manner, in this embodiment, the filtration media may be configured to maintain the effluent below 40 Pt—Co units for at least 14,000 minutes, such that the filtration media may comprise a composition mix of at least 1000 ml by volume (e.g., 1200 ml by volume) and/or the prescribed adsorption capacity. As such, the performance of the filtration media may be attributed to the inclusion of at least one the following, including but not limited to perlite and/or ZVI and/or synergetic effects between clay and sand. Moreover, as compared to the sorption media known in the art (e.g., CTS, IFGEM-1, IFGEM-4, and/or CPS), the adsorption capacity of the filtration media (e.g., at least 25.0 mg of Pt—Co·g⁻¹) may be superior to the adsorption capacity of the rest the sorption media known in the art. Moreover, observed morphology of ZIPGEM shown by SEM indicated a heterogenous surface further supporting the longer duration of color removal observed. Additionally, in this embodiment, the filtration media may comprise at least one synergistic interactions among at least two compounds with unique morphological structure within the composition mix of the filtration media, such that the filtration media may be configured to promote color removal by improving physicochemical interactions via better dispersion and/or diffusion, optimizing color removal efficiency within drinking water treatment.

### Phosphorus Removal Mechanism

In an embodiment, the ZIPGEM-based filtration system may achieve an average percent removal of about 97.9% to about 78.9%, encompassing every value in between, from the initial about 60 minute to about 300-minute range. For example, in some embodiments, ZIPGEM may comprise an approximately 52.8% removal at roughly the 5,480 minutes mark.

In an embodiment, the optimum removal of ZIPGEM may be the result of a synergetic effect among the different ingredients of recycled materials of ZVI, clay, and/or perlite in the filtration media. As such, in this embodiment, the different specialty ingredients (i.e., media components) may contribute to the overall physicochemical characteristics of each media mix in a synergistic way. Each specialty ingredient may be carefully selected to obtain a sorption media mix capable of excelling in the removal of one or more contaminants (i.e., phosphate vs. nitrate) from different water matrices with cost-effective, scalable, and/or sustainable nature. For example, in some embodiments, silicate sand may have a low cost and/or may maintain an appropriated flow rate (Table 1). Silicate sand may also be plentiful while providing an appropriate environment for microbial ecology to thrive, and it is simple to maintain and operate (Valencia et al., 2020). The adsorption of phosphorus to sand is mainly dependent on the Ca⁺² content of the sand (Brix et al., 2001), as the negatively charged phosphorus is attracted to the positively charged Ca⁺² (Equation 12) (Deng et al., 2018, Lei et al., 2018). In addition, the percent content of CA⁺² of ZIPGEM may comprise about 1.0, and/or about 1.1% of the media in terms of element composition, respectively, suggesting that only some phosphorus removal can be associated with the electrochemical interaction of Ca⁺² and/or phosphorus.

Moreover, in an embodiment, the percentage of Fe in ZIPGEM may be much higher than compositions known in the art, owing to the inclusion of recycled ZVI as specialty ingredient of the green sorption media matrices. ZVI can be oxidized by oxygen in the presence of water to form ferrous iron, which may be further be oxidized to ferric iron with oxygen. Subsequently, in this embodiment, phosphate may precipitate with ferrous [Fe(II)] and/or ferric [Fe(III)] iron, further contributing to phosphate removal.

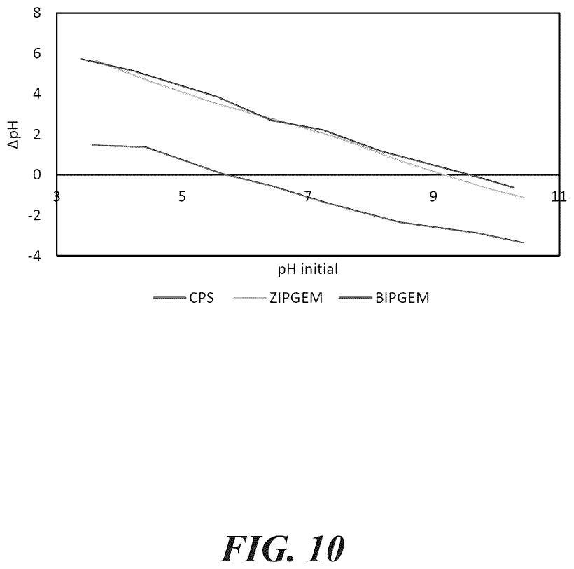

Additionally, in an embodiment, the effect that different pH values have on the adsorption capacity ZIPGEM may be realized via a series of isotherm experiments, as shown in FIG. 10. In this embodiment, the adsorption capacity of ZIPGEM may be superior to the adsorption capacity of the compositions known in the art. Accordingly, the better performance of ZIPGEM may be attributed to the inclusion of ZVI in the specialty ingredients, aiding the adsorption of PO₄⁻³ by electrostatic interaction in response to the varying the location of the PZC in the media and/or increasing PO₄⁻³ precipitation with Fe.

The following examples are provided for the purpose of exemplification and are not intended to be limiting.

### EXAMPLES

### Example #1

Experimental Comparison of ZIPGEM (i.e., filtration media) and Sorption Media Known in the Art (e.g., CTS, IFGEM-1, IFGEM-4, and CPS)

Within the five tested sorption media, a media recipe of Zero-valent-Iron and Perlite Based Green Sorption Media (hereinafter “filtration media” and/or “ZIPGEM) comprising a composition ratio of 85% sand, 5% clay, 6% zero-valent-iron (ZVI) and 4% perlite by volume stood out as the best option for color removal. Findings showed that ZIPGEM (i.e., filtration media) can maintain a color removal of ˜77% for about 14,080 minutes, maintaining the effluent concentration below 40 Pt—Co units given the influent condition of 175±10 Pt—Co units. A recovery on the adsorption capacity of ZIPGEM was observed around 40,000 minutes due to synergetic effects among several different components of recycled ZVI, clay, sand, and perlites. ZIPGEM can be applied to industrial wastewater treatment for dye removal as well.

Five sorption media, including Clay-Tire crumb and Sand sorption media (denoted CTS, hereafter), Iron-Filing Green Environmental media 1 and 4 (denoted IFGEM-1 and IFGEM-4, hereafter, respectively), Clay-Perlite and Sand sorption media (denoted CPS, hereafter) and Zero-valent Iron and Perlite Green Environmental Media (denoted as ZIPGEM), were tested to evaluate their effectiveness to remove color from a source water collected from a water canal polluted with tannic acid.

The tannic acid in this canal is high given the abundant in cypress forests within the water sample area. Among these sorption media, CTS and IFGEM-1 were previously studied for nutrient and metal removal (Chang et al., 2019a; Chang et al., 2019b; Valencia et al., 2019; Wen et al., 2018; Chang et al., 2020). IFGEM-4, CPS and ZIPGEM were developed, due to the potential contribution of coupled perlite and zero-valent iron (hereinafter “ZVI”) on the top of traditional sand and clay to the removal of color. The research objective and novelty associated with exploring and comparing the effectiveness of five sorption media (made from recycled materials) which are cheaper than activated carbon to treat water with high concentration of color and to examine whether they can meet the regulatory requirement (i.e., 40 Pt—Co color unit) in the St. Johns River Water Management District for source water pretreatment (SJRWMD, 2021). The questions to be answered were: (1) Is there any incremental effect on color removal from the sequential use of recycled iron filings and perlite? (2) What is the removal mechanism of color the proposed sorption media composition comprising components of recycled iron filings, clay, and perlite? (3) Which media mix of the five used can achieve the best color removal efficiency?

### Material and Methods

Lake Brooklyn near Keystone Heights in Clay County, Florida, the United States (US) is facing a problem with low water level which is affecting recreational use and nearby shallow aquifer drinking water wells. Some wells have gone dry due to aquifer overuse, and hence the Lake Brooklyn is in acute need of replenishment. A state project to pump water from the Black Creek South Prong, a tributary of the St. Johns River, to Lake Brooklyn to recharge the semi-confined Upper Floridian aquifer at Keystone Heights has moved forward with the recent land acquisition needed for the about 27-km pipeline through southwest Clay County. The Floridan aquifer is one of the main sources of groundwater in the US and it is mainly composed of limestone and dolomite beds. The Floridan aquifer has confined, unconfined, and semiconfined areas, where the areas in the St. Johns River Management District are mostly semiconfined (Kat B. G., 1992). This is the first attempt in Northeast Florida for a project of this magnitude and will take up to 37,000 metric tons per day (e.g., 10 million gallons per day) from Black Creek, as shown in FIGS. 1A-1B. However, the interbasin water transfer project is hampered by the excessive concentration of color in Black Creek. Brown reddish color in this creek is the product of the high amount of tannic acid reaching the water body from cypress trees surrounding this area, as shown in FIGS. 1C-1D.

Before water can be transferred to the Upper Floridan aquifer, the water from Black Creek needs to be treated for color removal in situ. Current concentrations in this region range from 170 to 325 Pt—Co color units. However, the St. John River Management District standard for drinking source water is less than 40 color units Pt—Co (SJRWMD, 2021) before the interbasin transfer is allowed. Given the low cost associated with adsorption processes, and low maintenance requirements for filtration facilities, column studies to compare the application of sorption media were conducted to find the most appropriate design. Water collected from Black Creek was used as the influent for the column studies and was collected in 18.9×10⁻³ m³ plastic buckets and stored at the University of Central Florida (UCF) in a walk-in refrigerator set at a temperature of −17.8° C.

### Composition and Characterization of the Sorption Media

The five sorption media compositions were tested systematically for their potential to remove color from Black Creek water. The composition and matrix of the sorption media studied are summarized in TABLE 1. To further explore the effect on zero valent iron (ZVI) (e.g., iron filings) as component of the media, new iron-sand based sorption media mixes, known as IFGEM-1 and IFGEM-4, were developed. Furthermore, the utilization of perlite for the removal of contaminant (i.e., metals, dyes, and nutrients) is a novel development (Alakan and Dogan, 2001; Hosseini and Toghroli, 2021; Moussavi and Bagheri, 2012). It has been suggested in the prior studies that perlite has considerable potential to remove methyl violet dye from aquatic solutions, and its efficiency improves with increasing temperature and pH. (Dogan and Alkan, 2003) Such studies substantiate the inclusion of perlite in two newly developed sorption media denoted as Clay-Perlite and Sand media (denoted as CPS, hereafter) and Zero-valent Iron and Perlite Green Environmental Media (denoted as “ZIPGEM”, hereafter (i.e., the filtration media)). The media compositions followed previous ones. (Valencia et al., 2021). Presently, as shown in TABLE 1, the CTS media mix was used as control to compare against iron-based media mixes, including IFGEM-1 and IFGEM-4, as well as perlite-based media mixes, including CPS and ZIPGEM.

TABLE 1

| Media name | Media Matrix (% by volume) |
|---|---|
| CTS | 85% sand, 5% clay, 10% tire crumb |
| IFGEM-1 | 96.2% sand and 3.8% ZVI |
| IFGEM-4 | 90% sand and 10% ZVI |
| CPS | 92% sand, 5% clay and 3% perlite |
| ZIPGEM | 85% sand, 5% clay, 6% ZVI and 4% perlite |

These five sorption media were characterized by hydraulic conductivity (m·sec⁻¹), BET surface area (m²·g⁻¹), porosity (%), bulk density (g·cm⁻³), and chemical composition (% per element). Media samples were delivered to the laboratories of EMSL Analytical, Inc. in Orange City, Florida for the measurement of grain size distribution, bulk density and BET surface area. The methods ASTM D422, ASTM D854 and ASTM B922 for particle size analysis for soils, specific gravity of soils and standard test methods for metal powder specific surface area by physical adsorption, respectively, were followed.

The hydraulic conductivity (or intrinsic permeability) was determined in a standard permeameter following the protocol for Constant Head Permeability test in the Geotechnical Laboratory at UCF. The porosity and the hydraulic retention time (HRT) of the sorption media were measured at UCF. The porosity was determined by measuring the volume of water needed to fill the pores of a dry media sample. The HRT was determined via a tracer examination with Rhodamine dye (CAS Number 37299-86-8). Rhodamine dye was selected due to low cost, easy operation and detection via a fluorometer, low natural background, limited toxicity level, and nonreactivity (Richard et al., 2004). For the tracer examination, about 1 ml of Rhodamine dye was injected at the top of the column, subsequently effluent samples were collected at 5-10 min intervals and measured by an Aquaflour™ (Turner Designs 998-0851) handheld fluorometer until the rhodamine dye breakthrough was observed and completed.

The chemical compositions of the different media were analyzed via an X-Ray Fluorescence Spectrophotometer (XRF) PANalytical Epsilion at the Materials Characterization Facility (MCF) at UCF (Dewi et al., 2018). Textural characterization of the media was obtained at the MCF at UCF with a Scanning Electron Microscopy (SEM) Jeol JSM-6480 SEM instrument. The Jeol SEM allows a variable pressure mode of operation allowing microscopy of non-conductive, oily, and damp samples.

As shown in FIG. 2, the results of the sieve analyses were plotted to obtain the grain size distribution curves or gradation curves from each sorption media mix. These results were used to evaluate whether these sorption media were poorly or well graded. To do so, the coefficient of uniformity (hereinafter “Cᵤ”) and the coefficient of gradation (“C_{c}”), which are the common measures of soil gradation, were calculated based on Equation (1) (hereinafter “Eq.”) and Eq. (2) for these media mixes. Within this context, D₆₀, D₃₀ and D₁₀ is the grain diameter at 60%, 30% and 10% finer, respectively. The higher the Cᵤ value the higher the range of particle size. If the Cᵤ is greater than 4 and less than 6 then the media mix is classified as well graded, but, if the Cᵤ is less than 4 then the media mix is classified as poorly graded. However, for a media mix to be well graded, the C_{c} value must range between 1 and 3.

$${C}_{u} = \frac{{D}_{60}}{{D}_{10}} \qquad Eq . ( 1 )$$

$${C}_{c} = \frac{{D}_{30}^{2}}{{D}_{60} {D}_{10}} \qquad Eq . ( 2 )$$

### Experimental Set-Up for Column Exam:

A series of experiments with fixed bed columns was performed for the purpose of exploring the color removal efficiency and life expectancy of these selected sorption media. Columns 30.48 cm (12 in) in depth and 7.62 cm (3 in) diameter were filled with 1200 ml of the selected sorption media (i.e., CTS, IFGEM-1, CPS, IFGEM-4 and ZIPGEM) and a 5.08 cm (2-in) free space was left above the media in case of overflow. Each column set-up included a filter and a layer of pebbles at the bottom to prevent clogging, while a layer of pebbles was placed at the top of each column to aid in water distribution.

All column experiments were operated with a downward flow, simulating the planned implementation at field scale. Before the experiment, each column was flushed with de-ionized water (DI) at a flowrate of 8 ml·min⁻¹ for approximately 3 bed volumes and left to drain for >10 hours to remove any pre-existing contaminants in the sorption media. Subsequently, water collected from the Black Creek tributary of the St. Johns River (denoted as influent, hereafter) was supplied to each column via a peristaltic pump at a fixed flowrate of 4 ml . . . . The color concentration of the influent was modified to 175±10 Pt—Co units by adding DI water if necessary to maintain the same influent color concentration for all the column experiments. T for the column studies the hydraulic loading rate maintained was 1.26 (m³·day⁻¹·m⁻²).

### Water Parameter Analysis

Water samples from the influent and effluent at distinct time intervals were collected, analyzed, and catalogued to obtain information on color removal. All water samples were analyzed for color within 24 hours of collection to prevent any biological and chemical processes from altering color concentrations. All water sample analysis were performed at the Environmental Engineering Laboratories at UCF. true color of each water sample was measured using a Hach Method 8025 spectrophotometer. First, water samples were filtered through a Millipore Sigma MF-Millipore Cellulose Ester membrane with 0.45-μm pore size. Subsequently, 10 ml of filter samples were used to fill a 465 nm cell and placed in the DR-5000 Hach Spectrophotometer meter to measure and catalogue true color concentrations.

### Dynamic Adsorption Models

Dynamic modeling of the breakthrough curves allows the understanding of the sorption behavior of color to the sorption media. Thomas, Modified Dose Response (hereinafter “MDR”), and Yoon-Nelson models were selected to characterize the dynamic sorption mechanism. The Thomas model is derived from the Langmuir adsorption isotherm to describe the equilibrium between adsorbate and adsorbent where diffusion is neglected (Ghasemi et al., 2011; Mustafa and Ebrahim, 2010). The MDR model is an empirical model, appropriate for applications in breakthrough curves that have an asymmetric behavior (Chang et al., 2016). The Yoon-Nelson model is the simplest dynamic adsorption model as it does not require information on the adsorbent, adsorbate, or the physical characteristics of the sorption bed (Ghribi and Chlendi, 2011). The linear forms of these dynamic adsorption models with the definitions of parameters are shown in TABLE 2.

TABLE 2

| Model | | |
|---|---|---|
| name | Linear Form | Parameters |
| Thomas | $ln [ ( \frac{{C}_{O}}{{C}_{t}} ) - 1 ] = \frac{{k}_{T} {q}_{o} m}{Q} - {k}_{T} {C}_{0} t$ | k_{T} = Thomas rate constant (L · mg of |
| | | Pt-Co⁻¹ · min⁻¹) |
| | | qₒ = media equili- |
| | | brium uptake (mg |
| | | of Pt-Co · g⁻¹) |
| | | m = mass of media |
| | | in the column (g) |
| | | Q = flow rate (L · |
| | | min⁻¹) |
| MDR | $ln ( \frac{{C}_{t}}{{C}_{O} - {C}_{t}} ) = {a}_{mdr} ln ( {C}_{O} {Q}_{t} ) - {a}_{mdr} ln ( {q}_{o} m )$ | a_{mdr} = MDR rate constant |
| | | qₒ = media equili- |
| | | brium uptake (mg · |
| | | g⁻¹) |
| | | Q = flow rate (L · |
| | | min⁻¹) |
| | | m = mass of media |
| | | in the column (g) |
| Yoon- Nelson | $ln ( \frac{{C}_{t}}{{C}_{0} - {C}_{t}} ) = {k}_{YN} t - τ {k}_{YN}$ | τ = half time (min) k_{YN} = Yoon Nelson |
| | | rate constant |
| | | (min⁻¹) |

*Cₒ corresponds to the influent concentration (in color unit Pt-Co), Cₜ corresponds to the effluent concentration at time t (in color unit Pt-Co) and t stands for time (in minutes).

To improve the goodness of fit of the dynamic adsorption models, a method for outlier detection and removal was performed. Detection of outliers from the data sets was accomplished by drawing 95% confidence intervals (CI) around the scatter plots of the effluent concentration (in color units) vs. time (minutes). Outliers outside of the 95% CI were removed from the data sets. Moreover, these steps were performed multiple times after the removal of outliers until all data points were within the 95% CI (Uusipaikka, 2008).

### Life Expectancy

For field implementation, it is important to determine the frequency of media replacement after treatment capacity has been exhausted. This can be achieved by formulating life expectancy curves for a range of removal efficiencies (e.g., 40-90%) to treat a volume of color impacted water. To estimate the media's replacement frequency, first the media usage rate (i.e., Eq. 3) is determined according to the target removal efficiency (R). The usage rate (g·L⁻¹) specifies the mass of media in grams that can treat 1 L of water based on the desired effluent concentration. As a result, each removal efficiency will have its corresponding usage rate and thus corresponding life expectancy curve. The determination of usage rate employs the influent concentration C₀ (mg·L⁻¹), the average target effluent concentration C₁ (mg·L⁻¹) (where C₁=C₀ (1−R)), and the maximum adsorption capacity q₀ (mg·g⁻¹) selected from the appropriate dynamic adsorption model that can best describe the experimental data collected from column studies. The modeled R is dependent on the reasonable range of color removal obtained from the column exam. To produce the life expectancy curves, a range of volume of treated water V_{water treated} (L) is selected to calculate the corresponding range of mass of media required for treatment mass_{media} (g) according to Eq. 4.

Additionally, since the determination of the media's replacement frequency is dependent on the flow rate specified, the design flow rate (Q in L·h⁻¹) needs to be first selected by taking into account the maximum flow rate (Q_{threshold} in L·h⁻¹) considered as the design threshold and it is preferred for Q to be less than Q_{threshold}. Having an understanding of the Q_{threshold} is crucial to prevent possible ponding effect. In this case, gravity is assumed to dominate the flow path contributing to vertical flow as the filter depth is small (i.e., 0.3-0.6 m). Hence the laboratory HRT determined from the column tracer exam is utilized to determine the Q_{threshold} (i.e., Eq.6) to be representative when scaling from a laboratory examination up to a filed application. To estimate the life expectancy, the void volume or pore space (V_{void} in m³) corresponding to the available water retention capacity in the media is first determined from Eq.5, using the media mass, media porosity Ø, and density (ρ_{media} in kg·m⁻³). Once the design flow rate (Q) is selected, the surface area of the filter cell is determined from the hydraulic loading rate (HLR in m³/m² d⁻¹) based on the experimental column-exam conditions following Eq. 7. The volume of the cell V_{cell} (m³) representing the volume occupied by the media is determined according to the area area_{design} (m²) and the depth of cell depth_{filter} (m) (i.e., Eq.8). Hence, the mass_{media design} corresponding to the filter cell dimensions and the density of media, can be calculated according to Eq. 9. Lastly, the life expectancy is calculated from Eq. 10, for a specified media mass (mass_{media design}) corresponding to filter design and the design flow rate (Q). A design chart can be generated accordingly with a few turning lines to link the target removal efficiency curve with the treated water in volume and the selected mass of media.

$$Usage Rate = \frac{{c}_{0} - {c}_{1}}{{q}_{0}} \qquad Eq . ( 3 )$$

$${V}_{water treated} = \frac{{mass}_{m e d i a}}{usage rate} \qquad Eq . ( 4 )$$

$${V}_{v i o d} = {mass}_{m e d i a} ( ∅ ) ( \frac{1}{{ρ}_{m e d i a}} ) \qquad Eq . ( 5 )$$

$${Q}_{threshold} = \frac{{V}_{v o i d} * conversion factor ( \frac{1000 L}{1 {m}^{3}} )}{H R T} \qquad Eq . ( 6 )$$

$${area}_{surface} = \frac{Q * ( \frac{1 {m}^{3}}{1000 L} )}{H L R} \qquad Eq . ( 7 )$$

$${V}_{c e l l} = {area}_{surface} * {depth}_{c e l l} \qquad Eq . ( 8 )$$

$${mass}_{media design} = {V}_{cell} * {ρ}_{m e d i a} \qquad Eq . ( 9 )$$

$$Life Expectancy = {V}_{design water treated} ( \frac{1}{Q} ) * conversion factor ( \frac{d}{24 h} ) \qquad Eq . ( 10 )$$

### Results and Discussion

The physical characteristics of the five selected sorption media (i.e., CTS, IFGEM-1, IFGEM-4, CPS, and ZIPGEM) are provided below in TABLE 3. Among the selected sorption media, ZIPGEM has the largest surface area (2.55 m²·g⁻¹) followed by IFGEM-4, CPS, CTS, and IFGEM-1. Larger surface area can lead to have better adsorption potential (Wang et al., 2014). In terms of porosity CTS has the highest porosity (40.10%) followed by IFGEM-1, ZIPGEM, CPS, and finally IFGEM-4. The saturated hydraulic conductivity for all media is within the typical range for sand (10⁻³ to 10⁻⁵ m·sec⁻¹) (Reddi and Inyang, 2000), indicating appropriateness for field implementation. Finally, the inclusion of ZVI in the sorption media can be associated with the resultant higher density and larger surface area in ZIPGEM contributing to better color removal.

TABLE 3

| | BET | | | Saturated |
|---|---|---|---|---|
| | Surface | | | Hydraulic |
| Media | Area | Porosity | Density | Conductivity |
| name | (m² · g⁻¹) | (%) | (g · cm⁻³) | (m · sec⁻¹) |
| CTS | 0.86 | 40.10 | 2.40 | 2.6 · (10⁻⁴) |
| IFGEM-1 | 0.31 | 36.16 | 2.73 | 2.8 · (10⁻⁴) |
| IFGEM-4 | 2.33 | 25.97 | 3.01 | 1.7 · (10⁻⁴) |
| CPS | 1.08 | 26.48 | 2.61 | 1.7 · (10⁻⁴) |
| ZIPGEM | 2.25 | 29.04 | 2.80 | 2.8 · (10⁻⁴) |

The gradation curves or particle size distribution curves of each sorption media are presented in FIG. 2. The uniformity coefficient (Cu) and the coefficient of gradation (Cc) are the measures of soil properties and are presented in FIG. 2. For the media mix to be well graded, the value of C_{c} must range between 1 and 3. The value of C_{c} of IFGEM-4 is slightly larger than others while all of them are smaller than 2. This implies all five media mixes are poorly graded. Higher value of Cᵤ indicates that the media mix consists of media particles with different size distributions. All the Cᵤ values are below 4 signifying that all sorption media are poorly graded. But CTS has the highest Cᵤ value among the five media mixes. What followed CTS are IFGEM-4, IFGEM-1, ZIPGEM, and CPS.

In addition to physical characterization of the media mixes, samples were evaluated via an XRF analysis to describe the chemical composition of the media mixes, as provided below in TABLE 4. The main chemical element in all mixes was silica (Si), as shown in TABLE 4, provided below. As known in the prior art, amino-functionalized magnetic mesoporous silica can remove tannic acid from aqueous solution by adsorption. (Wang et al., 2010) The second most abundant chemical components for all sorption media mixes, excluding IFGEM-1 is aluminum (Al). The presence of Al as a chemical component in the sorption media mixes can be explained by the inclusion of clay as key ingredient of the mixes (Nayak et al., 2007). Al is utilized for removal of diverse contaminants including nutrients, metals, and contaminants of emerging concern (Nouri et al., 2010; Ordonez et al., 2020; Zaied et al., 2020). The inclusion of recycled ZVI (e.g., 95.6% Fe) as an ingredient of the sorption media for the removal of contaminants is highly promising given its reactivity, large surface area, lower cost, and environmentally friendly nature (Khuntia et al., 2019). Furthermore, K and Ca (e.g., 1-2.5% and/or 0.7-1%) are also part of the chemical composition of the sorption media mixes, and thus, to some extent their presence can aid in a synergistic effect that can be helpful for the removal of contaminants.

TABLE 4

| Compound | CTS | IFGEM-1 | IFGEM-4 | CPS | ZIPGEM |
|---|---|---|---|---|---|
| Al (%) | 8.6 | 10.1 | 2.4 | 9.8 | 9.3 |
| Si (%) | 86.0 | 81.7 | 90.4 | 84.6 | 83.4 |
| P (%) | 1.8 | 1.8 | 1.6 | 1.8 | 1.7 |
| K (%) | 2.2 | 1.0 | 1.8 | 2.4 | 2.5 |
| Ca (%) | 1.0 | 0.7 | 0.7 | 1.0 | 0.8 |
| Fe (%) | 0.3 | 4.8 | 3.1 | 0.5 | 2.4 |

Images of the media mixtures attained from SEM analysis are presented in FIGS. 3A-3E. The images complement the physical characteristics in providing a visualization of the media mixes at the microscale. The most salient change among the selected sorption media is the color, as the darkish brown tone increases with the increasing concentration of ZVI. Moreover, the media morphology indicates that ZIPGEM particles are the most heterogenous in size and shape which may provide 3-dimensional morphological structures with a higher hydraulic conductivity at the microscale to promote molecular diffusion in a multi-layer structure during an adsorption process. Poorly graded materials with morphological structures would have higher potential to allow dispersion and molecular diffusion to occur in layer-by-layer films during the adsorption process. As known in the art, such a unique process can be formed by the following four steps: (1) mass transfer in a liquid phase via convective mass transfer followed by molecular diffusion; (2) interface diffusion via film diffusion between the liquid phase and the exterior surface of the adsorbent; (3) intrapellet mass transfer through surface diffusion and pore diffusion; and (4) the adsorption-desorption reaction before and after equilibrium. (Crittenden et al., 1986) On the other hand, IFGEM-4 had the higher number of larger particles along with a larger surface area and lower hydraulic conductivity given its higher content of ZVI and better gradation, all prone to form a monolayer structure in an adsorption process.

To further visualize the physical difference of the sorption media and analyze material morphology, and structure of the key elements of the media materials, SEM images of sand, clay, ZVI, and perlite are presented in FIGS. 4A-4D. When compared to sand and clay in general, ZVI and perlite have greater morphological structure variability. As shown in FIG. 4C and FIG. 4D, perlite exhibits more morphological alterations in nuclei, vacuoles, and shapes suggesting sophisticated surface areas for intraparticle diffusive processes during adsorption. ZVI has surface structural, morphological, and chemical attributes that can aid in oxidation and adsorption by increasing the available contact spaces for water and oxygen. The clay particles exhibit a crystalline structure. Moreover, the smaller particle sizes of clay can overpower the benefits of clay richness in Al if the content of clay in the sorption media is too high, as it can create possible clogging issues due to blockage of the pore spaces of the media. The richness of perlite and sand in Si and Al can provide larger particle size and reduce clogging issues in sorption media. Hence a suitable media mix is critical to further support sorption and adsorption for color removal.

### Color Removal Efficiency of Sorption Media

To meet the requirement imposed by the St. John River Management District for source water, color concentration of source water must be less than 40 Pt—Co color units. As the influent water influent concentration is 175±10 Pt—Co units the media needs to achieve about 77% color removal. The results are provided in terms of time (minutes) vs. color removal efficiency (%) and are presented in FIGS. 5A-5J, and the times when the media removal efficiency drop below 77% and the terminal time point of the five media reaching the regulatory limit in this column exam are summarized in TABLE 5, provided below. When comparing the results, as shown in FIG. 5C and FIG. 5D, it is observed that the color removal efficiency for IFGEM-1 was the first one to drop below 77% after 200 minutes, resulting in effluent concentration above the standard (40 Pt—Co color units). Following IFGEM-1, as shown in FIGS. 5A-5B and FIGS. 5E-5J, in ascending order is CPS, CTS, IFGEM-4, and ZIPGEM which maintained appropriate color removal for the first 325, 600, 1,500 and 14,080 minutes respectively, as shown in TABLE 5. While IFGEM-1 was the first one to drop below 77% removal efficiency, it reached terminal time point later than CTS (2,652 minutes), as shown in FIG. 5A and FIG. 5B, and CPS (5,820 minutes), as shown in FIG. 5G and FIG. 5H. The extended breakthrough curve for IFGEM-1 can be associated with the presence of ZVI, which can contribute to color removal by ionic interactions. The benefit of ZVI in some media mixes can be further observed by the results of IFGEM-4, as shown in FIG. 5E and FIG. 5F, obtaining color removals above 77% for about 1,500 minutes. Some of the media reached terminal time point due to ponding issues before the end of the life cycle of media, indicating that the ZVI content in the media might be too high.

The sorption media ZIPGEM, a media mix of ZVI, perlite, clay, and sand stood out at the final stage for the color removal. As shown in FIG. 5I and FIG. 5J, ZIPGEM had the best performance among all the media compositions tested, as effluent concentrations below 40-unit Pt—Co were observed for prolonged times. Additionally, a possible recovery of the adsorption capacity of ZIPGEM around 40,000 minutes was observed when the color removal efficiency increased to ˜74.5%. Such phenomenon might be due to the synergetic effects among several different components of ZVI, clay, sand, and perlites. However, ZIPGEM showed ponding and clogging issues at time 52,480 minutes (875 hours), before the media reached the end point of life cycle.

Clogging and ponding may be associated with the ZVI particles undergoing oxidization resulting in iron oxide clogging of the pore space in the media mix and affecting the infiltration negatively. Given that some Al and Fe can be dissolved in water the major tannic acid removal mechanism could be chemical precipitation driven by the formation of solid organometallic complexes, the emergence of Al-tannate can also contribute to clogging issues. The higher the content of ZVI, the larger the chance to have a ponding effect due to accumulation of aluminum and iron salts on the surface of Si (found in sand). The ZVI and Sand ratio were calculated for IFGEM-1, IFGEM-4 and ZIPGEM based on the media matrix, as shown in TABLE 1, resulting in 0.04, 0.11 and 0.071 (ZVI/Sand percent by volume), with these results it can be recommended that, to avoid ponding issues, the ZVI to sand ratio should be less than 0.071. However, since the clogging issue in ZIPGEM occurred long after the media stopped efficiently treating the influent when the color exceeded 40-unit Pt—Co, this issue is not an immediate concern. The strong performance of ZIPGEM can be attributed to a larger surface area and hydraulic conductivity, high porosity, and better morphological structure among the media mixes, with stronger ionic interactions, van der Walls forces, and hydrogen bonding effect.

TABLE 5

| | | Time for the | Terminal |
|---|---|---|---|
| | Mass of media | effluent to be <40 | time point |
| Media name | (kg) | Pt—Co (minutes) | (minutes) |
| CTS | 1.60 | 600 | 5820 |
| IFGEM-1 | 1.44 | 200 | 11460 |
| IFGEM-4 | 1.84 | 1,500 | ^{a}4602 |
| CPS | 1.28 | 325 | 2675 |
| ZIPGEM | 1.64 | 14,080 | ^{a}52,480 |

^{a}Terminal time points were reached due to clogging issues.

### Removal Mechanism

Tannic acid has a tendency to spontaneously adsorb to different surfaces to yield a hydrophilic coating (Ball and Meyer, 2016). Kaal et al. (2005) suggested the interactions between soil minerals and tannins result in adsorption. Wang et al. (2010) discovered that the adsorption mechanism is heterogeneous, and dependent on pH and ionic strength. Ball et al. (2016) indicated that the adsorption of tannic acid to silicate is completed after about 15 minutes revealing that it produces a thin layer on SiO₂. The removal of tannic acids with clay is also related to adsorption. Attapulgite/CoFe₂O₄ was developed by Teng et al. (2019) for tannic acid removal, and the main mechanism responsible for the sorption was hydrogen bonding and surface complexation. As mentioned by Amari et al. (2021), however, attapulgite clay coated with chitosan was found to adsorb 95.3 mg g⁻¹ of tannic acid driven by electrostatic interactions, hydrogen bonding, and Van der Waals forces (Deng et al., 2012). Furthermore, since the anionic functional groups of tannic acid include hydroxyl and carboxyl groups it can adsorb on oxide surfaces (Zhang et al., 2009). Tannic acid is negatively charged, hence Ca²⁺ can aid to bind negatively charged surfaces such as species of tannic acid (Perez-Benito, 2003; Zhang et al., 2009).

Besides, an Al ion has the possibility of interacting with multiple tannic acid molecules and the formation of insoluble complexes resulting from aluminum compounds such as Al—OH at low and high pH. While at pH between 5-6, when Al(OH)₃ is the predominant form, complex formation is replaced by adsorption onto Al(OH)₃ surface (Georgantas and Grigoropoulou, 2006). The coprecipitation of tannic acid with Al(OH)₃. occurs in the presence of hydrous aluminum oxide (e.g., Al(OH)₃) leading to soluble colloidal hydroxy-Al-tannate complexes (Omoike, 1999). In the case of humic substances, Al-humic complexes are formed, and charge neutralization occurs (Georgantas and Grigoropoulou, 2006). Similarly, since tannic acid is a polymeric molecule, it can chelate with Fe³⁺ ions, producing an insoluble complex where the structure is contingent on the solution pH (Al-Mayouf, 1997).

Given the composition of NOM present in natural water, the color removal mechanism encompasses the process of precipitation, charge neutralization, entrapment, adsorption, and complexation with coagulant metal ions into insoluble particles. The reduction in tannic acid in water can also be attained by precipitation leading to the formation of solid complexes which can be separated in processes like coagulation and sedimentation. Omoike (1999) examined the effect of tannic acid on phosphate and organism matter removal during wastewater treatment. Inorganic salts of aluminum or iron are primary coagulants in natural or engineered systems that can hydrolyze to generate insoluble precipitates and entrap particles, neutralizing the charge on the particles. As mentioned previously, accumulation of positively charged aluminum and iron salts (i.e., coagulating metal ions) on the surface of Si given the suitable pH values in water, could also attract negatively charged particles. NOM removal with ferric salts has been reported in a range for 29-70% (Uyak and Toroz, 2007) and NOM can also react with polyvalent metal cations producing soluble metal-NOM complexes (Li et al., 2016).

As shown in FIG. 6, interactions among components in media mixes are. For example, Fe and sand interactions in Fe-oxide coated quartz (i.e., Qtz) sand were explored by Kaal et al. (2005) for tannic acid retention given the potential for tannin-Fe oxide binding. The interactions among the main components (i.e., perlite, clay, sand, and ZVI) of ZIPGEM thus promote efficient color removal. Sand and perlite can work together via the retention of the precipitates (Al-tannin and Fe-tannin complexes) in the porous space while aiding in adsorption. It should be noted that sand, clay, and perlite may share removal mechanisms pertaining to Al and Al—Si bonds given their chemical composition. Furthermore, as shown in FIG. 5I and FIG. 5J, the unique media morphology of ZIPGEM (i.e., the filtration media) helps diffusion and dispersion. Dissolved Al comes from clay and perlite when pH values are appropriate.

### Dynamic Adsorption Modeling

The Yoon Nelson model is a kinetic empirical model that allows the estimation of the time needed for the media to reach 50% breakthrough (τ) (Cₜ/Cₒ=50%). For CTS, IFGEM-1, IFGEM-4, CPS, and ZIPGEM this value was estimated as 2,152, 9,840, 3,382, 1,151 and 62,023 minutes, respectively. Alternatively, Thomas model parameters were selected for comparison as their predictions were consistent having an appropriate r-squared value for all media (R²>0.6). By comparing the qₒ it can be observed that ZIPGEM has the highest adsorption capacity (27.1 mg of Pt—Co·g⁻¹) among the tested sorption media. Thus, the efficiency of the media can be categorized in descending order based on the adsorption capacities (qₒ) as ZIPGEM<IFGEM-1<IFGEM-4<CTS<CPS. Furthermore, in comparison to the Thomas model which predictions of qₒ for all the media were consistent, the MDR model showed an inconsistent prediction in qₒ for ZIPGEM (qₒ=421.52 mg of Pt—Co·g⁻¹). Thus, despite the higher r-squared value for MDR model, it was not selected as the preferred model to estimate the dynamic adsorption capacity, as provided below in TABLE 6.

TABLE 6

| Media | Model | R² | Parameter |
|---|---|---|---|
| CTS | Thomas | 0.858 | k_{T} = 3.94 (10)⁻⁶ L · mg of Pt—Co⁻¹ · min⁻¹ |
| | | | q₀ = 1 mg of Pt—Co · g⁻¹ |
| | MDR | 0.898 | a_{mdr} = 1.22 |
| | | | q₀ = 0.494 mg of Pt—Co · g⁻¹ |
| | Yoon- | 0.858 | k_{YN} = 7(10)⁻⁴ min⁻¹ |
| | Nelson | | τ = 2,151.57 min (1.49 day) |
| IFGEM- | Thomas | 0.606 | k_{T} = 6 (10)⁻⁷ L · mg of Pt—Co⁻¹ · min⁻¹ |
| 1 | | | q₀ = 4.80 mg of Pt—Co · g⁻¹ |
| | MDR | 0.731 | a_{mdr} = 0.44 |
| | | | q₀ = 2.66 mg of Pt—Co · g⁻¹ |
| | Yoon- | 0.606 | k_{YN} = 1.5(10)⁻³ min⁻¹ |
| | Nelson | | τ = 9,840 min (6.83 day) |
| IFGEM- | Thomas | 0.939 | k_{T} = 5.03 (10)⁻⁶ L · mg of Pt—Co⁻¹ · min⁻¹ |
| 4 | | | q₀ = 1.31 mg of Pt—Co · g⁻¹ |
| | MDR | 0.960 | a_{mdr} = 1.40 |
| | | | q₀ = 0.03 mg of Pt—Co · g⁻¹ |
| | Yoon- | 0.939 | k_{YN} = 9(10)⁻⁴ min⁻¹ |
| | Nelson | | τ = 3,382.33 min (2.35 day) |
| CPS | Thomas | 0.928 | k_{T} = 8.38 (10)⁻⁶ L · mg of Pt—Co⁻¹ · min⁻¹ |
| | | | q₀ = 0.64 mg of Pt—Co · g⁻¹ |
| | MDR | 0.885 | a_{mdr} = 1.09 |
| | | | q₀ = 0.37 mg of Pt—Co · g⁻¹ |
| | Yoon- | 0.928 | k_{YN} = 1.5(10)⁻³ min⁻¹ |
| | Nelson | | τ = 1150.73 min (0.8 day) |
| ZIPGEM | Thomas | 0.676 | k_{T} = 1.67(10)⁻⁷ L · mg of Pt—Co⁻¹ · min⁻¹ |
| | | | q₀ = 27.1 mg of Pt—Co · g⁻¹ |
| | MDR | 0.354 | a_{mdr} = 0.27 |
| | | | q₀ = 421.52 mg of Pt—Co · g⁻¹ |
| | Yoon- | 0.676 | k_{YN} = 3(10)⁻⁵ min⁻¹ |
| | Nelson | | τ = 62,023.3 min (43 day) |

Comparison of ZIPGEM with Other Adsorbents

The advantages of low cost, feasible field application and easy maintenance motivated innovation of different adsorbents, including agricultural waste, activated carbon, activated alumina, and zero-valent iron among the most popular. The color removal using the activated sand showed an efficacy of 70% in the first 3 minutes while the non-modified sand had an efficacy of 40%. More comparisons of different adsorbents for color removal are summarized in TABLE 7.

TABLE 7

| Adsorbent | Adsorbent capacity | | Description |
|---|---|---|---|
| Activated clay | 153 and 28.3 mg · g⁻¹ | | Tannic acid and humic |
| | | | acid |
| Amino- | 510.2 | mg · g⁻¹ | Tannic acid |
| functionalized | | | |
| magnetic | | | |
| mesoporous silica | | | |
| Sunflower stalks | 105 and 317 mg · g⁻¹ | | Methylene and basic |
| | | | red 9 |
| Orange Peel | 19.88 | mg · g⁻¹ | Aid Violet |
| Citrullus Lanatus rind | 11.9 | mg · g⁻¹ | Crystal Violet |
| Iron based sludge | 625, 833.34 and | | Direct blue 71, acid |
| | 333.34 mg · g⁻¹ | | blue 40 and basic |
| | | | violet blue 16. |
| Spherical Fe₃O₄ | 630 | mg · g⁻¹ | Congo red dye |
| nanoparticles | | | |

| | | |
|---|---|---|
| ZIPGEM | 27.1 mg of Pt—Co · g⁻¹ | Color |

### Application Potential

Different electrochemical, physicochemical, and photocatalytic methods allow for the removal of dyes for industrial wastewater treatment. In the traditional technology hub, microfiltration, ultrafiltration, and nanofiltration for removal of humic substances have shown potential and can remove 90% of humic acids in water treatment plants (Lowe and Hossain, 2008). The removal of NOM (i.e., tannic and humic acid) by photocatalytic methods is an effective method too. An example is the degradation of dyes, detergents, and organic acids by TiO₂ nanofilms (Albu et al., 2007) with the aid of UV light due to their photocatalytic activity (occurring at UV absorbance at the range of 254 nm˜370 nm) (Quan et al., 2005, Qaseem et al., 2020). In addition, the removal of tannic acid from wastewater by electrochemical oxidation was confirmed by Govindaraj et al. (2010). However, most of these existing technologies are costly and operationally complex due to regeneration and/or final disposal of sorbents while ZIPGEM can be used as daily coverage at landfills. It is helpful to estimate the replacement frequency upon the exhaustion of all adsorption capacity or reach the threshold (e.g., regulatory limit) to maintain reliable treatment.

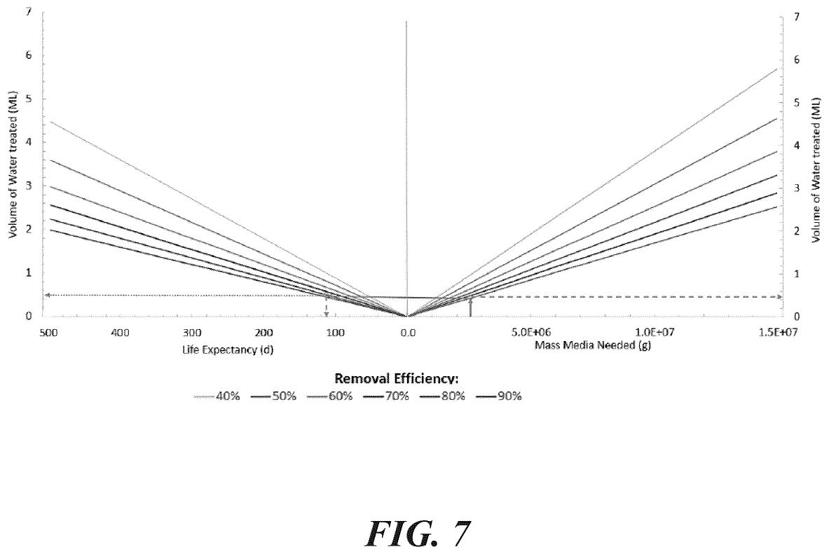

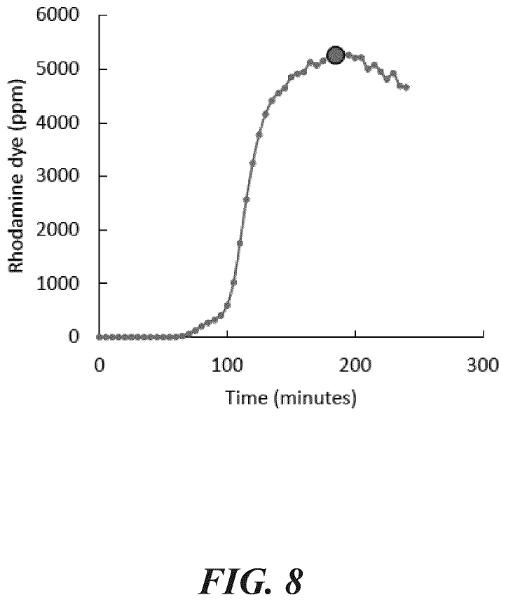

As shown in FIG. 7, the life expectancy assessment curves based on a set of prescribed removal efficiency can be derived to predict the volume of water treated over the media's usage life corresponding to the quantity of media selected. For demonstration, the life expectancy calculation is presented for an application of ZIPGEM in color removal in Lake Brooklyn, FL given the influent condition of 179 color units Pt—Co (e.g., Co). Aiming for a target effluent color concentration at or below 40 color units Pt—Co per SJRWMD requirements (SJRWMD, 2021), the removal efficiency R of 80% is selected for demonstration in this water pretreatment case based on the removal ranges (57-91% color removal as shown), and as shown in FIG. 8, the HRT. By employing the laboratory HRT of 3.7 h for ZIPGEM and the corresponding laboratory HLR of 31.06 gpd/ft² (1.27 m³/(m² d⁻¹)) (Table 2), the maximum flow rate (Q_{threshold}) and surface are area_{surface} for the filter cell can be determined. Hence, the maximum flow rate Q_{threshold} of 4.88 (10)₃ L·d⁻¹ (0.0013 MGD) for a V_{void} of 0.75 m³ was calculated. Reducing the Q_{threshold} by 20% to avoid unexpected flooding or ponding in water treatment filter, a controlled pumping flow rate or design flow rate (Q) of 3.91 (10)₃ L·d⁻¹ (0.0010 MGD) was selected for life expectancy estimation. Based on this controlled pumping flow rate (Q), the corresponding area_{surface} of 3.09 m² (33.26 ft²) was determined. Note that the selected Q (design flow rate) is a function in terms of HRT, removal efficiency, and adsorption capacity of the adsorbent. For a design filter depth of approximately 0.30 m, a cell volume of 0.88 m³ (31 ft³) was required which corresponds to a design media mass of 2.46 (10)₃ kg in a treatment cell. The turning-line method, as shown in FIG. 7, provides that following the life expectancy curves can showcase the volume of water treated (V_{water treated}) over the media useful life corresponding to the quantity of media needed (mass_{media}) in a treatment cell. The value to treat a specific volume of water was determined as 0.47 ML (0.12 MG) in such a filter cell from which the estimated life expectancy corresponding to this V_{design water treated} is 119.21 d (0.33 y) based on approximately 2.5 tons of ZIPGEM.

### Risk Assessment

It is important to ensure that implementation of the sorption media as a pretreatment system does not have any side effect that can have any negative health or environmental impact. For instance, the long-term human exposure to aluminum can cause encephalopathy, anemia, and bone disease in dialyzed patients (Colonia and Peris-Sampedro, 2017). Moreover, iron is an essential element for living organisms as it contributes to oxygen transportation and electron transport. Yet, if the iron intake is excessive, it can lead to tissue damage (Abbaspour et al., 2014). The EPA in the US has established standards for iron and aluminum ion concentration under the secondary drinking water standards. Under these standards, the EPA has recommended that the concentration of aluminum and iron in drinking water should not exceed the concentrations of 0.2 and 0.3 mg·L⁻¹, respectively. Moreover, the World Health Organization indicated that the aluminum levels in drinking water facilities using aluminum sulfate coagulation ranges from 0.1 to 2.7 mg·L⁻¹.

Therefore, effluent samples from each column were analyzed in terms of dissolved aluminum and dissolved iron ion concentration to confirm that there was no harmful leachate with these metals from the sorption media. The results from CTS and CPS, as provided below in TABLE 8 and TABLE 11, respectively, indicate some increase in the dissolved aluminum ion concentration, yet the results did not exceed the concentration of aluminum found previously in drinking waters treated with aluminum sulfate coagulate. On the contrary, IFGEM-1, IFGEM-4 and ZIPGEM, as provided below in TABLE 9, TABLE 10, and TABLE 12, respectively effluents did not contain dissolved aluminum, on the contrary, they provided aluminum removal. Removal was observed in terms of dissolved iron in the ZIPGEM column. In IFGEM-4, iron concentration increase was observed after 69 hours potentially driven by clogging in the column as dissolved iron increased in the effluent.

TABLE 8
CTS

| Time (hour) | Dissolved Aluminum ions (mg/L) |
|---|---|
| Influent | 0.3 |
| 37 | 0.4 |
| 81 | 0.4 |
| 128 | 0.4 |

TABLE 9
IFGEM-1

| | Dissolved Iron | Dissolved Aluminum |
|---|---|---|
| Time (hour) | ions (mg/L) | ions (mg/L) |
| Influent | 0.0 | 0.3 |
| 3 | 0.0 | 0.9 |
| 53 | 0.0 | 0.0 |
| 151 | 0.0 | 0.0 |

TABLE 10
IFGEM-4

| | Dissolved Iron | Dissolved Aluminum |
|---|---|---|
| Time (hour) | ions (mg/L) | ions (mg/L) |
| Influent | 1.1 | 0.3 |
| 5 | 0.6 | 0.0 |
| 32 | 1.1 | 0.1 |
| 69 | 3.1 | 0.0 |

TABLE 11
CPS

| Time (hour) | Dissolved Aluminum ions (mg/L) |
|---|---|
| Influent | 0.6 |
| 5 | 0.5 |
| 28 | 0.8 |
| — | — |

TABLE 12
ZIPGEM

| | Dissolved Iron | Dissolved Aluminum |
|---|---|---|
| Time (hour) | ions (mg/L) | ions (mg/L) |
| Influent | 1.1 | 0.3 |
| 3 | 0.1 | 0.0 |
| 22 | 0.5 | 0.0 |
| 115 | 0.5 | 0.0 |

### CONCLUSION

The source water to be utilized for drinking water supply is oftentimes troubled by the presence of NOM (i.e., tannic and humic acid). Adsorption is still one of the most cost-effective treatment methods for the removal of color for drinking water treatment. A low maintenance alternative filtration media was proposed for any in-situ pretreatment of drinking water sources. Five low-cost sorption media were produced and tested by fixed bed column studies to determine the color removal efficiency. Given the influent condition of 175±10 Pt—Co units, the adsorption capacity can be ranked in terms of how long the proposed media sustained the color removal of ˜77% or greater. ZIPGEM was ranked the first followed by IFGEM-1, IFGEM-4, CTS, and CPS. ZIPGEM maintained the effluent below 40 Pt—Co units for about 14,000 minutes based on the media mix of 1,200 ml by volume and the prescribed adsorption capacity. Such performance can be attributed to the inclusion of both perlite and ZVI and synergetic effects between clay and sand. With the predicted Thomas model parameter, the adsorption capacity of ZIPGEM (e.g., 27.1 mg of Pt—Co·g⁻¹) was superior to the adsorption capacity of the rest of the four sorption media. Moreover, observed morphology of ZIPGEM shown by SEM indicated a heterogenous surface further supporting the longer duration of color removal observed. Such synergistic interactions among the four components with unique morphological structure promoted color removal by improving physicochemical interactions via better dispersion and diffusion.

### Example #2

Differential Effect of Adsorption Ingredients for Phosphorous Removal from River Water

### Materials and Methods:

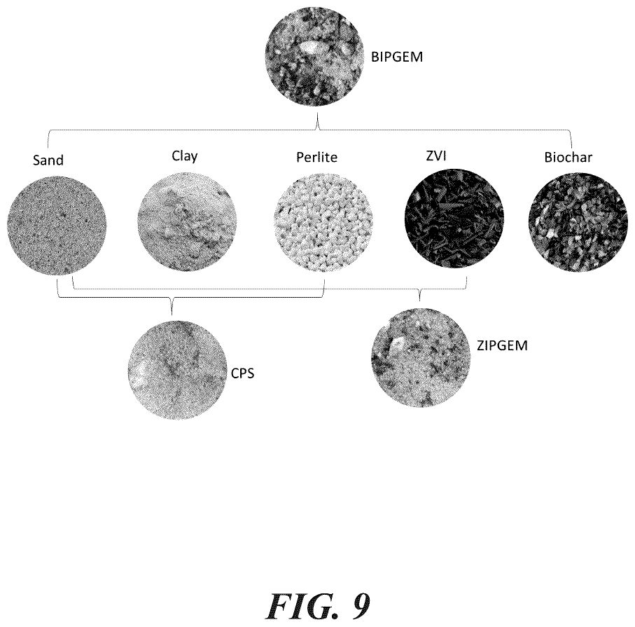

Three specialty adsorbents were studied to understand its potential to remove phosphate via physiochemical interactions. These media mixes include CPS, ZIPGEM, and BIPGEM. The components and media matrix in percent by volume as well as physical characteristics for each sorption media are presented in TABLE 13. The Zero-Valent Iron (ZVI) was obtained from Connelly-GPM, Inc. Iron Aggregate, with descriptive name ETI CC-1004 (−8+50). The ZVI composition is 87-93% metallic iron. Moreover, the perlite used is from Miracle-Go® and its description indicated that it contains 99.44% perlite. The biochar used is from Plantonix and it is derived from soft wood and tree trimmings. The physical characteristics including BET surface area and density were performed at the EMSL Analytical, Inc laboratories. Density and BET surface area were measured following methods ASTM D₈₅₄ and ASTM B922. Moreover, the saturated hydraulic conductivity was measured at the University of Central Florida (UCF) Geotechnical laboratories following the constant head permeability test. The Point of Zero Charge (PZC) for each media was also measured by the salt addition method (Mahmood et al., 2011). The salt addition method determines the pH where the surface of the adsorbent is at ionic equilibrium, and it is the condition when the number of H+ and OH— at the surface of the particle are equal. The protocol followed is presented in detail in Ordonez et al. (2022) utilizing 0.2 M NaNO3 solution and adding NaOH or HNO3 for pH adjustment. The results are presented on FIG. 9.

TABLE 13

| | | Density | BET Surface | Saturated Hydraulic | Porosity |
|---|---|---|---|---|---|
| Name | Media Matrix | (g · cm³) | Area (m² · g⁻¹) | Conductivity (m · sec⁻¹) | (%) |
| CPS | 92% sand, 5% clay, 3% perlite | 2.61 | 1.08 | 1.7(10⁻⁴) | 26 |
| ZIPGEM | 85% sand, 5% clay, 5% perlite | 2.78 | 1.50 | 2.8(10⁻⁴) | 33 |
| | and 5% ZVI | | | | |
| BIPGEM | 80% sand, 5% clay, 5% perlite, | 2.59 | 1.35 | 1.2(10⁻⁴) | 30 |
| | 5% ZVI and 5% biochar | | | | |

### Isotherm Experiments

A series of isotherm tests were performed to obtain information on the adsorption capacity of the different green sorption media under different pH conditions. In the beginning the selected green sorption media including CPS, ZIPGEM, and BIPGEM were washed with DI water (3 Bed Volumes (BV)) and then dried for 24 hours at a temperature of 78° C. Subsequently, aliquots of 5 grams of media with 40 ml of DI water spiked to different concentrations (i.e., 0, 0.7, 2, 3, 4, 5, 15, 30, 60, 120, and 240 mg·L−1 PO₄³⁻) were prepared. The aliquots were then shaken for 6 hours on a shaker at 180 rpms and at room temperature. The procedure was repeated at three different pH conditions (i.e., pH of 4, 7 and 10) adjusted with NaOH or HNO3. At the completion of the shaking time, each aliquot was left to rest for 30 min and the supernatant was extracted, filtered via a membrane filter with pore size 0.45 μm and analyzed for phosphate concentrations in triplicate. An additional isotherm was performed following the same protocol but substituting the influent with surface canal water spiked with NO₃— to a concentration of 2 mg·L⁻¹, while the canal water was still spiked to different concentrations (i.e., 0, 0.7, 2, 3, 4, 5, 15, 30, 60, 120, and 240 mg·L⁻¹ PO₄³⁻) to explore the competing effect between nitrate and phosphate.

Collected water samples were analyzed for TP using the Hach TNT 843, 844 and 845 analyze kit, which follows the Ascorbic Acid method (EPA method 365.1) at different detection ranges. Water samples were analyzed for Nitrate using the TNT 835 Hach kit, based on the Dimethylphenol method (EPA method 40 CFR 141). All samples were measured within 24 hours of collection. Additional information on the TNT kits measuring protocols can be found at Hach, (2021) and Hach (2022).

Isotherm studies allow the estimation of the adsorption capacity of a sorbent (i.e., sorption media) in an equilibrium condition. The four linear forms of the Langmuir isotherm model, and Freundlich linear models were applied to the isotherm data to obtain information of the adsorption capacity of the selected sorption media. The amount of phosphate adsorbed per unit weight of the sorption media (qe) was calculated in accordance with Eq. 11. Where m is the mass of the sorption media in grams, Co is the initial concentration on the solution in mg·L⁻¹, C_{c} is the adsorbate concentration of the solution at equilibrium in mg·L⁻¹ and V is the volume of the solution in L.

$${q}_{e} = \frac{( {C}_{o} - {C}_{e} ) V}{m} \qquad Eq . ( 11 )$$

Langmuir isotherm model assumptions include monolayer adsorption onto a surface with finite number of adsorption sites (Hameed et al., 2007). The Langmuir nonlinear equation follows Eq. 12, where KL corresponds the Langmuir equilibrium constant or affinity constant (L·mg⁻¹) and qₘ is the maximum adsorption capacity of the absorbent (mg·g⁻¹) (Guo & Wang, 2019). Four different linear forms of the Langmuir isotherm can be found in the literature and are presented in Eq. 13 (denoted as Langmuir 1, hereafter), Eq. 14 (denoted as Langmuir 2, hereafter), Eq. 15 (denoted as Langmuir 3, hereafter) and Eq. 16 (denoted as Langmuir 4, hereafter).

$$\begin{matrix}{q}_{e} = \frac{{q}_{m} {K}_{L} {C}_{e}}{1 + {K}_{L} {C}_{e}} & Eq . ( 12 ) \\ \frac{{C}_{e}}{{q}_{e}} = \frac{1}{{q}_{m}} {C}_{e} + \frac{1}{{K}_{L} {q}_{m}} & Eq . ( 13 ) \\ \frac{1}{{q}_{e}} = ( \frac{1}{{K}_{L} {q}_{m}} ) \frac{1}{{C}_{e}} + \frac{1}{{q}_{m}} & Eq . ( 14 ) \\ {q}_{e} = {q}_{m} - ( \frac{1}{{K}_{L}} ) \frac{{q}_{e}}{{C}_{e}} & Eq . ( 15 ) \\ \frac{{q}_{e}}{{C}_{e}} = {K}_{L} {q}_{m} - {K}_{L} {q}_{e} & Eq . ( 16 )\end{matrix}$$

The Freundlich model is an empirical model, its linear and nonlinear form are presented in Eq. 17 and Eq. 18, respectively. In both equations, the constant K_{F} relates to the adsorption capacity, while the constant n relates to the adsorption intensity. If the n is greater than 1 then the adsorption is favorable (Campbell and Davies, 1995; Dada et al., 2012; Desta, 2013).

$$\begin{matrix}{q}_{e} = {K}_{L} {C}_{e}^{1 / n} & Eq . ( 17 ) \\ ln ( {K}_{F} ) = ln ( {K}_{F} ) - \frac{1}{n} ln ( {C}_{e} ) & Eq . ( 18 )\end{matrix}$$

A triplicate set of columns of 5 inches (12.7 cm) in depth and 4 inches (10.2 cm) in diameter filled with 700 ml of sorption media with equivalent weight of gram of 1,000 grams of ZIPGEM media were set up to understand the dynamic removal of ZIPGEM. A filter and layer of pebbles were placed at the bottom of each media mix to prevent clogging, while a layer of pebbles was placed at the top of each column to aid in water distribution. Prior to the column study, each column was flushed with DI water for 3 BV and left to drain for about 8 hours. The dynamic column study consisted of feeding each column in downward flow with DI water spiked with phosphate standard solution to a concentration of 4 mg·L⁻¹ PO₄³⁻ until the media reached saturation. Water samples were collected from the effluent at different time intervals after 23 hours until the media reached exhaustion. Water samples were analyzed for TP using the Hach TNT 843.

Data obtained from the dynamic column study was applied to Thomas (Eq. 19 and Eq. 20) and Yoon-Nelson (Eq. 21 and Eq. 22) dynamic model. The dynamic Thomas model (Thomas 1944) is one of the most popular models to predict the adsorption behavior of the adsorbent (green sorption media) (Nwabanne et al., 2022). The non-linear form of the Thomas model is presented in Eq. 19, while the linearized form is presented in Equation 20. Its constant (Kt, unitless) and media maximum adsorption capacity (qₒ, mg·g⁻¹) are retrieved from the linear regression of ln

$$\begin{matrix}\frac{{C}_{o}}{{C}_{t}} = \frac{1}{1 + exp [ ( \frac{{K}_{t}}{Q} ) ( {q}_{o} m - {C}_{o} Qt ) ]} & Eq . ( 19 ) \\ ln [ \frac{{C}_{o}}{{C}_{t}} - 1 ] = \frac{{K}_{t} {q}_{o} m}{Q} - {K}_{t} {C}_{o} t & Eq . ( 20 )\end{matrix}$$

where Co is the influent concentration (in mg·L⁻¹), Ct is the effluent concentration at time t (in mg·L⁻¹), and t is time is minutes.

$$[ \frac{{C}_{o}}{{C}_{t}} - 1 ] vs . t$$

Yoon Nelson model (Yoon and Nelson, 1984) is one of the simplest dynamic models as it neglects the information of the physical characteristics of the physical bed and the absorbent. The non-linear form of the Yoon-Nelson model is presented in Eq. 21 and the linear form of the model is presented in Eq. 22. The parameters KYN and τ correspond to the Yoon-Nelson constant (in min⁻¹) and the time required for the adsorbent to reach 50% breakthrough (in min) (Nwabanne et al., 2022).

$$\begin{matrix}\frac{{C}_{t}}{{C}_{o}} - {C}_{t} = exp ( {K}_{YN} t - {K}_{YN} τ ) & Eq . ( 21 ) \\ ln ( \frac{{C}_{t}}{{C}_{o} - {C}_{t}} ) = {K}_{YN} t - τ {K}_{YN} & Eq . ( 22 )\end{matrix}$$

### Results:

### Media Characterization

A larger BET surface area and higher porosity can be good indicators of more available adsorbent sites resulting in better adsorption (Gupta et al., 2013). ZIPGEM has the larger BET surface area and higher porosity followed by BIPGEM and finally by CPS. Moreover, the saturated hydraulic conductivity of ZIPGEM was the highest among the three specialty absorbents, followed by CPS and BIPGEM, respectively. The saturated hydraulic conductivity is an important factor for appropriate treatment capacity (e.g., hydraulic loading rate) toward scale-up of the system, as it can indicate the required contact time of the adsorbent and adsorbate to obtain good removal efficiency.

Aside from the physical properties of the media, it is crucial to determine the chemical properties to obtain a holistic understanding of removal mechanisms of these specialty adsorbents. The PZC provides an insight on the surface charge of the media at different pH levels. This is, at pH levels below the PZC the surface of the media is positively charged, while at points above the PZC the surface of the media is negatively charged. The location of the PZC for CPS, ZIPGEM, and BIPGEM is located at pH of ˜5.6, ˜9.2 and ˜9.5, respectively (FIG. 10).

The chemical composition of the three selected green sorption media mixes (i.e., CPS, ZIPGEM, and BIPGEM) were determined based on the X-ray Fluorescence (XRF) instrument. In TABLE 14, the results indicate that Si is the major element on the media matrix of the three sorption media mixes. For CPS, ZIPGEM, and BIPGEM, the percent content of Al is 10.5%, 8.4%, and 11.5%, respectively, being the second major element in the media matrix for CPS and the third major element for ZIPGEM and BIPGEM. The major difference among the chemical element composition is the presence of Fe in ZIPGEM and BIPGEM in comparison to CPS. The Fe percent content in ZIPGEM and BIPGEM is 12.1% and 12.8%, while it is only 0.4% in CPS. Another element that stands out in the chemical element composition of the media is Ca, as it can partake in the removal mechanism of PO₄³⁻ via the different sorption media mixes.

TABLE 14

| Element | CPS | ZIPGEM | BIPGEM | Unit |
|---|---|---|---|---|
| Al | 10.5 | 8.4 | 11.5 | % |
| Si | 80.1 | 70.3 | 70.4 | % |
| P | 2.1 | 1.9 | 1.4 | % |
| S | 0.6 | 0.0 | 0.0 | % |
| Cl | 1.8 | 2.0 | 1.3 | % |
| K | 2.9 | 2.8 | 0.6 | % |
| Ca | 1.1 | 1.0 | 1.1 | % |
| Ti | 0.4 | 1.3 | 0.7 | % |
| Fe | 0.4 | 12.1 | 12.8 | % |

### Phosphate Removal Mechanism

The different specialty ingredients (i.e., media components) contribute to the overall physicochemical characteristics of each media mix in a synergistic way. Each specialty ingredient was carefully selected to obtain a sorption media mix capable of excelling in the removal of one or more contaminants (i.e., phosphate vs. nitrate) from different water matrices with cost-effective, scalable, and sustainable nature. For instance, silicate sand that has a low cost can maintain an appropriated flow rate (TABLE 13). Silicate sand is plentiful while providing an appropriate environment for microbial ecology to thrive, and it is simple to maintain and operate (Valencia et al., 2020). The adsorption of phosphorus to sand is mainly dependent on the Ca⁺² content of the sand (Brix et al., 2001), as the negatively charged phosphorus is attracted to the positively charged Ca⁺² (Eq. 22) (Deng et al., 2018, Lei et al., 2018). In the case of CPS, ZIPGEM, and BIPGEM, the percent content of Ca⁺² is 1.1, 1.0, and 1.1% of the media in terms of element composition, respectively, suggesting that only some phosphorus removal can be associated with the electrochemical interaction of Ca²⁺ and phosphorus.

$$2 {Ca}^{2 +} + {PO}_{4}^{2 -} + {OH}^{-} ↔ {Ca}_{2} {PO}_{4} ( OH ) \cdot 2 {H}_{2} O ( s ) \qquad Eq . ( 23 )$$

Nayak and Singh (2007) performed a XRF characterization on clay indicating that SiO₃ and Al₂O₃ are present in major quantities in clay (48.12% and 34.54%, respectively), justifying the high content of Al in the sorption media (i.e., CPS, ZIPGEM and BIPGEM). Furthermore, the adsorption of phosphate to clay is the combination of physiochemical interactions because of ligand exchange and electrostatic attraction (Wang et al., 2018). Phosphate adsorption can also be associated with the results of the interaction between aluminum ion from the dissolution of clay that results on the chemical precipitation of aluminum phosphate following Eq. 23 and Eq. 24 (Edzwald et al., 1976).

$$\begin{matrix}{Al}_{2} {O}_{3} + 3 {H}_{2} O ↔ 2 {Al ( OH )}_{3} & Eq . ( 24 ) \\ Al {( OH )}_{3} + {H}_{2} {PO}_{4}^{-} ↔ {AlPO}_{4} + {OH}^{-} + 2 {H}_{2} O & Eq . ( 25 )\end{matrix}$$

Moreover, the percentage of Fe in ZIPGEM and BIPGEM is much higher than in CPS, owing to the inclusion of recycled ZVI as specialty ingredient of the green sorption media matrices. ZVI can be oxidized by oxygen in the presence of water to form ferrous iron (Eq. 25) which can further be oxidized to ferric iron with oxygen (Stumm & Lee, 1961) (Eq. 26). Subsequently, phosphate can precipitate with ferrous [Fe(II)] or ferric [Fe(III)] iron in accordance with Eq. 27, Eq. 28, and Eq. 29, further contributing to phosphate removal.

$$\begin{matrix}2 {Fe}^{0} + {O}_{2} + 2 {H}_{2} O ↔ 2 {Fe}^{2 +} + 4 {OH}^{-} & Eq . ( 26 ) \\ {Fe}^{2 +} + {O}_{2} ↔ {Fe}^{3 +} {HO}_{2} & Eq . ( 27 ) \\ {Fe}^{2 +} + {H}_{2} {PO}_{4}^{-} ↔ {{Fe}_{3} ( {PO}_{4} )}_{2 ( s )} + {H}^{+} & Eq . ( 28 ) \\ {Fe}^{3 +} + {PO}_{4}^{3 -} ↔ {FePO}_{4 ( s )} & Eq . ( 29 )\end{matrix}$$

The removal of phosphate by perlite was disputable; for instance, Ma, et al, (2011) concluded that the removal of orthophosphate via perlite is negligible with an adsorption capacity of only 0.01 mg· g⁻¹ found via a Langmuir isotherm test. Similarly, Williams et al. (2000) studied a peat-perlite medium and found that there is no phosphate adsorption. However, an examination by Ozel et al. (2012) found that expanded perlite as an in-situ landfill liner system has a PO₄³⁻ removal efficiency of 91% from leachate. But Pradhan et al. (2020) treated greywater with perlite via a column study, and only achieved phosphate removals of up to 15%. The use of biochar for nutrient removal has increased due to its sustainable nature. The removal of phosphate by biochar is attributed to the large surface area, location of the PZC, and metal compounds (i.e., Al, Ca, Mg), supporting the main mechanism of removal (Almanassra et al., 2021; Veni et al., 2017; Yao et al., 2011).

Effect of Water Matrix on PO₄³⁻ Adsorption

The effect that different pH values have on the adsorption capacity of CPS, ZIPGEM, and BIPGEM was realized via a series of isotherm experiments (FIG. 10). The isotherm results reflected that the adsorption capacity of ZIPGEM and BIPGEM are superior to the adsorption capacity of CPS. The better performance of ZIPGEM and BIPGEM can be attributed to the inclusion of ZVI in the specialty ingredients, aiding the adsorption of PO₄³⁻ by electrostatic interaction in response to the varying the location of the PZC in the media and increasing PO₄³⁻ precipitation with Fe in accordance with Eqs. 25-29.

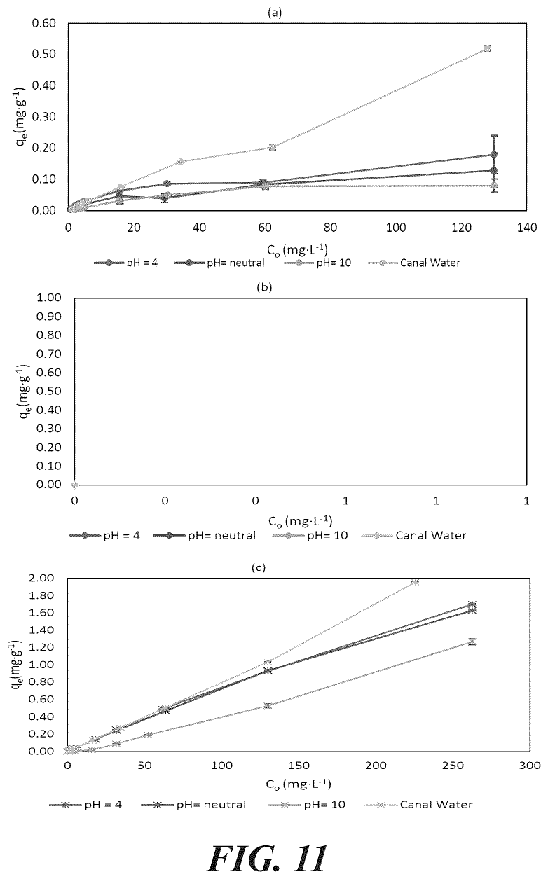

In general, higher PO₄³⁻ adsorption was attained for all media mixes at lower pH (pH=4); however, when the pH increased to pH of 7 and 10 the adsorption capacity decreased, being the lowest at pH of 10 (FIG. 11 (Section (A), Section (B), and Section (C)). The inverse relationship between pH and adsorption capacity has been observed in previous studies. For instance, Liu et al. (2008) concluded that the PO₄³⁻ adsorption capacity of mesoporous ZrO₂ doubled by decreasing the pH in the solution with varying pH values from 10.18 to 2.82. Liu et al. (2008) also suggested that as the pH increases, the surface become less positive owing to the presence of more OH⁻ in the solution, resulting in a lower PO₄³⁻ adsorption as the negatively charged PO₄³⁻ competes with the OH— for the positively charged surface, while concurrently, increasing the repulsion between the increasing negatively surface site and PO₄³⁻. The pattern of variation in PO₄³⁻ adsorption at different pH values was closer between BIPGEM and ZIPGEM. The lower adsorption of ZIPGEM at higher pH (pH of 10) and higher PO₄³⁻ concentrations (above 130 mg·L⁻ 1) further support the competition of PO₄³⁻ and OH— for the positively charge sites in the media surface, which decreases with increasing pH (FIG. 9). Moreover, the PO₄³⁻ removals for ZIPGEM were above 90% when the initial PO₄³⁻ concentration was below 60 mg·L⁻¹ regardless of pH variations (pH of 4, 7 or 10).

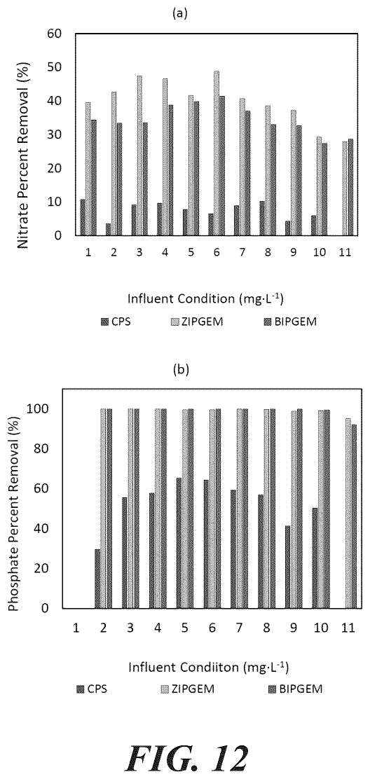

The Langmuir isotherm model is widely utilized for predicting the adsorption capacity of adsorbents. The data obtained from the isotherm studies were imputed into four different linear forms of the Langmuir isotherm. By comparing the experimental data and the simulated data obtained from the different forms of the linear Langmuir isotherm, it can be concluded that linear form present in Eq. 13 (Langmuir 1) is the most appropriate to predict the adsorption capacity of the media, followed by the linear form in Eq. 16 (Langmuir 4). These results are consistent with the findings by Guo and Wang (2019). The different parameters simulated by the Langmuir and Freundlich equation are summarized in TABLE 15. The qₘ values obtained for CPS at different water matrices ranged from 0.114 to 0.168 mg·g⁻¹. The qₘ obtained for BIPGEM and ZIPGEM were close in range with each other, but over 10 times higher than that for CPS. The qₘ values for ZIPGEM ranged from 0.946 to 1.832 mg·g⁻¹ and for BIPGEM the qₘ ranged from −0.131 to 1.824 mg·g⁻¹. The negative adsorption capacity obtained for qₘ value for BIPGEM at pH of 10 is the result of an inappropriate fitting of the Langmuir model (FIG. 12). Hence, it cannot be considered as an adequate model for estimating the qₘ value. The n value results obtained from the Freundlich model further support the results obtained from the Langmuir isotherm model, suggesting that pH is inversely correlated with the media's adsorption capacity and adsorption favorability (TABLE 16). The adsorption capacities of different low and high-cost adsorbent found in literature were included in TABLE 17 and TABLE 18, respectively. The adsorption capacity of the green sorption media of ZIPGEM and BIPGEM are comparable to adsorption capacities of the natural adsorbents (TABLE 17) such as Chitin and Chitosan. While the adsorption capacities of the functionalized adsorbents presented on TABLE 18 are higher, the production cost of these are higher, further supporting the applications of the green sorption media ZIPGEM and BIPGEM for large-scale applications.

TABLE 15

| | Parameters | pH = 4 | pH = 7 | pH = 10 |
|---|---|---|---|---|
| CPS | R² | 0.869 | 0.838 | 0.925 |
| | Kₐ(L · mg⁻¹) | 0.102 | 0.042 | 0.024 |
| | qₘ(mg · g⁻¹) | 0.168 | 0.140 | 0.114 |
| ZIPGEM | R² | 0.734 | 0.942 | 0.7802 |
| | Kₐ(L · mg⁻¹) | 0.377 | 0.165 | 0.154 |
| | qₘ(mg · g⁻¹) | 1.832 | 1.796 | 0.947 |
| BIPGEM | R² | 0.932 | 0.926 | 0.469 |
| | Kₐ(L · mg⁻¹) | 0.172 | 0.198 | −0.011 |
| | qₘ(mg · g⁻¹) | 1.824 | 1.703 | −0.131 |

TABLE 16

| | Parameters | pH = 4 | pH = 7 | pH = 10 |
|---|---|---|---|---|
| CPS | R² | 0.928 | 0.928 | 0.942 |
| | K_{f} | 0.026 | 0.008 | 0.003 |
| | n | 2.744 | 1.696 | 1.275 |
| ZIPGEM | R² | 0.966 | 0.952 | 0.896 |
| | K_{f} | 3.002 | 0.171 | 0.102 |
| | n | 2.257 | 1.504 | 1.811 |
| BIPGEM | R² | 0.898 | 0.949 | 0.848 |
| | K_{f} | 0.734 | 0.188 | 0.0001 |
| | n | 5.865 | 1.818 | 0.4876 |

TABLE 17

| | Phosphate | | | |
|---|---|---|---|---|
| Adsorbent | adsorption capacity | | Description | Reference |
| CPS | 0.140 | mg · g⁻¹ | Variation of initial concentration | Present |
| ZIPGEM | 1.796 | mg · g⁻¹ | Concentration range (0 to 240 mg · L⁻¹) | Disclosure |
| BIPGEM | 1.703 | mg · g⁻¹ | DI water at pH of 7 | |
| | | | Langmuir model | |
| IFGEM*-2 | 0.019 | mg · g⁻¹ | Variation of adsorbent mass | Chang et al. |
| | | | Influent concentration of 1 mg · L⁻¹ | (2019) |
| | | | DI water at a pH of 7 | |
| | | | Langmuir model | |
| Iron-coated sand | 0.693 | mg · g⁻¹ | Variation of adsorbent dosage | Huang et al., |
| Iron-manganese coated sand | 0.590 | mg · g⁻¹ | Adsorbent range from 0.1 to 1 g | (2014) |
| | | | pH of 7 and constant ionic strength | |
| | | | Langmuir model | |
| Chitosan | 6.64 | mg · g⁻¹ | Variation of initial concentration | Szymczyk et al., |
| Chitin | 2.09 | mg · g⁻¹ | Concentrations range (3 to 25 mg · L⁻¹) | (2016) |
| | | | Langmuir model | |
| Sponge iron | 1.11 | mg · g⁻¹ | Variation of initial concentration | Jiang et al., |
| Zeolite | 0.303 | mg · g⁻¹ | Concentrations range (3 to 40 mg · L⁻¹) | (2013) |
| | | | Langmuir model | |
| Sugar cane bagasse biochar | 2.95 to 13.21 ** | mg · g⁻¹ | Variation of initial concentration | Trazzi et al., |
| Miscanthus giganteus biochar | 3.75 to 16.10** | mg · g⁻¹ | Concentrations range (25 to 400 mg · L⁻¹) | (2016) |
| | | | pH of 7 | |
| | | | Langmuir model | |
| Kaolinite | 0.491 | mg · g⁻¹ | Variation of initial concentration | Fang et al., |
| Montmorillonite | 0.228 | mg · g⁻¹ | Concentrations range (25 to 400 mg · L⁻¹) | (2017) |
| Hematite | 0.064 | mg · g⁻¹ | pH of 6.5 ± 0.5 | |

Langmuir model

TABLE 18

| | Phosphate adsorption | | | |
|---|---|---|---|---|
| Functionalized Adsorbent | capacity | | Description | Reference |
| Functionalized sand with Mg—Fe | 69.47 | mg · g⁻¹ | Variation of initial concentration | Abdolmaleki et |
| layered double hydroxide | | | Temperature of 25° C. | al. (2021) |
| Functionalized sand with Ni—Fe | 66.64 | mg · g⁻¹ | Langmuir model | |
| layered double hydroxide | | | | |
| Mesoporous zirconium oxide | 29.71 | mg · g⁻¹ | Variation of initial concentration | Liu et al. (2008) |
| | | | Langmuir model | |
| Iron-doped (Fe^{II}) Activated | 14.12 | mg · g⁻¹ | Variation of initial concentration | Wang et al. |
| carbon | | | Temperature of 25° C. and initial pH of 6 | (2012) |
| | | | Langmuir model | |
| Lanthanum modified platanus | 124 | mg · g⁻¹ | Variation of initial concentration | Jia et al. (2020) |

| | |
|---|---|
| ball fiber biochar | Temperature of 25° C. |
| | Adsorbent dosage 0.4 g · L⁻¹ |
| | Langmuir model |

### Competitive Adsorption

An isotherm test utilizing surface water collected from a canal water system in Florida, USA spiked with NO₃— to a concentration of 2 mg L⁻¹ was performed on CPS, ZIPGEM and BIPGEM to explore the adsorption capacity and the removal mechanism based on real world water matrices. Remarkably, the adsorption capacity of phosphate by CPS increased by 8 times its capacity when using canal water in comparison to DI water (TABLE 15 and TABLE 19). This can be related to the presence of calcium (79.03 mg·L⁻ 1) and magnesium (14.10 mg·L⁻¹) in the canal water which promoted PO₄³⁻ precipitation (Eq. 22). However, the increase in PO₄³⁻ adsorption capacity by ZIPGEM and BIPGEM when using canal water was only noticeable at high PO₄³⁻ concentrations, as shown in FIG. 10.

The nitrate adsorption capacity at equilibrium (qe) of CPS, ZIPGEM, and BIPGEM calculated in the different aliquots spiked with constant nitrate and varying phosphate concentrations (Eq. 1) remained consistent. The qe for ZIPGEM was the highest (0.0088±0.00023 mg·g⁻¹) followed by BIPGEM and CPS with qe of 0.0075 (±0.001) and 0.0017 (±0.0005) mg·g⁻¹. The simultaneous removal efficiency of the sorption media achieved in an isotherm using spiked water at constant nitrate concentration—(2 mg·L⁻¹) and varying phosphate concentration (0, 0.7, 2, 3, 4, 5, 15, 30, 60, 120, and 240 mg·L⁻¹) denoted as 1, 2, 3, 4, 5, 6, 7, 8, 9, 10 and 11, respectively, is presented in FIG. 11 (Section (A), Section (B), and Section (C)). The higher NO₃⁻ removal was obtained by ZIPGEM with removal efficiency ranging from 27.9 to 39.58%, followed by BIPGEM with removals ranging from 27.45 to 34.44%, and lastly the removal of NO₃⁻ by CPS was the lower compared to other media mixes, ranging between 3.55 to 10.8%. The nitrate removal efficiency of BIPGEM and ZIGPEM were the highest when the PO₄³⁻ influent concentration were below 60 mg·L⁻¹. The phosphate removal efficiency for ZIPGEM ranged between 95.2% to 100% closely followed by BIPGEM with removal efficiency ranging between 92% and 100%. Finally, the phosphate removal efficiency achieved by CPS ranged between 30% to 66%. By comparing the removal achieved at the different conditions it can be observed that there is no effect in the NO₃⁻ removal efficiency of CPS, ZIPGEM and BIPGEM when PO₄³⁻ concentration are low (below 60 mg·L⁻¹) however, when the phosphate concentrations increase the removal efficiency for both nitrate and phosphate decreases. While this change in the removal efficiency is small, it can be explained by a competition between NO₃⁻ and PO₄³⁻ for the available positively charged surface which only occurs when the available positively surface charge sites are scarce (Chang et al., 2019).

TABLE 19

| | Langmuir | | Freundlich | |
|---|---|---|---|---|
| | Parameters | Canal Water | Parameters | Canal Water |
| CPS | R² | 0.457 | R² | 0.957 |
| | Kₐ (L · mg⁻¹) | 0.012 | K_{f} | 0.014 |
| | qₘ (mg · g⁻¹) | 0.938 | n | 1.228 |
| ZIPGEM | R² | 0.973 | R² | 0.864 |
| | Kₐ (L · mg⁻¹) | 2.072 | K_{f} | 0.658 |
| | qₘ (mg · g⁻¹) | 1.778 | n | 1.950 |
| BIPGEM | R² | 0.999 | R² | 0.973 |
| | Kₐ (L · mg⁻¹) | 3.399 | K_{f} | 0.977 |
| | qₘ (mg · g⁻¹) | 1.687 | n | 4.973 |

### Fixed Bed Column Study and Removal Efficiency

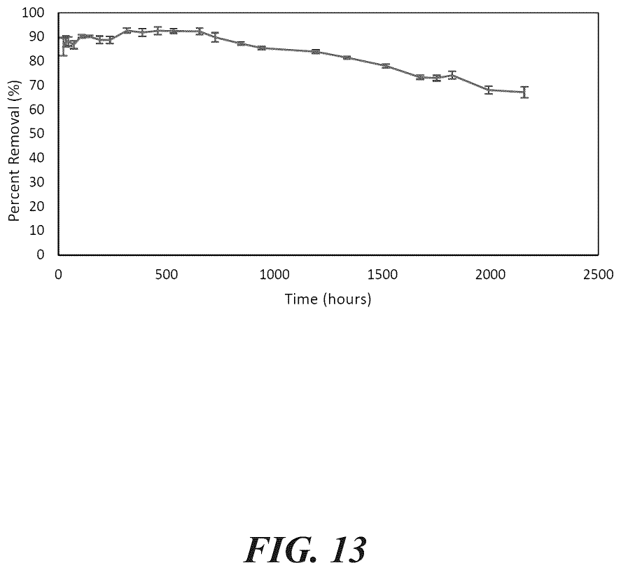

Fixed bed columns are a preferable experiment set up to determine the maximum adsorption capacities of green sorption media mixes as it considers axial dispersion, film diffusion resistance, and intraparticle diffusion resistance (Patel, 2019). The adsorption process of ZIPGEM was studied in a set of downflow dynamic columns, given its better performance in the isotherm studies in comparison against CPS and BIPGEM. Although the qₘ obtained for BIPGEM were almost equivalent to the qₘ obtained for ZIPGEM in the isotherm studies it was not selected because ZIPGEM has a lower production cost by excluding the biochar component and by considering the better performance of ZIGPEM at high pHs (pH of 10). The results from the dynamic column study of ZIPGEM are presented in FIG. 12 (Section (A) and Section (B)) and FIG. 13. The removal rate of phosphate for ZIPGEM ranged between 73% to 92%.

The R2 obtained from the linear regression curve of the Thomas and Yoon-Nelson model was 0.721 and 0.721. The KT constant from the Thomas models calculated from the linear regression is 2.50E (−6) and the calculated q0 is 7.65 mg·g⁻¹. While the calculated KYN obtained from the linear regression of the data is 1E (−05) min⁻¹ and the value of T is ˜166 days (239,110 min) for this column set up. By comparison the adsorption capacity of ZIPGEM with other adsorbents (TABLE 20), it can be concluded that ZIPGEM is more effective that other low-cost adsorbents such as zeolites and sponge iron.

TABLE 20

| | Adsorption | | | |
|---|---|---|---|---|
| Adsorbent | Capacity | | Conditions | Reference |
| ZIPGEM | 7.65 | mg · g⁻¹ | Constant influent rate of 8 ml · min⁻¹ | Present |
| | | | Influent concentration of 4 mg · L⁻¹ | Disclosure |
| IFGEM* | 0.76 | mg · g⁻¹ | Constant influent rate of 3 ml · min⁻¹ | Ordonez et al. |
| AGEM** | 0.74 | mg · g⁻¹ | Influent concentration if 2 mg · L⁻¹ of nitrate | (2020) |
| | | | and 2 mg · L⁻¹ of phosphate | |
| Sponge iron | 0.087 | mg · g⁻¹ | Variation of hydraulic retention time | Cheng et al. |
| Zeolite | 0.055 | mg · g⁻¹ | Model consistent and | (2013) |
| | | | Temperature = 25 ± 1 | |
| ***Fe-LC | 45.88-75.85 | mg · g⁻¹ | Conducted both the Thomas model and BDST model | Wang et al |
| | | | Variation of bed depths | (2016) |
| Granulated ferric | 31,500 BV | | Variation in influent P concentrations | Genz et al |
| Hydroxide (GFH) | | | Period of 3 months without interim | (2004) |
| Activated aluminum | 21,000 BV | | back flushing | |
| oxide | | | At room temperature (18-25° C.) | |
| Ferric Sludge | 18-32.7 | mg · g⁻¹ | Variation of sludge sample packed in column | Song et al |

| | |
|---|---|
| Variation of bed depth | (2011) |
| Variation in inlet sample solutions | |
| Thomas model was used | |

### Media Recover and Reuse Potential

The growth and production of plant crops require 16 essential elements including the macronutrients: nitrogen (N), phosphorus (P) and potassium (P), the secondary nutrients: calcium (Ca), magnesium (Mg) and sulfur(S) and the micronutrients: boron (B), chloride (CI), copper (Cu), iron (Fe), manganese (Mn), molybdenum (Mo) and zinc (Zn). Most plant crops required Fe in small quantities of about 0.44 kg to 0.68 kg (1 to 1.5 lb) Fe per 0.405 hectare (1 acre) (Hochmuth et al., 2011). While the application of chemical fertilizer as soil amendment increases crop production it can also cause side effects including water pollution from agricultural runoff, soil acidification, impact to the microbial ecology in the rhizosphere and affect nutritional balance (Lin et al., 2019). Alternatively, the application of organic fertilizers as soil amendment can prevent soil acidification and the long-term application of organic fertilizers can increase total soil organic carbon content (Wang et al., 2019), improve soil nutrients and can regulate and improve the structure of the microbial ecology in different soils (Cui et al., 2018, Lui et al., 2021).

Contemplating the use and reutilization of the exhausted ZIPGEM for local crop fields, instead of final disposal once ZIPGEM reaches saturation, would be more advantageous. Concurrently supporting the realization toward SDGs 2.3 to improve soil quality. The chemical element composition of the saturated ZIPGEM media is presented in TABLE 21, along with the chemical element composition of different fertilizers including fish manure (Ekinci et al., 2019), insect derived compost and commercial fertilizer (Choi et al., 2009). The re-use of the exhausted media as soil amendment is attributed to the sustainability and cost effectiveness of the new sorption media by lowering the cost and environmental impact in circular economy, reducing the ecological effects surrounding phosphorus mining (Koppelaar and Weikard, 2013) for chemical fertilizers and preserving the already limited phosphorus resources (Weikard and Seyhan, 2009). The search for low-cost fertilizer is currently needed given the 80% increase in price of fertilizer since 2020 (Bhadha et al., 2022). For instance, the current estimated cost to place fertilizer (N, P, K, Ca, Mg, Fe, Si, B, Cᵤ, Mn and Zn) for sugarcane crops is 494 $ per acre (Bhabha et al., 2022).

TABLE 21

| Saturated ZIPGEM | | Fish Manure* | | Insect derived compost** | | Commercial fertilizer** | |
|---|---|---|---|---|---|---|---|
| Comp. | Conc (%) | Comp. | Con (%) | Comp | Conc (%) | Comp | Conc (%) |
| Al | 3.38 | N | 3.66 | N | 2.1 | N | 3.2 |
| Si | 73.41 | P | 1.03 | P | 0.42 | P | 0.48 |
| P | 5.41 | K | 0.74 | K | 3.9 | K | 5.4 |
| Cl | 0.73 | Ca | 1.75 | Ca | 2.5 | Ca | 2.7 |
| K | 1.95 | Mg | 0.19 | Mg | 0.2 | Mg | 0.2 |
| Ca | 0.40 | Na | 0.22 | Na | 0.2 | Na | 0.1 |
| Ti | 0.61 | Total C | 41.44 | Fe | 345 (mg/kg) | Fe | 399.7 (mg/kg) |
| Fe | 13.42 | — | — | — | — | — | — |

### Conclusion:

With the accelerated increase in world population, the United Nations developed an agenda with Sustainable Development Goals to cover areas of concern including the production of clean water and sustainable food under the SDG 2.4 and 6.3. The present disclosure intends to propose three new green sorption media capable of removing nutrients from different water matrix to prevent eutrophication of aquatic system, while allowing the recycling of the adsorbed nutrients by direct applications of the exhausted media as soil amendment. The three green sorption media were explored in a series of isotherms, and the results were imputed into different forms of the Langmuir and Freundlich isotherm. The Langmuir 1 (Eq. 13) (Cₑ/qₑ VS. qₑ) linear form of the Langmuir isotherm model is preferable for estimating the qₘ of the sorption media (i.e., CPS, ZIPGEM and BIPGEM) given that the simulated data is the most similar to the experimental data. The predicted qₘ for CPS ranged from 0.114 to 0.938 mg·g⁻¹, for ZIPGEM it ranged from 0.947 to 1.832 mg·g⁻¹ and for BIPGEM it ranged from −0.131 to 1.824 mg·g⁻¹. The sorption media ZIPGEM achieved higher PO₄³⁻ adsorption capacities, and thus, its performance was the most excelled given its little variation on its performance under a wider range of influent water matrix (i.e., pH of 4, 7, and 10 and canal water). This supports its application in different water treatment systems. For instance, PO₄³⁻ removals as high as 99% were attained for ZIPGEM at initial PO₄³⁻ concentrations below 120 mg·L⁻¹ in the presence of NO₃⁻ when using surface water (canal water). Moreover, 90% PO₄³⁻ removals were attained for ZIPGEM at initial PO₄³⁻ concentrations above 60 mg·L⁻¹ within the different initial pH levels. A dynamic column study was performed using ZIPGEM to further characterize the dynamic adsorption capacity of the media. The maximum adsorption capacity of ZIPGEM estimated by the Thomas dynamic model in a column study was 7.56 mg·g⁻¹.

The sustainable nature of the different ingredients of the media matrix and the high PO₄³⁻ adsorption capacity and XRF chemical composition of the exhausted media further supports the direct application of ZIPGEM, BIPGEM, and CPS in sequence as soil amendment to aid in sustainable food production while contributing to improving soil quality. Finally, higher nitrate removal efficiency was attained by ZIPGEM, followed by BIPGEM, and CPS; however, the biological removal of nitrate was overlooked due to short contact time. Future work may be directed to understand the synthesis of microbiological and physiochemical nutrient removal mechanisms in the different green sorption media and how the different specialty ingredients of the media can further enhance the growth of microbial ecology (i.e., biochar), while further contributing to plant growth.

### Example #3

### Exploring Shared Adsorption Capacity and Thermodynamics for Simultaneous Removal of Microcystin and Phosphorus Via Green Sorption Media in Eutrophic Water

### Materials and Methods

### Media Characterization:

The adsorption capacities and removal mechanism of MC-LR of four green sorption media were explored. The sorption media CPS is composed of 92% sand, 5% clay, and 3% perlite in percentage by volume. ZIPGEM is composed of 85% sand, 5% clay, 5% ZVI, and 5% perlite in percent by volume. Both CPS and ZIPGEM were selected as control to investigate the differential effect of the inclusion of zero valent iron (ZVI) and biochar as media component. BIPGEM-1 is composed of 80% sand, 5% clay, 5% ZVI, 5% perlite, and 5% biochar in percentage by volume. While, BIPGEM-2 is composed of 60% sand, 5% clay, 5% ZVI, 5% perlite, and 25% biochar in percent by volume. The physical and chemical characteristics of the media were investigated for a better interpretation of the media removal mechanism. The density and Brunauer-Emmett-Teller (BET) surface area were analyzed by EMSL Analytical Laboratory. The saturated hydraulic conductivity and porosity were determined in a geotechnical laboratory at the University of Central Florida (UCF). The point of zero charge (PZC) was measured at a chemical laboratory at UCF following the salt addition method (Bakatula et al., 2018; Mahmood et al., 2011). The methodology was presented in detail by Ordonez et al. (022). Finally, the chemical composition of the media and the individual components was measured at the Advanced Materials Processing and Analysis Center at UCF via an X-ray fluorescence (XRF) analysis.

### Chemicals:

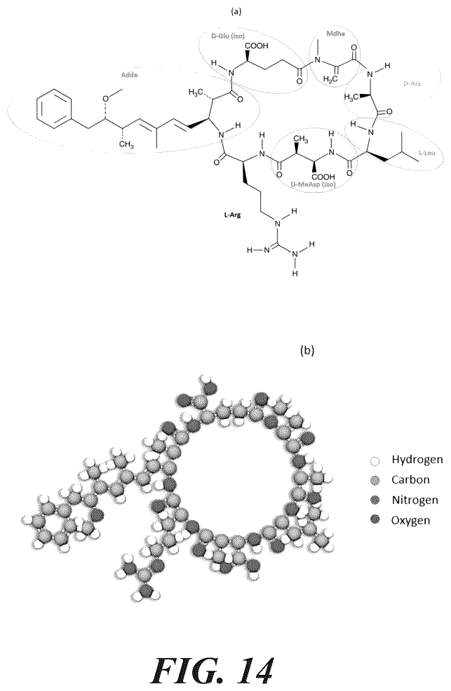

The MC-LR standard solution utilized for the isotherm studies was acquired from Sigma-Aldrich in liquid form with a concentration of 2.5 mM. The MC-LR standard for the column studies was obtained from Cayman chemical in a solid form. The MC-LR standard was first dissolved in methanol in accordance with its solubility point of 10 mg·m¹-1. The formal name for the MC-LR is cyclo [2,3-didehydro-N-methylalanyl-D-alanyl-L-leucyl-(3S)-3-methyl-D-B-aspartyl-L-arginyl-(2S,3S,4E,6E,8S,9S)-3-amino-9-methoxy-2,6,8-trimethyl-10-phenyl-4,6-decadienoyl-D-y-glutamyl], and its molecular form is C49H74N10O12 (FIG. 14).

### Stepped Isotherm Study:

A series of equilibrium isotherms were performed on the sorption media (i.e., CPS, ZIPGEM, BIPGEM-1 and BIPGEM-2) to determine its MC-LR adsorption capacity and the effect the coexistence of phosphate (PO₄³⁻) or calcium (Ca²⁺) has on the MC-LR removal potential and adsorption capacity. In the first equilibrium isotherm (denoted as Case 1 hereafter), 5 aliquant on Erlenmeyer Flask were set with 10 g of media and m¹ of DI water spiked with MC-LR to different initial concentrations ranging from 5-350 μg·L⁻¹ (5, 35, 50, 100, and 350 μg L⁻¹ denoted as Condition 1, Condition 2, Condition 3, Condition 4, and Condition 5, respectively). For BIPGEM-2 an additional condition (Condition 6) with a MC-LR concentration of 600 μg·L⁻¹ MC-LR was included. In the second and third isotherm studies (denoted as Case 2 and Case 3, respectively, hereafter) the same protocol was followed; however, the initial conditions were modified by including PO₄³⁻ to a concentration of 20 mg·L⁻¹ (i.e., Case 2) or Ca2+ to a concentration of 30 mg·L⁻¹ (i.e., Case 3) across all influent conditions (TABLE 22). The resultant solutions were shaken in a shaking platform for 24 hours at 160 rpm. At the conclusion of the shaking time the solutions were left to settle for 1 hour. Subsequently duplicate water samples with 100 mL of the resultant solutions were collected in a plastic bottle to be delivered to an external lab (i.e., Green Water Laboratories) for MC-LR analysis.

TABLE 22

| | Case 1 | | Case 2 | Case 3 |
|---|---|---|---|---|
| Control | | | 20 mg · L⁻¹ PO₄⁻³ | 30 mg · L⁻¹ Ca²⁺ |
| Condition 1 | 5 | μg · L⁻¹ | 5 μg · L⁻¹ + | 5 μg · L⁻¹ + |
| | | | 20 mg · L⁻¹ PO₄⁻³ | 30 mg · L⁻¹ Ca²⁺ |
| Condition 2 | 35 | μg · L⁻¹ | 35 μg · L⁻¹ + | 35 μg · L⁻¹ + |
| | | | 20 mg · L⁻¹ PO₄⁻³ | 30 mg · L⁻¹ Ca²⁺ |
| Condition 3 | 50 | μg · L⁻¹ | 50 μg · L⁻¹ + | 50 μg · L⁻¹ + |
| | | | 20 mg · L⁻¹ PO₄⁻³ | 30 mg · L⁻¹ Ca²⁺ |
| Condition 4 | 100 | μg · L⁻¹ | 100 μg · L⁻¹ + | 100 μg · L⁻¹ + |
| | | | 20 mg · L⁻¹ PO₄⁻³ | 30 mg · L⁻¹ Ca²⁺ |
| Condition 5 | 350 | μg · L⁻¹ | 350 μg · L⁻¹ + | 350 μg · L⁻¹ + |
| | | | 20 mg · L⁻¹ PO₄⁻³ | 30 mg · L⁻¹ Ca²⁺ |
| Condition 6* | 600 | μg · L⁻¹ | 600 μg · L⁻¹ + | 600 μg · L⁻¹ + |
| | | | 20 mg · L⁻¹ PO₄⁻³ | 30 mg · L⁻¹ Ca²⁺ |

Water samples delivered to Green Water laboratory in Palatka, Florida were analyzed for total MC with a Liquid Chromatography-Mass Spectrometry/Mass Spectrometry (LC-MS/MS) following the MMPB (2R-methyl-3S-methoxy-4-phenylbutanoic acid) method (Foss et al. 2). Guo et al. (2017) compared the analysis of MCs in drinking water by enzyme-linked immunoassay (ELISA) and LC-MS/MS method, finding that the LC-MS/MS results were more reliable than those from ELISA. An extra set of samples was collected and analyzed for PO43− or Ca2+ concentration via Hach measuring kits. The Hach product TNT844 was utilized to analyze the samples for PO43−, and the Hach product TNT869 was utilized to analyze the samples for Ca2+ concentrations. Water samples analyzed for PO43− or Ca2+ were previously filtered via a 0.45 μm membrane filter. To minimize the risk of the MC-LR adsorbing to the Erlenmeyer flask or sampling bottles, each of the flask and sampling bottles was rinsed 3 times with the spiked solution or the corresponding water sample prior to sample storage.

The different concentrations were selected given the wide range of concentrations at which MC-LR is found in different environments. For instance, the presence of MC-LR has been found in different drinking water sources or public reservoirs. In Sao Paulo, Brazil, concentrations ranging from 0.5-100 μg·L⁻¹ were found in a public reservoir (Nobre, 1997), while concentrations up to 1.25 μg·L⁻¹ were detected in Pará, in the Brazilian Amazonia (Vieira et al., 2005). Different aquatic systems have also been affected with high concentrations of MC; for instance, the concentrations of MC-LR in the Indian River Lagoon in the state of Florida ranged from 0.01-85.70 μg·L⁻¹ between 2018 and 2019, with higher concentration detected during the wet season (May to October) (Laureano-Rosario et al., 2021). Moreover, Billam et al. (2006) reported MC-LR concentration in 2 lakes in Texas with concentrations ranging from 0.096-4.914 μg·L⁻¹ in Buffalo Spring Lake and 0.2-5.83 μg·L⁻¹ in Lake Ransom Canyon, and in both lakes higher concentrations were observed during the spring season. The issue with high concentrations of MC extends outside of the USA; for instance, in Beira Lake in Sri Lanka, MC-LR concentrations varied from 11,450-25,230 μg·L⁻¹, with higher concentration targeted within the rainy season (Piyathilaka and Manage 2017).

### Equilibrium Isotherm:

Data collected for MC-LR concentration at different influent conditions were analyzed in terms of percentage removal as well as for its absorption capacity by the Langmuir and Freundlich isotherm models. The Langmuir isotherm is widely used to explore the adsorption capacity of different sorption materials (Languir, 1932; Ho and Chiang, 2001). Different linearization of the Langmuir model can be found in literature; however, Guo and Wang (2019) suggested that the linear form presented in Equation 30 and Equation 31 can better estimate the Langmuir parameters. In this equation the parameter qₑ is the amount of sorbate adsorbed per unit weight (μg·g⁻¹) of the sorption media and it can be calculated following Equation 32. In Equation 3, m is the mass of the sorption media in grams, Co is the initial concentration on the solution in μg·L⁻¹, Ce is the concentration of the solution at equilibrium in μg·L⁻¹, and V is the volume of the solution in L. Moreover, the Langmuir parameters KL and qₘ correspond to the Langmuir equilibrium constant (L·μg⁻¹) and the maximum adsorption capacity of the absorbent (μg·g⁻¹), respectively, and are retrieved from the regression plot of

$$\frac{{C}_{e}}{{q}_{e}} vs . {C}_{e} .$$

$$\begin{matrix}{q}_{e} = \frac{{q}_{m} {K}_{L} {C}_{e}}{1 + {K}_{L} {C}_{e}} & ( 30 ) \\ \frac{{C}_{e}}{{q}_{e}} = \frac{1}{{q}_{m}} {C}_{e} + \frac{1}{{K}_{L} {q}_{m}} & ( 31 ) \\ {q}_{e} = \frac{( {C}_{o} - {C}_{e} ) V}{m} & ( 32 )\end{matrix}$$

The Freundlich isotherm model is an empirical equation, and its nonlinear form is presented in Equation 33, while one of the most common linear forms is presented in Equation 34 (Freundlich, 1909; Appel, 1973). The linear form of the Freundlich equation is obtained from the linear regression In (qₑ) vs. In (Cₑ), where the slop of the line is 1/n and the K_{F} is calculated form the x-interception. The 1/n parameter indicates the adsorption intensity where the adsorption is favorable If 1/n is between 0 and 1 (0<1/n>1) then the adsorption is unfavorable.

$$\begin{matrix}{q}_{E} = {K}_{F} {C}_{e}^{\frac{1}{n}} & ( 33 ) \\ ln ( {q}_{e} ) = \frac{1}{n} ln ( {C}_{e} ) + ln ( {K}_{F} ) & ( 34 )\end{matrix}$$

The thermodynamic parameters including Gibbs free energy (ΔG), enthalpy change ΔH° and entropy change 4S can aid in the explanation of the MC-LR removal mechanism by the sorption media. To determine these parameters a series of series of batch tests were performed with aliquots with 10 grams of media and 250 ml of DI water spike to Condition 5 for the three cases (Case 1, 2 and 3) at three different temperatures (17 C°, 23 C° and 35 C°). The same shaking and analysis protocol as the equilibrium isotherms was followed (Section 2.3).

The thermodynamic parameters can be determined from the Van't Hoff Equation (Equation 35) and the change in Gibbs free energy (ΔG) which can described in the form of Equation 36. Where k_{eq} is the equilibrium constant and can be calculated following Equation 37. The ΔS° is the standard entropy change (J/mol K), ΔH° is the standard enthalpy change (kJ/mol) and 4G° is the standard Gibbs free energy change (kJ/mol). When ΔS° is positive value it signifies affinity of adsorbent towards the aqueous solution, while a negative value relates to a lower affinity for adsorption. The change in enthalpy (ΔH) characterizes the total changes in bond energy between the adsorbent and adsorbate. For ΔH° an endothermic and exothermic reaction is represented by a positive and negative value, respectively. Moreover, a non-spontaneous and spontaneous reaction is inferred from a positive and negative value of ΔG, respectively.

$$\begin{matrix}Δ {G}^{0} = Δ {H}^{0} - T Δ {S}^{0} & ( 35 ) \\ Δ {G}^{0} = - RTln ( {k}_{eq} ) & ( 36 ) \\ {K}_{eq} = \frac{{q}_{e}}{{C}_{e}} & ( 37 )\end{matrix}$$

Variance (ANOVA) test without replication with the data analysis module in Microsoft Excel. The one-way ANOVA was taken to verify if the differences in removal efficiency among the different sorption media (i.e., CPS, ZIPGEM, BIPGEM-1 and BIPGEM-2) at the various influent cases were significant under a 95% confidence interval. The 2-null hypothesis (H₀) and 2 alternative hypotheses (Hₐ) to be tested are as follows:

H₀: There is not a significant difference in the removal efficiency means between sorption media. Hₐ: There is a significant difference in the removal efficiency between sorption media.

A 2-way ANOVA test was applied to the removal efficiency of each media at different influent conditions and cases to verify if the differences in removal efficiency are significant under a 95% confidence interval. The assumption considered by the 2-way ANOVA includes the homogeneity of variance, independence of observations, and normally distributed dependent variables, and the data should not have significant outliers (Knežević and Žmuk, 2021). The 2-null hypotheses (H₀₁, H₀₂) and 2 alternative hypotheses (Hₐ₁, Hₐ₂) to be tested are presented as follows:

Hoi: There is not a significant difference in the average removal efficiencies among the different initial influent MC-LR concentrations (i.e., Conditions 1-5 or Conditions 1-6) for CPS, ZIPGEM, BIPGEM-1 and BIPGEM-2. (Ha1: There is a significant difference in the average removal efficiencies among the different initial influent MC-LR concentrations (i.e., Conditions 1-5 or Conditions 1-6) for CPS, ZIPGEM, BIPGEM-1, and BIPGEM-2.)

H02: There is not a significant difference in the average removal efficiencies among the different cases (i.e., Cases 1, 2, and 3) for CPS, ZIPGEM, BIPGEM-1, and BIPGEM-2 (Hₐ2: There is a significant difference in the average removal efficiencies among the different cases (i.e., Cases 1, 2, and 3) for CPS, ZIPGEM, BIPGEM-1, and BIPGEM-2.)

The acceptance or rejection of the null hypotheses was determined by comparison of the F and Fcrit values. If the F value was greater than the Fcrit value, then the null hypothesis was rejected and the alternative hypothesis was chosen.

### Columns Study

A fixed-bed column study for CPS, ZIPGEM and BIPGEM-1 was performed to collect information on its removal efficiency and adsorption capacity for MC-LR treatment in a dynamic environment. The experimental setup consisted of a polyvinyl chloride column of 12.7 cm depth (5 inches) and 10.2 cm (4 inches) diameter in triplicate for each sorption media. Each column contained a filter and layer of pebbles at the bottom to prevent clogging, followed by 1,300 mL of media (i.e., CPS, ZIPGEM, BIPGEM-1) and topped with a layer of pebbles to aid in water distribution at the surface of the column. The column was operated in a downflow manner with peristaltic pump to provide a constant flowrate of 14 mL·min⁻¹. Each column has 1,300 ml of media. The hydraulic loading rate is 2,517 1·day⁻¹·m⁻² (60.939 gallons·day⁻¹·ft⁻²). The influent consisted of spiked surface water at a concentration of 70 μg·L⁻¹ of MC-LR that reflects the typical high range of MC-LR concentrations in natural environments. The media reach 50% breakthrough at 40 hours (50% removals were obtained at this point).

Water samples were collected at different times to capture the breakthrough curve of CPS, ZIPGEM and BIPGEM-1 for MC-LR adsorption. The collected water samples were delivered to Green Water laboratory for analysis for total MC with a LC-MS/MS. Moreover, a set of triplicate samples collected from surface water was sent to Eurofins Flowers Chemical Laboratories, Inc. for analysis of basic water parameters (i.e., dissolved iron, dissolved aluminum, nitrogen kjeldahl, nitrate, nitrite, total nitrogen, total phosphorus, and chlorophyll a). A separate set of triplicate water samples was sent to ALS testing laboratories to test the concentration of tannic acid in the water.

Information on the breakthrough curve for all sorption media (i.e., CPS, ZIPGEM and BIPGEM-1) was imputed into 2 dynamic models, namely Thomas and Modified Dose-Response (MDR) model. The Thomas model is commonly used to produce a general analysis of the adsorption process in a fixed bed column. The Thomas model was developed based on the Langmuir isotherm equilibrium and second-order reversible kinetics (Gonzalez-Lopez et al., 2021). The linear form of the Thomas model is presented in Equation 35 and can be obtains from the linear regression of ln

$$( \frac{{C}_{o}}{{C}_{t}} - 1 ) vs . t ,$$

where t is time in minutes; Cₒ and Cₜ are the influent MC-LR concentration and the effluent concentration at time t in μg·L⁻¹, respectively; m is the mass of media along the fixed bead in grams; Q is the influent flow rate in L·min⁻¹; KT is the Thomas constant in L·minutes⁻¹·μg⁻¹; and q, is the maximum adsorption capacity of the media in μg·L⁻¹

$$ln ( \frac{{C}_{o}}{{C}_{t}} - 1 ) = \frac{{K}_{T} {q}_{o} m}{Q} - {K}_{T} {C}_{o} t \qquad ( 38 )$$

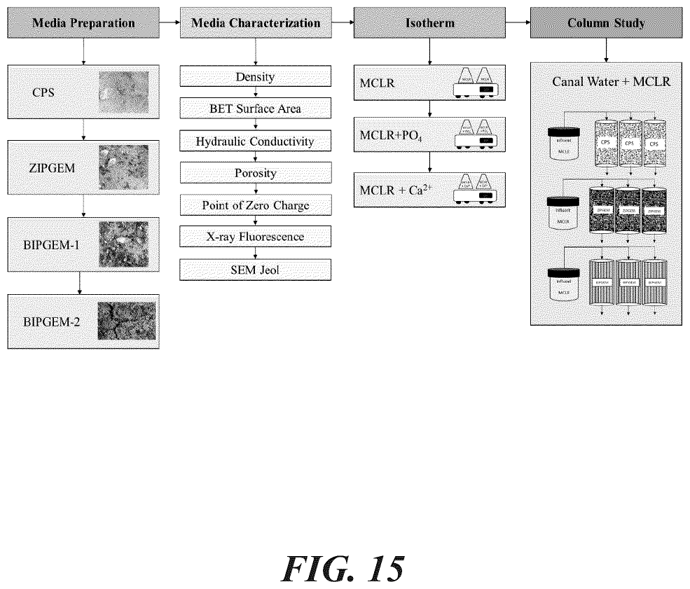

The MDR model is an empirical model, which is more suitable for asymmetric breakthrough curves and thus minimizes the error from the Thomas model (Song et al., 2011). The linear form of the MDR model is presented in Equation 36; from this equation the constants Ct, Co, Q, m, qₒ, and t keep the same meaning and units as in the Thomas model, however, the constant a_{mdr} corresponds to the MDR constant (unitless). FIG. 15 summarizes the whole experimental setup.

$$ln ( \frac{{C}_{t}}{{C}_{o} - {C}_{t}} ) = {a}_{mdr} ln ( {C}_{o} Qt ) - {a}_{mdr} ln ( {q}_{o} m ) \qquad ( 39 )$$

### Results:

### Media Characteristics:

The characteristics of the sorption media CPS, ZIPGEM, BIPGEM-1, and BIPGEM-2 are summarized in TABLE 23. The results indicate that the sorption media BIPGEM-2 has the highest BET surface area, followed by ZIPGEM, BIPGEM-1 and CPS. ZIPGEM has the highest saturated hydraulic conductivity followed by CPS, BIPGEM-1, and BIPGEM-2, respectively. The difference in the physical characteristics among CPS, ZIPGEM, BIPGEM-1 and BIPGEM-2 can be attributed to the inclusion of ZVI or ZVI and biochar as media components and the different media matrices. A larger surface area and higher porosity can be beneficial for adsorption processes because it can provide more active sites (Bhatnagar and Jain, 2005; Rong et al., 2017; Subramaniam et al., 2017), while a lower saturated hydraulic conductivity can be beneficial for adsorption process because it extends the contact time of the media and the adsorbate. However, a lower density can be beneficial for application purposes given the inverse relationship between density and volume (pore space). The location of the PZC for the media can also impact the removal mechanisms. The PZC for CPS, ZIPGEM, BIPGEM-1 and BIPGEM-2 occurs at pH of 5.6, 9.2, 9.6, and 10, respectively. At the PZC the charge at the surface of the sorption media is zero, however, when the pH drops below the PZC the surface charge is positively charged, whereas when the pH is above the PZC the charge in the surface of the media is negatively charged (Bhatnagar and Jain, 2005).

The location of the PZC for ZIPGEM can be attributed to the presence of ZVI because the PZC for iron hydroxides ranges from 7-9 (Wu et al., 2017). However, the higher location of the PZC in BIPGEM-1 and BIPGEM-2 can be attributed to the presence of biochar, given that the PZC for biochar (as disclosed herein) is located at a pH of 10.6 (TABLE 23)

TABLE 23

| | | | Saturated | |
|---|---|---|---|---|
| | | | Hydraulic | |
| | Density | BET Surface | Conductivity | PZC |
| Name | (g · cm³) | Area (m² · g⁻¹) | (m · sec⁻¹) | (±Stdev) |
| CPS | 2.61 | 1.08 | 1.7(10⁻⁴) | 5.6 ± |
| | | | | 0.22 |
| ZIPGEM | 2.78 | 1.50 | 2.8(10⁻⁴) | 9.2 ± |
| | | | | 0.33 |
| BIPGEM-1 | 2.59 | 1.35 | 1.2(10⁻⁴) | 9.6 ± |
| | | | | 0.06 |
| BIPGEM-2 | 2.67 | 3.08 | 0.6(10⁻⁴) | 10.0 ± |
| | | | | 0.4 |
| Biochar | 1.18 | 371.11 | 1.1(10⁻⁴) | 10.6 ± |
| | | | | 0.01 |

The chemical elemental composition of the different components of the media matrix were explored by an XRF analyzer to explore how each material can contribute to the removal mechanism of the sorption media (TABLE 24). The main component of these green sorption media is sand, followed by clay and perlite, whereas ZVI is a component of ZIPGEM, BIPGEM-1 and BIPGEM-2 and biochar is a component of BIPGEM-1 and BIPGEM-2. Sand (the main component of all media) is made of ˜91% Si, and clay (the second main component in the all-media matrix) is made of ˜38% and ˜52% Al and Si, respectively. The composition of perlite is mainly Si, K, and Al, accounting for ˜57%, ˜19%, and ˜9%, respectively. ZVI is composed of ˜95% of Fe, while the main components of biochar are Ca and K, accounting for ˜50.9% and ˜23.8% respectively.

In TABLE 25, the chemical elemental composition for CPS, ZIGEM, BIPGEM-1 and BIPGEM-2 is presented. The major difference in the elemental composition among the media is the presence of Fe in ZIPGEM, BIPGEM-1 and BIPGEM-2 in comparison to CPS. In ZIPGEM, BIPGEM-1 and BIPGEM-2, Fe accounts for ˜12.1%, ˜12.8% and ˜5.6%, respectively of the media's chemical elemental composition, in comparison to CPS, in which Fe only accounts for ˜0.4% of its elemental composition. With the increased Fe percentage in ZIPGEM, the percentage of Si decreases as evidence of the lower content of sand in ZIPGEM, BIPGEM-1 and BIPGEM-2.

TABLE 24

| | Sand | | Clay | | Perlite | | ZVI | | Biochar | |
|---|---|---|---|---|---|---|---|---|---|---|
| Element | Conc | Unit | Conc | Unit | Conc | Unit | Conc | Unit | Conc | Unit |
| Al | 2.3 ± (0.4) | % | 37.7 ± (0.1) | % | 9.3 ± (0.5) | % | 0.4 ± (0.3) | % | — | % |
| Si | 90.9 ± (3.2) | % | 51.6 ± (0.1) | % | 57.0 ± (1.7) | % | 0.7 | % | 2.7 | % |
| P | 2.0 ± (0.1) | % | 1.5 | % | 2.2 ± (0.1) | % | 0.5 | % | 1.9 | % |
| S | 0.4 ± (0.3) | % | 0.5 | % | 1.3 ± (0.2) | % | — | % | 0.9 | % |
| Cl | 1.6 ± (1.1) | % | 1.5 | % | 1.7 ± (0.1) | % | 0.5 | % | 2.3 | % |
| K | 2.1 ± (0.2) | % | 0.8 | % | 19.3 ± (1.4) | % | — | % | 23.8 | % |
| Ca | 0.9 ± (0) | % | 1 | % | 6.1 ± (0.1) | % | 0.3 | % | 50.9 | % |
| Ti | 0.9 ± (0.6) | % | 1.7 | % | 0.2 | % | — | % | 1.6 | % |
| Fe | 0.3 ± (0.1) | % | 3.6 | % | 2.4 ± (0.1) | % | 95.6 ± (0.2) | % | 13 | % |
| Cr | — | — | — | — | — | — | 0.3 | % | 0.1 | % |
| Mn | — | — | — | — | 0.3 | % | 0.5 | % | 2.1 | % |
| Ni | — | — | — | — | — | — | 0.4 | % | — | % |
| Cu | — | — | — | — | — | — | 0.5 | % | 0.4 | % |
| Zn | — | — | — | — | — | — | 0.3 | % | 0.2 | % |
| Sr | — | — | — | — | — | — | — | — | 0.1 | % |

TABLE 25

| | Sand | | Clay | | Perlite | | ZVI | | Biochar | |
|---|---|---|---|---|---|---|---|---|---|---|
| Element | Conc | Unit | Conc | Unit | Conc | Unit | Conc | Unit | Conc | Unit |
| Al | 2.3 ± (0.4) | % | 37.7 ± (0.1) | % | 9.3 ± (0.5) | % | 0.4 ± (0.3) | % | — | % |
| Si | 90.9 ± (3.2) | % | 51.6 ± (0.1) | % | 57.0 ± (1.7) | % | 0.7 | % | 2.7 | % |
| P | 2.0 ± (0.1) | % | 1.5 | % | 2.2 ± (0.1) | % | 0.5 | % | 1.9 | % |
| S | 0.4 ± (0.3) | % | 0.5 | % | 1.3 ± (0.2) | % | — | % | 0.9 | % |
| Cl | 1.6 ± (1.1) | % | 1.5 | % | 1.7 ± (0.1) | % | 0.5 | % | 2.3 | % |
| K | 2.1 ± (0.2) | % | 0.8 | % | 19.3 ± (1.4) | % | — | % | 23.8 | % |
| Ca | 0.9 ± (0) | % | 1 | % | 6.1 ± (0.1) | % | 0.3 | % | 50.9 | % |
| Ti | 0.9 ± (0.6) | % | 1.7 | % | 0.2 | % | — | % | 1.6 | % |
| Fe | 0.3 ± (0.1) | % | 3.6 | % | 2.4 ± (0.1) | % | 95.6 ± (0.2) | % | 13 | % |
| Cr | — | — | — | — | — | — | 0.3 | % | 0.1 | % |
| Mn | — | — | — | — | 0.3 | % | 0.5 | % | 2.1 | % |
| Ni | — | — | — | — | — | — | 0.4 | % | — | % |
| Cu | — | — | — | — | — | — | 0.5 | % | 0.4 | % |
| Zn | — | — | — | — | — | — | 0.3 | % | 0.2 | % |
| Sr | — | — | — | — | — | — | — | — | 0.1 | % |

### Isotherm Results:

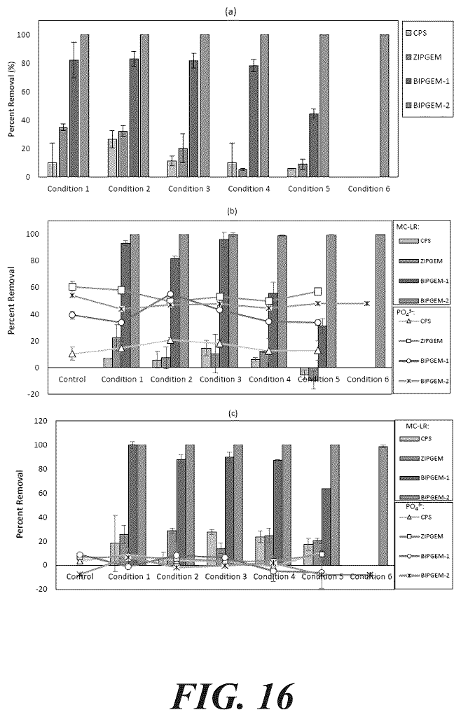

A series of isotherm studies were performed to understand the removal efficiency and the effect that different influent concentrations have on the MC-LR removal by the different sorption media (i.e., CPS, ZIPGEM, BIPGEM-1 and BIPGEM-2). Additionally, 3 different cases were selected to investigate the effect that the coexistence of PO43− and Ca2+ has on the MC-LR removal efficiency of sorption media. In Case 1, MC-LR alone was spiked in the influent at different concentrations, while in Case 2, PO₄³⁻ at a constant concentration was spiked in the influent with varying MC-LR concentrations and in Case 3, Ca²⁺ at a constant concentration was included along the spiked influents with different MC-LR concentrations. The different influent concentrations ranged from 5-600 μg·L⁻¹ and are denoted as Condition 1-6 as explained in TABLE 22. In general, in Case 1, Case 2 and Case 3 (FIG. 16 Section (a), Section (b), and Section (c)), a trend can be observed with decreasing MC-LR removal efficiency as the concentration of MC-LR in the influent increases. The highest MC-LR removal efficiencies were obtained by BIPGEM-2, ranging between 98 to 100% across all cases, followed by BIPGEM-1 ZIPGEM and CPS, respectively. For instance, in Case 1 the removal efficiencies of BIPGEM-1 ranged from 44.6-82.9%, while in Case 2 and Case 3 the removal efficiencies ranged from 29.5-91.7% and 63-100%, respectively. For ZIPGEM and CPS the removal efficiencies were lower. In Case 1 the removal efficiencies of ZIPGEM and CPS ranged between 9% and 35% and 6.1% and 26.7%, respectively. In Case 2, the removal efficiencies ranged between 0% and 22% for ZIPGEM and between 0% and 14.6% for CPS. Finally, in Case 3 the removal efficiencies attained by ZIPGEM and CPS ranged from 20.6-28.6% and 6-27.7%, respectively.

In Case 2, the simultaneous removal of phosphorus was studied, and it was observed that ZIPGEM outperformed the other sorption media in terms of phosphate removal, with removals ranging from 49.4-60.6%. The PO43− removal by BIPGEM-2 ranged from 43.9-54.09%, while for BIPGEM-1 it ranged from 33.7-43.13%. Lower PO₄³⁻ removal were obtained by CPS ranging between 10.3-20.6%. In Case 3, occurrence of Ca²⁺ was studied, and no significant change in effluent concentration, in comparison to the influent concentration, was observed among the 4 different sorption media.

The MC-LR percentage removals obtained by each sorption media in each case were subject to a 1-way ANOVA at a 95% critical interval. By comparing the resultant F and F_{crit} values, it was concluded that there is a significant difference among the mean values of these removal efficiencies across the 4-sorption media. This conclusion was attained via the acceptance of the alternative hypothesis. Furthermore, the percentage removals across the 3 different cases (i.e., Cases 1, 2, and 3) and conditions (i.e., Conditions 1-5 or Conditions 1-6) within each media were further compared by a 2-way ANOVA test with a 95% critical interval. The test was performed to determine if there was a significant difference among the MC-LR percentage removals attained at the different cases and conditions within each media. The acceptance or rejection of the null hypothesis was determined based on the comparison of the F and F_{crit} value. For BIPGEM-2, ZIPGEM and CPS, both null hypotheses (H₀₁ and H₀₂) were accepted, leading to the conclusion that there were not significant differences in the MC-LR percentage removals obtained among the different MC-LR influent concentrations and cases. On the contrary, for BIPGEM-1 the first null hypothesis was rejected (H₀₁), allowing for acceptance of the first alternative hypothesis, leading to the conclusion that there were significant differences across MC-LR percentage removals attained by the different influent MC-LR conditions (Condition 1-5). Moreover, for BIPGEM-1, the second null hypothesis was accepted, generating the conclusion that there were not significant differences in the MC-LR removals across the different cases.

To further characterize the MC-LR adsorption capacity of the sorption media (i.e., CPS, ZIPGEM, BIPGEM-1, and BIPGEM-2), the isotherm results were imputed into the Langmuir and Freundlich isotherm models, and the results are presented in TABLE 26 and TABLE 27. High correlation efficiencies (R2) were obtained for CPS, ZIPGEN and BIPGEM-1 from the linear regression following the Freundlich isotherm, while for BIPGEM-2 R2 was only observable in Case 1. For the Langmuir isotherm model, high value of R2 was only obtained from the linear regression of BIPGEM-1 (all cases) and CPS and BIPGEM-2 in Case 1, and an acceptable R2 was obtained for ZIPGEM case 1. The low R2 for CPS, ZIPGEM and BIPGEM-2 in Case 2 and Case 3 can be explained by the first and second assumption of the Langmuir isotherm that states that the adsorption is entirely of a monolayer at the surface and that only one adsorbed molecule can be adsorbed at each site. Considering these results, it can be concluded that for CPS and ZIPGEM the adsorption is monolayer on homogeneous sites when MC-LR is alone in the influent, whereas, when MC-LR coexists with other contaminants (i.e., PO₄³⁻ and Ca²⁺), the adsorption is multilayer on heterogeneous sites according to the assumption of the Freundlich isotherm model. Such conclusion cannot be made for BIPGEM-1, given that high R2 were attained from the linear regression of both Langmuir and Freundlich models.

The adsorption capacities in Case 1 for CPS, ZIPGEM, BIPGEM-1 and BIPGEM-2 obtained by the Langmuir model are 0.74 μg·g⁻¹, 1 μg·g⁻¹, 4.63 μg·g⁻¹, and 29.49 μg·g⁻¹, respectively. BIPGEM-2 had the higher adsorption capacity followed by BIPGEM-1, ZIPGEM and CPS. Moreover, the n value derived from the Freundlich isotherm model indicates whether the adsorption is favorable or unfavorable. Based on the n values from CPS, the adsorption for Case 1 and Case 3 is favorable, while the adsorption in Case 2 is not favorable. On the contrary, for ZIPGEM, BIPGEM-1 and BIPGEM-2 the adsorption is favorable for all cases (Case 1, Case 2, and Case 3). The adsorption capacity of BIPGEM-1 and BIPGEM-2 are compared to different adsorbents in the literature and is summarized in TABLE 28.

TABLE 26

| Media | Condition | R² | Equation | Parameter |
|---|---|---|---|---|
| CPS | Case 1 | 0.841 | y = 1.348x + | K_{T} = 0.009 |
| | | | 155.9 | qₘ = 0.74 μg · g⁻¹ |
| | Case 2 | 0.005 | y = −0.363x + | K_{T} = −0.0007 |
| | | | 498.08 | qₘ = −2.75 μg · g⁻¹ |
| | Case 3 | 0.045 | y = −0.433x + | K_{T} = −0.433 |
| | | | 341.65 | qₘ = −2.31 μg · g⁻¹ |
| ZIPGEM | Case 1 | 0.239 | y = 0.999x + | K_{T} = 0.005 |
| | | | 183.03 | qₘ = 1.00 μg · g⁻¹ |
| | Case 2 | 0.070 | y = 1.301x + | K_{T} = 0.0048 |
| | | | 269.77 | qₘ = 0.77 μg · g⁻¹ |
| | Case 3 | 0.017 | y = 0.062x + | K_{T} = 0.0005 |
| | | | 136.56 | qₘ = 16.13 μg · g⁻¹ |
| BIPGEM- 1 | Case 1 | 0.999 | y = 0.216x + | K_{T} = 0.0294 |
| | | | 7.35 | qₘ = 4.63 μg · g⁻¹ |
| | Case 2 | 0.854 | y = 0.1473x + | K_{T} = 0.0207 |
| | | | 7.10 | qₘ = 6.79 μg · g⁻¹ |
| | Case 3 | 0.951 | y = 0.1265x + | K_{T} = 0.028 |
| | | | 4.489 | qₘ = 7.91 μg · g⁻¹ |
| BIPGEM- 2 | Case 1 | 1 | y = 0.0339x + | K_{T} = 1.8032 |
| | | | 0.0188 | qₘ = 29.49 μg · g⁻¹ |
| | Case 2 | 0.005 | y = 0.0542x + | K_{T} = 0.329 |
| | | | 0.1645 | qₘ = 18.45 μg · g⁻¹ |
| | Case 3 | — | — | qₑ* = 16.9 μg · g⁻¹ |

TABLE 27

| Media | Condition | R² | Equation | Parameter |
|---|---|---|---|---|
| CPS | Case 1 | 0.893 | y = 0.795x − 4.748 | K_{F} = 0.009 |
| | | | | n = 1.258 |
| | Case 2 | 0.900 | y = 1.066x − 6.3315 | K_{F} = 0.002 |
| | | | | n = 0.938 |
| | Case 3 | 0.802 | y = 0.987x − 5.423 | K_{F} = 0.004 |
| | | | | n = 1.013 |
| ZIPGEM | Case 1 | 0.771 | y = 0.5852x − 3.7661 | K_{F} = 0.023 |
| | | | | n = 1.709 |
| | Case 2 | 0.864 | y = 0.694x − 4.679 | K_{F} = 0.009 |
| | | | | n = 1.442 |
| | Case 3 | 0.950 | y = 0.9722x − 4.699 | K_{F} = 0.009 |
| | | | | n = 1.061 |
| BIPGEM- 1 | Case 1 | 0.917 | y = 0.6332x − 1.6424 | K_{F} = 0.194 |
| | | | | n = 1.579 |
| | Case 2 | 0.852 | y = 0.4782x − 0.977 | K_{F} = 0.376 |
| | | | | n = 2.091 |
| | Case 3 | 0.964 | y = 0.5836x − 0.984 | K_{F} = 0.374 |
| | | | | n = 1.713 |
| BIPGEM- 2 | Case 1 | 1 | y = 0.64x + 3.059 | K_{F} = 0.047 |
| | | | | n = 1.563 |
| | Case 2 | 0.036 | y = −0.7548x + 1.632 | K_{F} = 0.195 |
| | | | | n = −1.325 |
| | Case 3 | — | — | — |

TABLE 27

| Media | Adsorption capacity | | Experimental setup | Reference |
|---|---|---|---|---|
| Coconut shell | 16.1 | mg · g⁻¹ | Varying amount of carbon | Huang et al. |
| Bituminous coal | 17.5 | mg · g⁻¹ | Initial concentration 250 μg · L⁻¹ | (2007) |
| Wood | 83.3 | mg · g⁻¹ | pH of 7.5 and Temp. 25° C. | |
| | | | DI water | |
| | | | Langmuir | |
| Peat | 0.255 | mg · g⁻¹ | Varying initial concentration | Sathishkumar |
| | | | Concentration range 100-1000 μg · L⁻¹ | et al. (2010) |
| | | | pH of 3 | |
| | | | DI water | |
| | | | Langmuir | |
| Iron oxide | 0.594 | mg · g⁻¹ | Adsorbent dose = 0.1, 1, 2, 3, and 4 mg · L⁻¹ | Gao et al. |
| nanoparticles | | | Initial concentration 250 μg · L⁻¹ | (2012) |
| | | | pH of 7 and Temp. 25° C. | |
| | | | DI water | |
| | | | Langmuir | |
| Wood-based GAC | 26 | mg · g⁻¹ | Adsorbent dose = 0, 1, 5, and 11 mg · L⁻¹ | Villars et al. |
| | | | Initial concentration: 50 μg · L⁻¹ | (2020) |
| | | | DI water | |
| Activated carbon | 0.357 | mg · g⁻¹ | Varying amount of carbon: 0.01-0.05 g | Mashile et al. |
| | | | Concentration range: 5-65 μg · L⁻¹ | (2018) |
| | | | pH of 3-9 | |
| | | | DI water | |
| | | | Langmuir | |
| BIPGEM-1 | 0.004-0.008 | mg · g⁻¹ | Varying initial concentration | Present Disclosure |
| | | | Concentration range: 5-600 μg · L⁻¹ | |
| BIPGEM-2 | 0.017-0.029 | mg · g⁻¹ | pH of 7 | |

DI water spiked with PO4 or Ca 3-2+
Langmuir

### Phosphate and Mc-LR Shared Adsorption:

Phosphate adsorption capacity (qₑ) of the sorption media CPS, ZIPGEM, BIPGEM-1 and BIPGEM-2 is presented in TABLE 29, along with the shared phostaphe adsorption capacity, when MC-LR is present in the water matrix (q_{e_shared}). The phosphate adsorption capacity of BIPGEM-1 was the least affected by the presence of MC-LR as the qₑ and q_{e_shared} estimated is 0.210 and 0.123 mg·g⁻¹, respectively. For both, ZIPGEM and BIPGEM-1, the qₑ reduced by about 0.038 and 0.044 mg·g⁻¹, respectively, in the presence of MC-LR. The decrease in the q_{e,shared} from the qₑ can be explained by a competition between phosphate and MC-LR for the available adsorption sites in the surface of the media. While, the qₑ, shared slightly increases in CPS by 0.015 mg·g⁻¹. Given the low qₑ and a higher standard deviation in the q_{e,shared} in CPS, such difference can be more relatable with a variation in the media phosphate adsorption capacity that with the effect by the presence of MC-LR. The maximum adsorption capacity of the sorption media (qₒ) (i.e., CPS, ZIPGEM, BIPGEM-1 and BIPGEM-2) calculated by the Langmuir isotherm are presented in TABLE 26. In general, a decrease in the MC-LR q0 of the sorption media was observed in Case 2, under the coexistence of MC-LR and phosphate, further implying a competition for the available sorption sites in the surface of the media.

TABLE 29

| | CPS | ZIPGEM | BIPGEM-1 | BIPGEM-2 |
|---|---|---|---|---|
| qₑ(mg · g⁻¹) | 0.055 | 0.324 | 0.210 | 0.300 |
| | (0.026) | (0.022) | (0.017) | (0.010) |
| q_{e, shared}*(mg · g⁻¹) | 0.070 | 0.286 | 0.213 | 0.256 |
| | (0.045) | (0.022) | (0.046) | (0.011) |

### Thermodynamics Parameters:

The ΔG°, ΔH° and ΔS° are possible indicators of the nature of adsorption. Given the outperformance of BIPGEM-1 and BIPGEM-2 in the MC-LR adsorption capacity, the thermodynamic properties were further investigated. The ΔH° values for BIPGEM-1 in all cases are positive, indicating that the adsorption is endothermic. While for BIPGEM-2, the ΔH° value indicated that the adsorption is exothermic when the water matrix contains only MC-LR, but when the water matrix phosphate or calcium the adsorption becomes endothermic. The endothermic nature of the MC-LR adsorption to biochar has previously been confirmed by Li et al., (2014). Given the increase in the MC-LR removal efficiency in BIPGEM-1 and BIPGEM-2 and the endothermic nature of the MC-LR adsorption to the sorption media, it can be suggested that the inclusion of biochar was the main contributor in the media for MC-LR removal. The ΔS° indicates affinity between the sorption media BIPGEM-1- and BIPGEM-2 and the aqueous solution. While ΔG° indicates that the MC-LR adsorption to BIPGEM-2 is spontaneous, and in the contrary the MC-LR adsorption to BIPGEM-1 is unspontaneous.

TABLE 30

| | | ΔH° | ΔS° | ΔG° (kJ/mol) | | |
|---|---|---|---|---|---|---|
| | | (kJ/mol) | (J/mol) | 17 C.° | 23 C.° | 35 C.° |
| BIPGEM-1 | Case 1 | 53.39 | 152.8 | 8.05 | 9.60 | 5.79 |
| | Case 2 | 26.68 | 61.6 | 7.06 | 11.00 | 6.81 |
| | Case 3 | 12.37 | 15.9 | 7.68 | 7.72 | 7.42 |
| BIGPEM-2 | Case 1 | −3.1 | 44.4 | −15.59 | −16.70 | −16.56 |
| | Case 2 | 32.3 | 151.6 | −15.27 | −7.277 | −16.22 |
| | Case 3 | 247.6 | 857.9 | 0.10 | −8.48 | −16.03 |

### Removal Mechanism:

MC-LR in water at most pH (3<pH<12) is mostly negatively charged because of the deprotonation of the carboxyl group (Lawton et al., 2003; Lee and Walker, 2006). On the contrary the surface charge of CPS, ZIPGEM, BIPGEM-1 and BIPGEM-2 are positively charged at pH below 5.6, 9.2, 9.6. and 10, respectively, in accordance with its PZC (TABLE 23). The location of the PZC in ZIPGEM, BIPGEM-1 and BIPGEM-2 can be attributed to the presence of ZVI and ZVI and biochar as part of the sorption media matrix. This is because the location of PZC for iron hydroxide usually lies between 7 and 9 (Wu et al., 2017) and at pH of 10.6 for biochar (as disclosed herein). By considering the force of attraction between oppositely charged particles or Coulombic attraction, the higher adsorption capacity based on the Langmuir isotherm model for ZIPGEM, BIPGEM-1 and BIPGEM-2 in comparison to CPS can be justified (TABLE 26). Previous researchers have explained the interactions between MC-LR and iron particles. For instance, the removal of MC-LR onto iron oxide nanoparticles was examined by Lee and Walker (2011), who concluded that pH strongly affected the adsorption of MC-LR, indicating that the adsorption of MC-LR increased with decreasing pH, thus contributing to the adsorption of MC-LR to iron oxide particles (maghenite) mainly via electrostatic interactions. Moreover, Gao et al. (2012) suggested that the adsorption of MC-LR to iron oxide nanoparticles was spontaneous and endothermic. Additionally, the presence of clay can further aid in the MC-LR adsorption capacity of the sorption media.

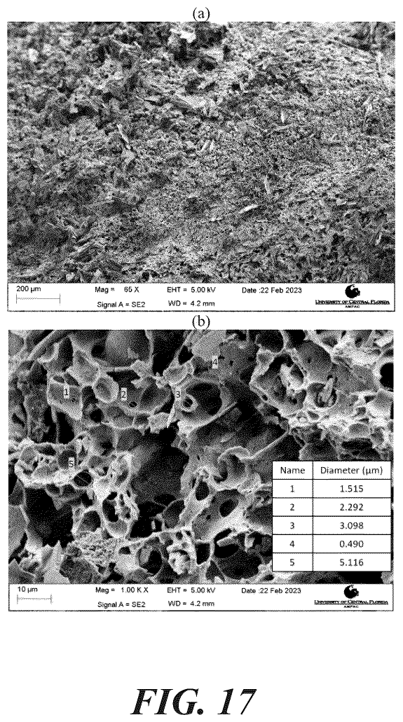

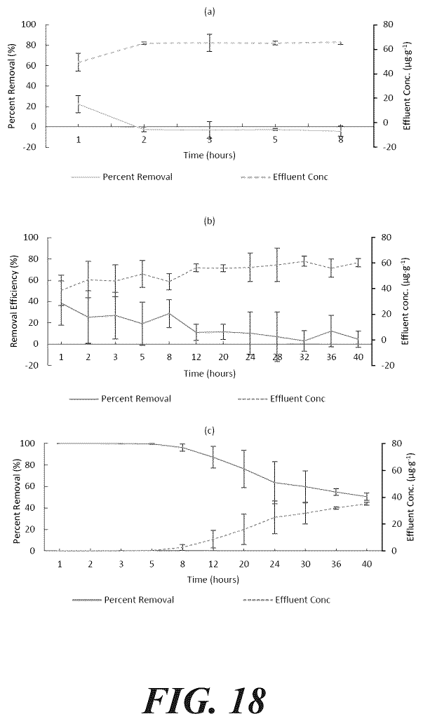

The removal efficiency and adsorption capacity of BIPGEM-2 and BIPGEM-1 were the highest among all 4 sorption media, and such improvement can be attributed to the inclusion of biochar in the media. The adsorption of MC-LR to biochar, as shown in FIG. 17 Section (a) and Section (b), was studied by Li et al. (2014), who found that the carboxylic and guanidino groups in the MC-LR structure can be responsible for the adsorption of MC-LR to biochar. Moreover, Li et al. (2014) also suggested that the adsorption of MC-LR to biochar is mainly attributed to the columbic attractions and the hydrogen bounding within the MC-LR and biochar surface. Liu et al. (2018) further indicated that the adsorption of MC-LR to biochar is the result of electrostatic attraction, pore filling, H bonding, and x-x interactions. The biochar was characterized in terms of surface morphology and PZC. The surface morphology of biochar is presented in FIG. 18 Section (a) and Section (b). In FIG. 18. Section (a), it can be observed that the surface of biochar is porous. By zooming in, the pore size is characterized, resulting in diameters ranging from 0.49-5.2 μm. The morphology of biochar can support the improved MC-LR adsorption of BIPGEM-1 and BIPGEM-2 explained by the incorporation of pore-filling adsorption by biochar in the synergetic adsorption mechanism of BIPGEM-1 and BIPGEM-2.

### Competing Effect Between Phosphate and MC-LR Removal:

In nature, MC-LR is commonly presented with other compounds including PO₄³⁻ and Ca²⁺; for this reason, it is important to understand how its presence can affect the removal efficiency of the sorption media. Based on the fitting of the Langmuir isotherm model, it can be assumed that when MC-LR is alone (Case 1) the adsorption of MC-LR in ZIPGEM and CPS is monolayer, whereas when MC-LR is present with other components (e.g., phosphate and calcium ions), the adsorption is multilayer. Moreover, based on the Freundlich equation, the major effect on the adsorption capacity was observed under the presence of PO₄³⁻ for CPS because the n value indicated that the adsorption was not favorable. The larger PZC and better physical and chemical characteristics of ZIPGEM, BIPGEM-1, BIPGEM-2 can explain whether in accordance with the Freundlich model, the adsorption was maintained as favorable in the presence of PO₄³⁻. By comparing the percentage removal, in these different conditions prescribed, a decrease in the MC-LR removal rates in Case 2 for all sorption media (i.e., CPS, ZIPGEM, BIPGEM-1, BIGPEM-2) can be observed. Such a decrease in removal efficiency of different adsorbents has been previously observed, and it can be attributed to a competition effect of PO₄³⁻ and MC-LR for the available positive adsorption sites (Li et al., 2014). However, the removal of PO₄³⁻ was not affected by the presence of MC-LR, suggesting that the interaction in the surface media will favor PO₄³⁻.

That said, the presence of cations in the water matrix can enhance the removal of MC-LR, which was observed by comparing the removal efficiencies in Case 3 with the removals in Case 1 for all sorption media. In Case 2, the Ca²⁺ removal was null, and the concentration maintained constant throughout the isotherm studies, regardless of the influent condition. Gao et al. (2012) suggested that calcium ions slightly enhanced the MC-LR adsorption capacity of the iron oxide nanoparticle. Meanwhile, Liu et al. (2019a) found that metal cation (i.e., Ca²⁺) on clay surface altered MC-LR adsorption by strengthening the ligand exchange and electrostatic interactions favoring MC-LR adsorption onto surface of kaolinite at lower pH.

Whereas a decrease in the MC-LR removal efficiency of the sorption media is seen in the presence of PO₄³⁻, an increase in the MC-LR removal efficiency when Ca²⁺ is present in water can be observed. However, its difference is not statistically significant within 95% critical interval in accordance with a 2-way ANOVA. These results support the application of the sorption media in a field scale, especially with BIPGEM-1 due to its high simultaneous removal efficiency of MC-LR and PO₄³⁻ and low production cost.

Dynamic Removal Efficiency with Canal Water:

The dynamic removal efficiency of sorption media with canal water as influent condition was investigated to simulate the adsorption behavior on a field scale. The results of the MC-LR percentage removal by the sorption media CPS, ZIPGEM, and BIPGEM-1 are presented in FIG. 18 Section (a), Section (b), and Section (c), respectively. The sorption media BIPGEM-2 was excluded from the dynamic column study due to its low saturated hydraulic conductivity, with respect to the other sorption media. Even though low saturated hydraulic conductivity can contribute to adsorption, if the conditions are very low, they may not be appropriate for field implementation. The sorption media BIPGEM-1 achieved better MC-LR removal followed by ZIPGEM and CPS while maintaining a low production cost in comparison to BIPGEM-2. BIPGEM-1 removed over 90% of MC-LR from the influent water for the first 8 hours; in the subsequent hours, its removal efficiency decreased, reaching ˜50% after ˜40 hours. On the contrary, ZIPGEM media only achieved ˜38% MC-LR removal within the first hour, reaching its exhaustion point (no removal efficiency) after 32 hours. As the control, CPS media only achieved 20% MC-LR removal in the first hour, reaching exhaustion after only 2 hours.

The results from the dynamic column studies for CPS, ZIPGEM, and BIPGEM-1 were imputed into the Thomas and MDR dynamic models, and the results are presented in TABLE 29. Given the short removal time for CPS, the MDR dynamic model was not applicable. Conversely, the adsorption capacity (qₒ) of CPS predicted by the Thomas model was 0.15 μg·g⁻¹; however, given that the Thomas model is based on the Langmuir model, the R2 obtained from the linear regression was low (0.35). For ZIPGEM, the Thomas and MDR models were applied, obtaining R2 of 0.651 and 0.776, respectively. The qₒ value predicted for ZIPGEM by the Thomas model was 0.97 μg·g⁻¹ and by the MDR model was 0.016 μg·g⁻¹. The R2 for BIPGEM-1 obtained by the Thomas and MDR models were 0.417 and 0.965, and the predicted q₀ values were 1.04 and 1.19 μg·g⁻¹, respectively. The lower R2 from the Thomas model fitting can be associated with the assumption of monolayer adsorption in the Langmuir isotherm, which, based on the results of the isotherm study, is not a valid assumption when there are other elements in the water matrix.

By comparing the qₒ from the dynamic models and the qₘ predicted from the Langmuir equilibrium isotherms, it can be observed that the adsorption capacities obtained in a dynamic condition are lower (TABLE 27 and TABLE 29). The water matrix characterization used as influent condition in the dynamic column study was performed by the research team. The decrease in the adsorption capacity of the sorption media can be explained by the presence of other contaminants in the influent water matrix because it can result in competition for the available sites between the adsorbents and the adsorbates. For instance, Gao et al. (2012) studied the removal efficiency of MC-LR to iron oxide nanoparticles and concluded that there is a competitive adsorption effect with other compounds, especially compounds containing carboxyl groups (i.e., citric acid, benzoic acid, and oxalic acid) with the effect increasing with a rising number of carboxyl groups. Moreover, Li et al. (2014) and Xiao et al. (2012) indicated that the presence of dissolved organic matter, especially tannic acid, inhibits the MC-LR adsorption capacity of biochar because they can compete for the available mesopore or macropore regions. Furthermore, Dixit et al. (2019) showed that inorganic ions (i.e., nitrate, bicarbonate, and sulphate) compete with MC-LR for the available sites in ionic exchange removal mechanisms, resulting in a reduction of MC-LR removal efficiency. Finally, the negative effect that the presence of phosphate has in the MC-LR removal efficiency of CPS, ZIPGEM, and BIPGEM-1 was further explained.

TABLE 31

| Media | Dynamic Model | R² | Equation | Parameters |
|---|---|---|---|---|
| CPS | Thomas | 0.350 | y = −0.005x + 0.1463 | qₒ = 0.15 μg · g⁻¹ |
| | | | | K_{T} = 7.9 E⁻⁶ L · μg⁻¹ · min⁻¹ |
| | MDR | — | — | — |
| ZIPGEM | Thomas | 0.651 | y = −0.0002x + 0.4027 | qₒ = 0.97 μg · g⁻¹ |
| | | | | K_{T} = 3.16 E⁻⁶ L · μg⁻¹ · min⁻¹ |
| | MDR | 0.776 | y = 0.6586x − 2.2615 | a_{mdr} = 0.632 |
| | | | | qₒ = 0.016 μg · g⁻¹ |
| BIPGEM-1 | Thomas | 0.417 | y = −0.1497x + 272.75 | qₒ = 1.04 μg · g⁻¹ |
| | | | | K_{T} = 0.002 L · μg⁻¹ · min⁻¹ |
| | MDR | 0.965 | y = 2.532x − 19.318 | a_{mdr} = 2.53 |
| | | | | qₒ = 1.19 μg · g⁻¹ |

TABLE 32

| Media | Adsorption capacity | Experimental setup | Reference |
|---|---|---|---|
| Graphene oxide- | 10.4 μg · g⁻¹ | Concentration range: 5, 20, 50 μg · L⁻¹ | Kumar et al. |
| coated sand | | Lake water | (2020) |
| | | Biofilm cultivation | |
| *GAC 1 | 1.85 μg · g⁻¹ | Initial concentration: 18.77 μg · L⁻¹ | Lopes et al. (2017) |
| GAC2 | 4.15 μg · g⁻¹ | Reservoir water | |
| BIPGEM-1 | 1.19 μg · g⁻¹ | Surface canal water | Present invention |
| | | Influent concentration: 70 μg · L⁻¹ | |

### Conclusion:

To respond to the increasing drinking water demand and changing water quality, it is crucial to develop proper treatment for surface water affected by nutrients, metals, and algal blooms. The MC-LR removal efficiencies, and adsorption capacities of 4 sorption media denoted as CPS, ZIPGEM, BIPGEM-1 and BIPGEM-2 for MC-LR at different water matrices were presented. The first advantage of these green sorption media is the low cost of operation and sustainable nature due to the use of recycled materials (e.g., ZVI and biochar). Additionally, these green sorption media have been proven to treat different pollutants simultaneously.

In terms of MC-LR adsorption capacity, the sorption media BIPGEM-2 outperformed BIPGEM-1, ZIPGEM and CPS. The MC-LR adsorption capacity of BIPGEM-2, based on the Langmuir isotherm in Case 1, Case 2 and Case 3 was 29.29, 18.45, and 16.9 μg·g¹, respectively. While, given the low production cost of BIPGEM-1, in comparison to BIPGEM-2, the MC-LR adsorption in a dynamic model was investigated and resultant qₒ is 1.19 μg·g⁻¹ based on the MDR dynamic model. The adsorption capacity of BIPGEM-1 in a dynamic environment is comparable with other adsorbents in literature. For example, in TABLE 30, it can be observed that the adsorption capacity of BIPGEM-1 is comparable with the adsorption capacity of GAC studied in a dynamic environment. The best performance of BIPGEM-2 and BIPGEM-1 for the MC-LR removal can be attributed to a large BET surface area, lower saturated hydraulic conductivity, high porosity, and the location of the PZC. Moreover, the inclusion of biochar in the media mix increases the MC-LR removal efficiency by its pore structure and high PZC in BIPGEM-1 and BIPGEM-2.

However, in a dynamic environment facing a real water matrix, the adsorption capacity of CPS, ZIPGEM, and BIPGEM-1 could be compromised given the presence of dissolved organic matter and inorganic ions, causing a competition for the available adsorption sites. Such an occurrence was also observed in the isotherm studies, indicating that the presence of PO₄³⁻ decreases the MC-LR removal efficiency of the sorption media. However, the presence of Ca²⁺ resulted in an increase in the MC-LR removal efficiency. Although these trends were represented by the observed change in the percentage removals, the application of a 2-way ANOVA test concluded that these changes are not significant under a 95% confidence interval, further supporting the application of the sorption media in different environments.

The removal of PO₄³⁻ was not affected by the presence of MC-LR, and in terms PO₄³⁻ removal the sorption media ZIPGEM outperformed BIPGEM-1 and CPS. The removal efficiency of ZIPGEM ranged from 55-60%. Although this researcher slightly studied the PO₄³⁻ removal efficiency of the sorption media, its efficiency to treat PO₄³⁻ suggests further research to find the adsorption capacity of ZIPGEM and BIPGEM-1. Finally, it can be concluded that the sorption media ZIPGEM, BIPGEM-1 and BIPGEM-2 are a good alternative to treat MC-LR and phosphate in-situ. Given the results, the water matrix needs to be studied before deciding on the appropriate sorption media. For instance, in water with high concentrations of PO₄³⁻ but low concentrations of algal toxin, the sorption media ZIPGEM may be more appropriate. But, in water with high concentration of algal toxins and DOM but lower PO₄³⁻ concentration, the filtration media BIPGEM-1 may be more appropriate.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

Abbaspour, N., Hurrell, R., Kelishadi, R., 2014. Review on iron and its importance for human health. Journal of research in medical sciences: the official journal of Isfahan University of Medical Sciences, 19 (2), 164.
Ahamed, S., Sperling, J., Stephens, J. C., Arent, D., 2019. The food-energy-water nexus, regional sustainability, and hydraulic fracturing: An integrated assessment of the Denver region. Case Studies in the Environment 3
Al-Mayouf, A., 1997. Corrosion of iron in aqueous solutions containing a chemical cleaning agent. Desalination 114, 29-36.
Alakan, M., Dogan, M., 2001. Adsorption of copper (II) onto perlite. Journal of Colloid and Interface Science 243, 280-291.
Albu, S. P., Ghicov, A., Macak, J. M., Hahn, R., Schmuki, P., 2007. Self-organized, free-standing TiO₂ nanotube membrane for flow-through photocatalytic applications. Nano Letters 7, 1286-1289.
Aljeboree, A. M., Alshirifi, A. N., Alkaim, A. F., 2017. Kinetics and equilibrium study for the adsorption of textile dyes on coconut shell activated carbon. Arabian Journal of Chemistry 10, S3381-S3393.
Amari, A., Alzahrani, F. M., Mohammedsaleh Katubi, K., Alsaiari, N. S., Tahoon, M. A., Rebah, F. B., 2021. Clay-polymer nanocomposites: Preparations and utilization for pollutants removal. Materials 14, 1365.
Ball, V., Meyer, F., 2016. Deposition kinetics and electrochemical properties of tannic acid on gold and silica. Colloids and Surfaces A: Physicochemical and Engineering Aspects 491, 12-17.
Bottino, A., Capannelli, C., Del Borghi, A., Colombino, M., Conio, O., 2001. Water treatment for drinking purpose: ceramic microfiltration application. Desalination 141, 75-79.
Chang, M. Y., Juang, R.-S., 2004. Adsorption of tannic acid, humic acid, and dyes from water using the composite of chitosan and activated clay. Journal of Colloid and Interface Science 278, 18-25.
Chang, N. B., Houmann, C., Wanielista, M., 2016. Scaling up adsorption media reactors for copper removal with the aid of dimensionless numbers. Chemosphere 144, 1098-1105.
Chang, N. B., Wen, D., Colona, W., Wanielista, M. P., 2019a. Comparison of biological nutrient removal via two biosorption-activated media between laboratory-scale and field-scale linear ditch for stormwater and groundwater co-treatment. Water, Air, & Soil Pollution 230, 151.
Chang, N. B., Wen, D., Wanielista, M. P., 2019b. Impact of changing environmental factors and species competition on iron filings-based green environmental media for nutrient removal in stormwater treatment. Environmental Progress & Sustainable Energy 38.4, 13087
Chassapis, K., Roulia, M., Vrettou, E., Parassiris, A., 2010. Preparation of bioinorganic fertilizing media by adsorption of humates on glassy aluminosilicates. Colloids and surfaces B: Biointerfaces 81, 115-122.
Chatterjee, S., Guha, N., Krishnan, S., Singh, A. K., Mathur, P., Rai, D. K., 2020. Selective and recyclable Congo red dye adsorption by spherical Fe₃O₄ nanoparticles functionalized with 1,2,4,5-benzenetetracarboxylic acid. Scientific reports, 10 (1), 1-11.
Colomina, M. T., Peris-Sampedro, F., 2017. Aluminum and Alzheimer's disease. Neurotoxicity of metals. 183-197.
Crittenden, J. C., Hutzler, N. J., Geyer, D. G., Oravitz, J. L., Friedman, G., 1986. Model development and parameter sensitivity. Water Resources Research 22 (3), 271-284.
Darko, B., Jiang, J. Q., Kim, H., Machala, L., Zboril, R., Sharma, V. K., 2014. Advances made in understanding the interaction of ferrate (VI) with natural organic matter in water. In Water Reclamation and Sustainability, Elsevier, 183-197.
Deng, Y., Wang, L., Hu, X., Liu, B., Wei, Z., Yang, S., Sun, C., 2012. Highly efficient removal of tannic acid from aqueous solution by chitosan-coated attapulgite. Chemical Engineering Journal 181, 300-306.
Dewi, R., Agusnar, H., Alfian, Z., 2018. Characterization of technical kaolin using XRF, SEM, XRD, FTIR and its potentials as industrial raw materials. In Journal of Physics: Conference Series 1116 (4), 042010
Dietrich, A. M., Burlingame, G. A., 2015. Critical review and rethinking of USEPA secondary standards for maintaining organoleptic quality of drinking water. Environmental Science & Technology 49, 708-720.
Dogan, M., Alkan, M., Onganer, Y., 2000. Adsorption of methylene blue from aqueous solution onto perlite. Water, Air, and Soil Pollution 120 (3), 229-248.
Dogan, M., Alkan, M., 2003. Removal of methyl violet from aqueous solution by perlite. Journal of Colloid and Interface Science 267, 32-41.
El-Sayed, G. O., 2011. Removal of methylene blue and crystal violet from aqueous solutions by palm kernel fiber. Desalination 272, 225-232.
EPA, 2012. EPA drinking water guidance on disinfection by-products. No. 4 Advice Note
Fawell, J., Robinson, D., Bull, R., Birnbaum, L., Boorman, G., Butterworth, B., Daniel, P., Galal-Gorchev, H., Hauchman, F., Julkunen, P., 1997. Disinfection by-products in drinking water: critical issues in health effects research. Environmental Health Perspectives 105, 108-109.
Georgantas, D., Grigoropoulou, H., 2006. Phosphorus and organic matter removal from synthetic wastewater using alum and aluminum hydroxide. Global Nest Journal 8, 121-130.
Ghasemi, M., Keshtkar, A. R., Dabbagh, R., Safdari, S. J., 2011. Biosorption of uranium (VI) from aqueous solutions by Ca-pretreated Cystoseira indica alga: breakthrough curves studies and modeling. Journal of Hazardous Materials 189, 141-149.
Ghribi, A., Chlendi, M., 2011. Modeling of fixed bed adsorption: application to the adsorption of an organic dye. Asian Journal of Textile 1, 161-171.
Gora, S. L., Andrews, S. A., 2017. Adsorption of natural organic matter and disinfection byproduct precursors from surface water onto TiO₂ nanoparticles: pH effects, isotherm modelling and implications for using TiO₂ for drinking water treatment. Chemosphere 174, 363-370.
Govindaraj, M., Muthukumar, M., Bhaskar Raju, G., 2010. Electrochemical oxidation of tannic acid contaminated wastewater by RuO2/IrO2/TaO2-coated titanium and graphite anodes. Environmental technology, 31 (14), 1613-1622.
Hosseini, S. A., Toghroli, A., 2021. Effect of mixing Nano-silica and Perlite with pervious concrete for nitrate removal from the contaminated water. Advances in Concrete Construction 11, 531-544.
Jawad, A. H., Mamat, N., Abdullah, M. F., Ismail, K., 2017. Adsorption of methylene blue onto acid-treated mango peels: kinetic, equilibrium and thermodynamic study. Desalination and Water Treatment 59, 210-219.
Katz, B. G., 1992. Hydrochemistry of the upper Floridan aquifer, Florida. Water-Resources Investigations Report, 91, 4196.
Kaal, J., Nierop, K., Verstraten, J., 2005. Retention of tannic acid and condensed tannin by Fe-oxide-coated quartz sand. Journal of Colloid and Interface Science 287, 72-79.
Katz, B. G., 1992. Hydrochemistry of the upper Floridan aquifer, Florida. Water-Resources Investigations Report, 91, 4196.
Kausar, A., Iqbal, M., Javed, A., Aftab, K., Bhatti, H. N., Nouren, S., 2018. Dyes adsorption using clay and modified clay: a review. Journal of Molecular Liquids, 256, 95-407.
Khuntia, B. K., Anwar, M. F., Alam, T., Samim, M., Kumari, M., Arora, I., 2019. Synthesis and Characterization of Zero-Valent Iron Nanoparticles, and the Study of Their Effect against the Degradation of DDT in Soil and Assessment of Their Toxicity against Collembola and Ostracods. ACS Omega 4, 18502-18509.
Krasner, S. W., McGuire, M. J., Jacangelo, J. G., Patania, N. L., Reagan, K. M., Aieta, E. M., 1989. The occurrence of disinfection by-products in US drinking water. Journal-American Water Works Association 81, 41-53.
Kutser, T., Pierson, D.C., Tranvik, L., Reinart, A., Sobek, S., Kallio, K., 2005. Using satellite remote sensing to estimate the colored dissolved organic matter absorption coefficient in lakes. Ecosystems 8, 709-720.
Li, X.-F., Mitch, W. A., 2018. Drinking water disinfection byproducts (DBPs) and human health effects: multidisciplinary challenges and opportunities. Environmental Science and Technology 52. 4, 1681-1689
Li, Y., Miao, X., Wei, Z., Cui, J., Li, S., Han, R., Zhang, Y., Wei, W., 2016. Iron-Tannic acid nanocomplexes: facile synthesis and application for removal of methylene blue from aqueous solution. Digest Journal of Nanomaterials and Biostructures 11.4, 1045-1061
Lowe, J., Hossain, M. M., 2008. Application of ultrafiltration membranes for removal of humic acid from drinking water. Desalination. 218, 343-354.
Mane, R., Bhusari, V., 2012. Removal of colour (dyes) from textile effluent by adsorption using orange and banana peel. International Journal of Engineering Research and Applications 2, 1997-2004.
Matilainen, A., Vepsäläinen, M., Sillanpää, M., 2010. Natural organic matter removal by coagulation during drinking water treatment: a review. Advances in Colloid and Interface Science 159, 189-197.
Meesuk, L., Seammai, S., 2010. The use of perlite to remove dark colour from repeatedly used palm oil. Journal of the Science Society of Thailand 36, 33-39.
Moussavi, G., Bagheri, A., 2012. Removal of petroleum hydrocarbons from contaminated groundwater by the combined technique of adsorption onto perlite followed by the 03/H₂O₂ process. Environmental Technology 33, 1905-1912.
Mustafa, Y. A., Ebrahim, S. E., 2010. Utilization of Thomas model to predict the breakthrough curves for adsorption and ion exchange. Journal of Engineering 4, 6206-6223.
Nayak, P. S., Singh, B. K., 2007. Instrumental characterization of clay by XRF, XRD and FTIR. Bulletin of Materials Science, 30 (3), 35-238.
Nouri, J., Mahvi, A., Bazrafshan, E., 2010. Application of electrocoagulation process in removal of zinc and copper from aqueous solutions by aluminum electrodes. International Journal of Environmental Research 4, 201-208.
Omoike, A., 1999. Removal of phosphorus and organic matter removal by alum during wastewater treatment. Water Research 33, 3617-3627.
Ordonez, D., Valencia, A., Chang, N.-B., Wanielista, M. P., 2020. Synergistic effects of aluminum/iron oxides and clay minerals on nutrient removal and recovery in water filtration media. Journal of Cleaner Production 275, 122728.
Palmstrom, N. S., Carlson, R. E., Cooke, G. D., 1988. Potential links between eutrophication and the formation of carcinogens in drinking water. Lake and Reservoir Management 4, 1-15.
Perez-Benito, J. F., 2003. Coagulation of colloidal manganese dioxide by divalent cations. Colloids Surfaces A: Physicochemical and Engineering Aspects 225, 145-152.
Prema, P., Thangapandian, S., Selvarani, M., Subharanjani, S., Amutha, C., 2011. Color removal efficiency of dyes using nanozerovalent iron treatment. Toxicological & Environmental Chemistry 93, 1908-1917.
Qaseem, S., Dlamini, D. S., Zikalala, S. A., Tesha, J. M., Husain, M. D., Wang, C., Jiang, Y., Wei, X., Vilakati, G. D., Li, J., 2020. Electro-catalytic membrane anode for dye removal from wastewater. Colloids and Surfaces A: Physicochemical and Engineering Aspects 603, 125270.
Quan, X., Zhao, X., Chen, S., Zhao, H., Chen, J., Zhao, Y., 2005. Enhancement of p, p′-DDT photodegradation on soil surfaces using TiO₂ induced by UV-light. Chemosphere 60, 266-273.
Rao, K., Krishnaiah, K., 1994. Colour removal from a dyestuff industry effluent using activated carbon. Indian Journal of Chemical Technology 1.1, 13-19.
Rambabu, K., Bharath, G., Monash, P., Velu, S., Banat, F., Naushad, M., Arthanareeswaran, G. and Show, P. L., 2019. Effective treatment of dye polluted wastewater using nanoporous CaCl2 modified polyethersulfone membrane. Process Safety and Environmental Protection, 124, 266-278.
Reddi, L., Inyang, H. I., 2000. Geoenvironmental engineering: principles and applications. CRC Press. Taylor and Francis Group.
Richardson, S. D., Willson, C. S. and Rusch, K. A., 2004. Use of rhodamine water tracer in the marshland upwelling system. Groundwater. 42 (5), 678-688.
Rossatto, D. L., Netto, M. S., Reis, G. S., Silva, L. F., Dotto, G. L., 2021. Volcanic rock powder residues as precursors for the synthesis of adsorbents and potential application in the removal of dyes and metals from water. Environmental Science and Pollution Research, 1-9.
Santos, S. C., Vilar, V. J., Boaventura, R. A., 2008. Waste metal hydroxide sludge as adsorbent for a reactive dye. Journal of Hazardous Materials. 153, 999-1008.
Saxton, M. A., Arnold, R. J., Bourbonniere, R. A., Mckay, R. M. L., & Wilhelm, S. W. (2012). Plasticity of total and intracellular phosphorus quotas in Microcystis aeruginosa cultures and Lake Erie algal assemblages. Frontiers in Microbiology, 3, 3.
Sharma, A., Syed, Z., Brighu, U., Gupta, A. B., Ram, C., 2019. Adsorption of textile wastewater on alkali-activated sand. Journal of cleaner production, 220, 23-32.
Shengguang, Y., Daying, X., Xiaolong, Y., Jun, Z., 1991. Effect of algae and water on water color shift. Chinese Journal of Oceanology and Limnology 9, 49-56.
Singh, K. P., Mohan, D., Sinha, S., Tondon, G., Gosh, D., 2003. Color removal from wastewater using low-cost activated carbon derived from agricultural waste material. Industrial & Engineering Chemistry Research 42, 1965-1976.
Sivaraj, R., Namasivayam, C., Kadirvelu, K., 2001. Orange peel as an adsorbent in the removal of acid violet 17 (acid dye) from aqueous solutions. Waste management, 21 (1), 105-110.
SJRWDM., accessed on: 12.1.2021. St. Johns River Water Management. Water Supply, Florida's aquifer, (sjrwmd.com).
Suba, V., Rathika, G., 2016. Novel adsorbents for the removal of dyes and metals from aqueous solution-a review. Journal of Advanced Physics 5, 277-294.
Sun, G., Xu, X., 1997. Sunflower stalks as adsorbents for color removal from textile wastewater. Industrial & Engineering Chemistry Research 36, 808-812.
Sun, C., et al., 2017. Adsorption removal of tannic acid from aqueous solution by polyaniline: Analysis of operating parameters and mechanism. Journal of Colloid and Interface Science. 487, 175-181.
Suyamboo, B. K. and Perumal, R. S., 2012. Equilibrium, thermodynamic and kinetic studies on adsorption of a basic dye by Citrullus lanatus rind. Iranica Journal of Energy & Environment, 3 (1), 23-34.
Tak, S., Vellanki, B. P., 2018. Natural organic matter as precursor to disinfection byproducts and its removal using conventional and advanced processes: state of the art review. Journal of Water and Health 16, 681-703.
Tara, N., Siddiqui, S. I., Rathi, G., Chaudhry, S. A., Asiri, A. M., 2020. Nano-engineered adsorbent for the removal of dyes from water: A review. Current Analytical Chemistry 16, 14-40.
Teng, Y., Liu, Z., Yao, K., Song, W., Sun, Y., Wang, H., Xu, Y., 2019. Preparation of attapulgite/CoFe₂O₄ magnetic composites for efficient adsorption of tannic acid from aqueous solution. International Journal of Environmental Research and Public Health 16, 2187.
Uusipaikka, E., 2008. Confidence intervals in generalized regression models. CRC press. Taylor and Francis Group
Uyak, V., Toroz, I., 2007. Disinfection by-product precursors reduction by various coagulation techniques in Istanbul water supplies. Journal of Hazardous Materials 141, 320-328.
Vadivelan, V., Kumar, K. V., 2005. Equilibrium, kinetics, mechanism, and process design for the sorption of methylene blue onto rice husk. Journal of Colloid and Interface Science 286, 90-100.
Valencia, A., Chang, N.-B., Wen, D., Ordonez, D., Wanielista, M. P., 2019. Optimal Recipe Assessment of Iron Filing-Based Green Environmental Media for Improving Nutrient Removal in Stormwater Runoff. Environmental Engineering Science 30 (10), 1323-1336.
Valencia, A., Zhang, W., Chang, N. B., 2021. Integration of machine learning classifiers and higher order tensors for screening the optimal recipe of filter media in stormwater treatment. Science of the Total Environment 771, 145423.
Wang, J., Zhao, G., Li, Y., Zhu, H., Peng, X., Gao, X., 2014. One-step fabrication of functionalized magnetic adsorbents with large surface area and their adsorption for dye and heavy metal ions. Dalton Transactions 43, 11637-11645.
Wang, J., Zheng, S., Liu, J., Xu, Z., 2010. Tannic acid adsorption on amino-functionalized magnetic mesoporous silica. Chemical Engineering Journal 165, 10-16.
Wang, Y., Joly, S., Morse, D., 2008. Phylogeny of dinoflagellate plastid genes recently transferred to the nucleus supports a common ancestry with red algal plastid genes. Journal of Molecular Evolution 66, 175-184.
Wen, D., Chang, N. B., Wanielista, M. P., 2018. Comparative copper toxicity impact and enzymatic cascade effect on Biosorption Activated Media and woodchips for nutrient removal in stormwater treatment. Chemosphere, 213, 403-413.
Wen, D., Chang, N. B., Wanielista, M. P., 2020. Assessing nutrient removal in stormwater runoff for urban farming with iron filings-based green environmental media. Scientific Reports 10 (1), 1-13.
Wong, S., Ghafar, N. A., Ngadi, N., Razmi, F. A., Inuwa, I. M., Mat, R., Amin, N. A. S., 2020. Effective removal of anionic textile dyes using adsorbent synthesized from coffee waste. Scientific Reports 10 (1), 1-13.
Wigle, D. T., 1998. Safe drinking water: a public health challenge. Chronic Diseases in Canada 19 (3), 103-107.
Yan, M., Wang, D., You, S., Qu, J., Tang, H., 2006. Enhanced coagulation in a typical North-China water treatment plant. Water Research 40, 3621-3627.
Zaied, B., Rashid, M., Nasrullah, M., Zularisam, A., Pant, D., Singh, L., 2020. A comprehensive review on contaminants removal from pharmaceutical wastewater by electrocoagulation process. Science of the Total Environment 726, 138095.
Zhang, L., Jun, M., Xin, L., Shutao, W., 2009. Enhanced removal of organics by permanganate preoxidation using tannic acid as a model compound-Role of in situ formed manganese dioxide. Journal of Environmental Sciences 21, 872-876.
Zhou, X.-F., Liang, J.-P., Zhao, Z.-L., Yuan, H., Qiao, J.-J., Xu, Q.-N., Wang, H.-L., Wang, W.-C., Yang, D.-Z., 2020. Ultra-high synergetic intensity for humic acid removal by coupling bubble discharge with activated carbon. Journal of Hazardous Materials 403, 123626.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A filtration media for the removal of at least one phosphorus molecule, microcystin molecule, or both from a water sample comprising:
at least one silicon atom;
at least one aluminum atom;
at least one zero-valence-iron (hereinafter “ZVI”) atom;
wherein the at least one ZVI atom is chemically bonded to the at least one silicon atom of at least one grain of perlite, thereby forming at least one ZVI-perlite structure;
wherein the at least one ZVI-perlite structure is chemically bonded to at least one alterative silicon atom of at least one grain of sand, thereby forming at least one quartz structure, whereby the at least one ZVI atom is disposed about at least a portion of a surface of the at least one quartz structure; and
wherein the at least one ZVI-coated quartz structure is metallically bonded to at least one aluminum atom, thereby forming an aluminum-doped ZVI-quartz construct.

2. The filtration media of claim 1, wherein the aluminum-doped ZVI-quartz construct further comprises at least one potassium atom, at least one calcium atom, or both.

3. The filtration media of claim 1, wherein the aluminum-doped ZVI-quartz construct comprises a heterogenous morphological structure.

4. The filtration media of claim 1, wherein the ratio of the at least one ZVI atom to the at least one grain of sand within the aluminum-doped ZVI-quartz construct is at most 0.071 by percent volume.

5. The filtration media of claim 1, wherein the aluminum-doped ZVI-quartz construct comprises a composition ratio of at least 85% sand, at most 5% clay, at most 6% ZVI, and at most 4% perlite by percent volume.

6. The filtration media of claim 1, wherein the aluminum-doped ZVI-quartz construct comprises a surface area of at most 3.00 m²·g⁻¹.

7. The filtration media of claim 6, wherein the aluminum-doped ZVI-quartz construct is configured to be hydraulicly conductive, highly porous, or both.

8. The filtration media of claim 7, wherein the aluminum-doped ZVI-quartz construct comprises a porosity of at least 29.0% of percent surface area.

9. The filtration media of claim 1, wherein the aluminum-doped ZVI-quartz construct comprises a density of at least 2.50 g·cm⁻³.

10. The filtration media of claim 1, wherein the aluminum-doped ZVI-quartz construct is electrochemically stable.

11. The filtration media of claim 1, wherein the aluminum-doped ZVI-quartz construct is hydrophobic.

12. A method of optimizing a phosphorus removal reaction, a microcystin removal reaction, or both within a water sample, the method comprising:
incorporating a filtration media into the water sample, the filtration media comprising:
at least one silicon atom;
at least one aluminum atom;
at least one zero-valence-iron (hereinafter “ZVI”) atom;
wherein the at least one ZVI atom is chemically bonded to the at least one silicon atom of at least one grain of perlite, thereby forming at least one ZVI-perlite structure;
wherein the at least one ZVI-perlite structure is chemically bonded to at least one alterative silicon atom of least one grain of sand, thereby forming at least one quartz structure, whereby the at least one ZVI atom is disposed about at least a portion of a surface of the at least one quartz structure; and
wherein the at least one ZVI-coated quartz structure is metallically bonded to at least one aluminum atom, thereby forming an aluminum-doped ZVI-quartz construct; and
wherein the incorporation of the filtration media to the water sample thereof optimizes the phosphorus removal reaction within the water sample.

13. The method of claim 12, wherein the aluminum-doped ZVI-quartz construct is configured to maintain an effluent concentration below at least 40 color units of Pt—Co.

14. The method of claim 13, wherein the aluminum-doped ZVI-quartz construct is configured to operate continuously in the water sample for at least 14,000 minutes.

15. The method of claim 12, wherein the aluminum-doped ZVI-quartz construct is configured to inhibit ponding, clogging, or both within at least one pour of the aluminum-doped ZVI-quartz construct for at least 40,000 minutes.

16. The method of claim 12, wherein the aluminum-doped ZVI-quartz construct is configured to maintain an adsorption capacity of at least 25.0 mg of Pt—Co·g⁻¹.

17. A method of synthesizing a filtration media for the removal of at least one phosphorus molecule, microcystin molecule, or both, the method comprising:
pretreating at least one iron atom, wherein the at least one iron atom comprises zero-valence (hereinafter “ZVI”);
chemically bonding at least one silicon atom of at least one grain of perlite to the at least one ZVI atom to form a ZVI-perlite structure;
chemically bonding at least one alternative silicon atom of at least one grain of sand to the ZVI-perlite structure to a quartz structure, whereby the at least one ZVI atom is disposed about at least a portion of a surface of the quartz structure; and
metallically bonding at least one aluminum atom to the ZVI-coated quartz structure to form the filtration media which is an aluminum-doped ZVI-quartz construct.

18. The method of claim 17, wherein heat treatment is used to chemically bond the at least one grain of perlite to the at least one grain of sand.

19. The method of claim 17, wherein heat treatment is used to chemically bond the at least one ZVI atom to the at least one grain of perlite.

20. The method of claim 17, wherein heat treatment is used to chemically bond the at least one aluminum atom to the at least one ZVI-coated quartz structure.
